(19) United States
(12) Patent Application Publication
(10) Pub. No.: US 2009/0188782 A1
(43) Pub. Date: Jul. 30, 2009

(54) Wet-discharge electron beam flue gas scrubbing treatment

(75) Inventors: Ralph Donald Genuario, Alexandria, VA (US); Jean Otto de Kat, Birkerod (DK)

Correspondence Address: Ralph D. Genuario;CEO, eSCRUB Systems Incorporated, 110 West 9th Street #662, Wilmington, DE, 19801, US

(73) Assignees: eSCRUB Systems Incorporated, Wilmington, DE (US); A.P. Moller-Maersk A/S

(21) Appl. No.: 12/285,011

(22) Filed: Sep. 26, 2008

Related U.S. Application Data
(60) Provisional application No. 60/976,762, filed on Oct. 1, 2007.

(51) Int. Cl. B01D 53/75; B01D 53/60; B01J 19/08

(52) U.S. Cl. 204/157.3; 422/169

(57) ABSTRACT

The present invention relates generally to scrubbing of flue gases to remove sulfur oxides, nitrogen oxides and particulate matter resulting from burning of high-sulfur fuels, and more specifically provides improvements in electron beam design and the use thereof in a wide variety of flue gas scrubbing applications including power plants installed on water borne vessels and positioned adjacent to bodies of water permitting the discharge of environmental-friendly wet-discharge stream. In a preferred embodiment, the electron beam chamber is used in tandem with a wet by product collector apparatus. In a preferred embodiment, the electron beam generator's electron gun has a beryllium anode foil that is used in conjunction with a sacrificial foil arrangement. The sacrificial foil arrangement separates the flue gas and any corrosive by-products that are produced by the process from the anode foil. In a preferred embodiment, the sacrificial foil arrangement is a Kapton foil that is mounted on a roller assembly and a partial pressure of 1/10 atmosphere is maintained between the anode and sacrificial foil.

The applicant claims the benefit of the Provisional Patent Application No. 60/976,762 filed 1 Oct. 2007.

### FIELD OF THE INVENTION

The present invention relates generally to scrubbing of flue gases to remove sulfur oxides, nitrogen oxides and particulate matter resulting from burning of high-sulfur fuels, and more specifically provides improvements in electron beam design and the use thereof in a wide variety of flue gas scrubbing applications including power plants installed on water borne vessels and positioned adjacent to bodies of water permitting the discharge of environmental-friendly wet-discharge stream.

### DISCUSSION OF RELATED ART

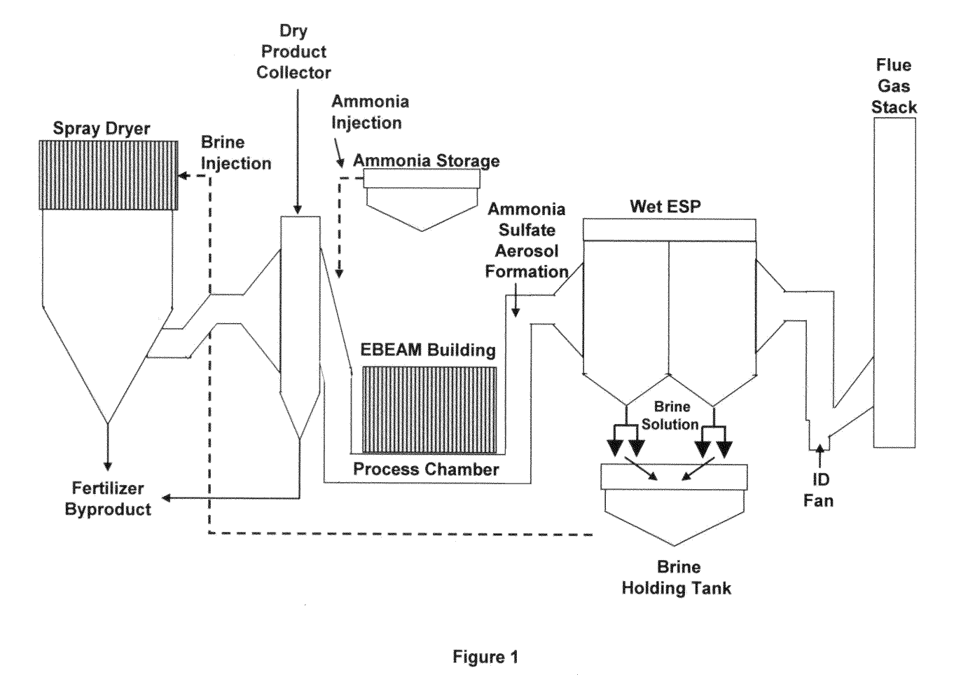

U.S. Pat. No. 5,695,616 discloses a flue-scrubbing arrangement that removes sulfur oxides and nitrogen oxides from stack gases and converts them into non-noxious ammonium sulfate-nitrate, which is utilizable as an agricultural fertilizer. Generally speaking, the arrangement involves passing flue gases, cleaned of fly ash, through a spray dryer to cool and humidify the gas. The humidified gas passes through an electron beam chamber where high energy electrons interact therewith to form sulfuric and nitric acids, which react with ammonia gas injected into the flue gas stream to form ammonia sulfate and nitrate salts. The transformed flue gases pass to a wet precipitator, where the salts are removed in aqueous solution, and the remaining scrubbed flue gases are passed to the stack. The aqueous solution is then fed back to the spray dryer, where the incoming flue gases pick up the water and precipitate the ammonium sulfate-nitrate as particles of about 100 μm. Thus, this patent discloses a flue scrubbing arrangement that produces a solid waste product, which is a valuable and useful fertilizer product, and is well-suited to land-based scrubbing applications. The entire disclosure of U.S. Pat. No. 5,695,616 is hereby incorporated herein by reference. Certain aspects of this technology are shown in FIGS. 1-3 of the Appendix hereto.

### DETAILED DESCRIPTION

Under various national and international laws and regulations, selected ocean going vessels are prohibited in releasing into the air within a specified distance from land (such as 50 nautical miles) flue gases above a certain threshold of SOx, NOx, and particulate matter. Such laws may be complied with by burning fuel that is low in components that generate SOx and particulate matter in flue gases. However, such fuel is generally expensive. In order to use fuels that are cheaper, and which have components that generate levels of SOx, NOx, or particulate matter, in flue gases above the legal or regulatory limits, scrubbers may be used to clean the flue gases. A traditional Wet By-Product Collector is difficult to use on such ocean going vessels, due to their large size. The present application discloses an apparatus and a method of using such an apparatus which when used in settings such as on ocean going vessels may allow the use of smaller wet by-product collectors, such that the treated flue gases are within the legal and regulatory limits.

As shown and described herein, an embodiment of the present invention provides a system and method for scrubbing of flue gases to remove sulfur oxides, nitrogen oxides and particulate mater from a flue gas stream of fossil fuel burning facilities, municipal solid waste burning incinerators, and the like that burn high-sulfur fuels and produce flue emissions having high SOx, NOx and particulate matter contents. NOx stands for oxides of nitrogen, such as nitrous oxide, N₂O, nitric oxide, NO, dinitrogen trioxide, N₂O₃, nitrogen dioxide, NO₂, and alike. SOx stands for oxides of sulfur, such as sulfur dioxide, sulfur monoxide, and sulfur trioxide. The new system and method provided herein produce an environmentally-friendly wet (liquid) discharge, and thus are well suited to sea-based scrubbing applications, as for use on seagoing vessels. Aspects of this technology are occasionally referred to herein as the e-SCRUB™@SEA technology, however, it should be noted that the technology is also well-suited for use in land-bas scrubbing applications.

As shown and described herein, an embodiment of the present invention provides a system and method for scrubbing of flue gases to remove sulfur oxides and nitrogen oxides from a flue gas stream of fossil fuel burning facilities, municipal solid waste burning incinerators, and the like that burn high-sulfur fuels and produce flue emissions having high SO₂, NOx and particulate matter contents. The new system and method provided herein produce an environmentally-friendly wet (liquid) discharge, and thus are well-suited to sea-based scrubbing applications, such as for use on seagoing vessels. Aspects of this technology are occasionally referred to herein as the @SEA technology. However, it should be noted that this technology is also well-suited for use in land-based scrubbing applications.

Embodiments of the system and method involve collection of solid particulate matter from combustion flue gases from a fossil fuel fired boiler or other source, disassociating oxygen and water of the flue gases by bombarding gas molecules with highly energetic electron beams in an electron beam reactor to form weakly acidic nitric and sulfuric add in mist form, and optionally passing this treated flue gas through a wet by-product collector (WBC) that captures the acidic solutions. In the WBC, a liquid having basic ph is sprayed in a Spray Tower Section to absorb/quench purposes to cool, humidify and saturate the flue gases prior to filtering. The sprayed water droplets move in a cross-flow pattern relative to the flue gas, covering the entire gas stream and flushing the tower's sidewalls. SO₃, SO₂ may be captured in this step due to the higher pH of the seawater. Coarse particulate matter (greater than approximately 3 microns in size) may also be captured, to effectively filter the gases.

The quenched gases then flow upward through an Absorber Section. In the Absorber Section, AggloFiltering Modules (AFM) are positioned to receive portions of the flue gas. In the modules, the flue gas is accelerated (compressed) and then decelerated (expanded), which causes water to condense. Additionally, nitric and sulfuric acid droplets form, which have a weakly acidic ph. These weak acids mix with sprayed liquid in the WBC, and drain to a lower portion of the WBC by gravity, etc.; scrubbed flue gases tend to move up and out of the WBC. The WBC thus discharges scrubbed flue gas and liquidous (wet) discharge. When the liquid is basic, the WBC discharges a liquid discharge stream having a near-neutral ph, or a ph level within a desired range.

Thus, relative to the arrangement described in U.S. Pat. No. 5,495,616, the arrangement disclosed herein eliminates the use of ammonia, the use of a spray dryer, the need for a dry (solid) by-product collector, and the production and need to move, handle and/or dispose of a solid by-product.

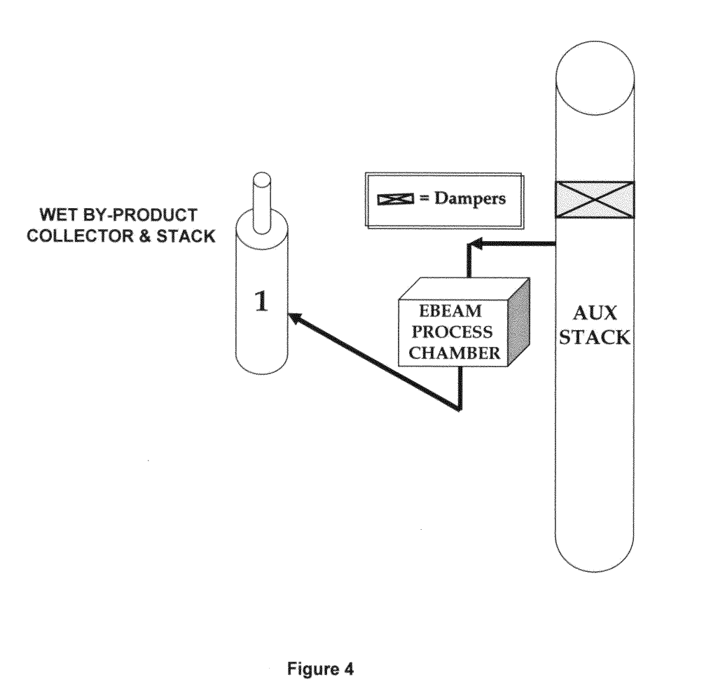

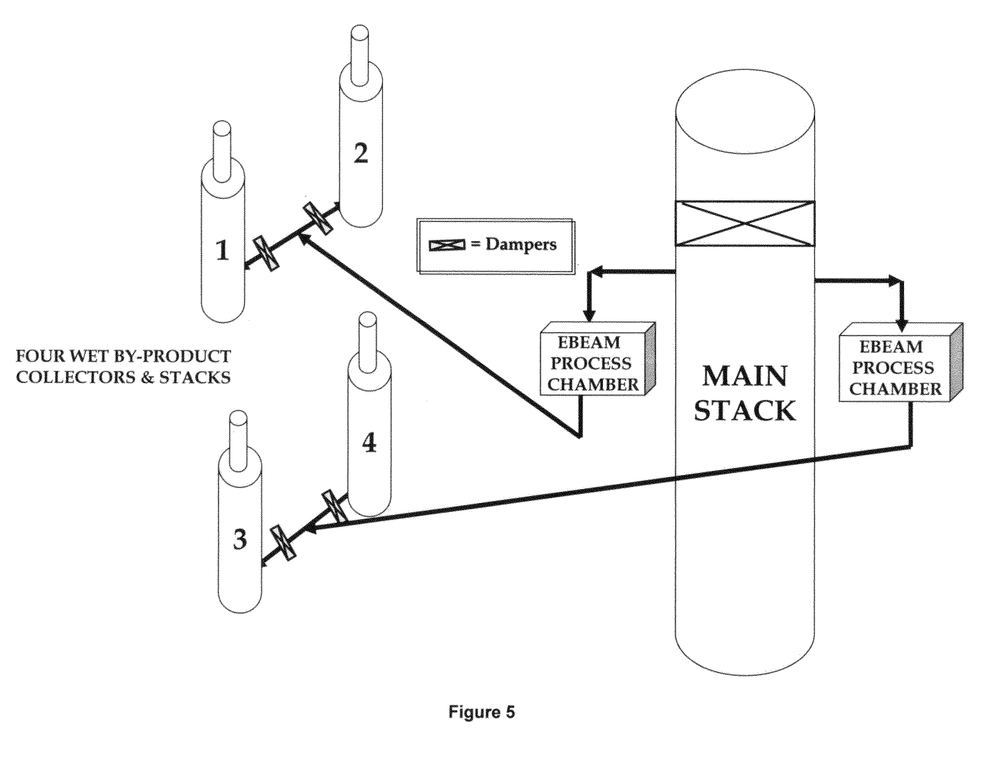

When the technology is employed in seagoing vessels, or in power plants, etc. having access to seawater, seawater may be used as the liquid having the basic pH. Thus, seawater may be used as both a water source for generation of OH⁻, O, HO₂ and other radicals, and as a medium for elimination of the process' waste products. The acids formed in the WBC may be mixed with the basic seawater, to provide liquid discharge having a pH level from about 3 to about 7, close to neutral, or slightly less basic. At proper volume ratios of the acid mixture with seawater, the characteristics of the discharge stream may permit discharge of the WBC's liquid discharge stream directly into the sea. By way of example, a scrubbing system may be fitted to either an auxiliary or main engine of a seagoing vessel to scrub its respective combustion product flue gas stream. See FIGS. 4 and 5.

When the technology is employed in freshwater vessels, or in power plants, etc, having access only to freshwater, which has a pH of approximately 7 (neutral), the low concentration of acids formed in the WBC may be mix not only with fresh water, but also with a basic pH-neutralizing solution, such as a sodium hydroxide solution, or with buffering solutions. For example, the sodium hydroxide may be stored in a reserve tank for this purpose and be mixed into the discharge stream as desired. A system may be provided for sampling and monitoring pH-levels of the acids from the WBC and automatically delivering an appropriate amount of pH-neutralizing solution to provide a WBC discharge stream having a ph level within a desired range. Alternatively, the pH of the waste stream may be adjusted by diluting the waste stream with sufficient amount of water.

When burning less-expensive, high-sulfur oil, it is believed that scrubbing systems in accordance with the present invention will remove 90%-95% of S0₂; 60%-70% of NOx and 95% or more of fine particulate matter. Prior to discharge, the waste stream may be processed further to remove substantial portion of the NOx. Such a system may be used with a selective catalyst reactor (S.C.R.).

In one embodiment of the present invention, the electron beam chamber may be the only or primary treatment of the flue gas. Under another embodiment of the present invention, the electron beam chamber apparatus may be used in conjunction with other scrubbers or collectors. It is preferred that the electron beam chamber is placed in upstream of the other scrubbers or collectors. In a preferred embodiment, the electron beam chamber is used in tandem with a wet byproduct collector apparatus.

In one embodiment of the present invention, the flue gas containing high levels of SOx, NOx, or particulates is treated with one electron beam chamber, and one additional scrubber. In another embodiment of the present invention, there are multiple additional scrubbers downstream from an electron beam chamber. The additional scrubbers may be in parallel or in series. In a prefer embodiment, the additional scrubbers are in parallel to each other, downstream from the electron beam chamber. In another embodiment, the flue gas containing high levels of SOx, NOx, or particulates is treated with a plurality of electron beam chambers, each chamber upstream from one or more additional scrubbers.

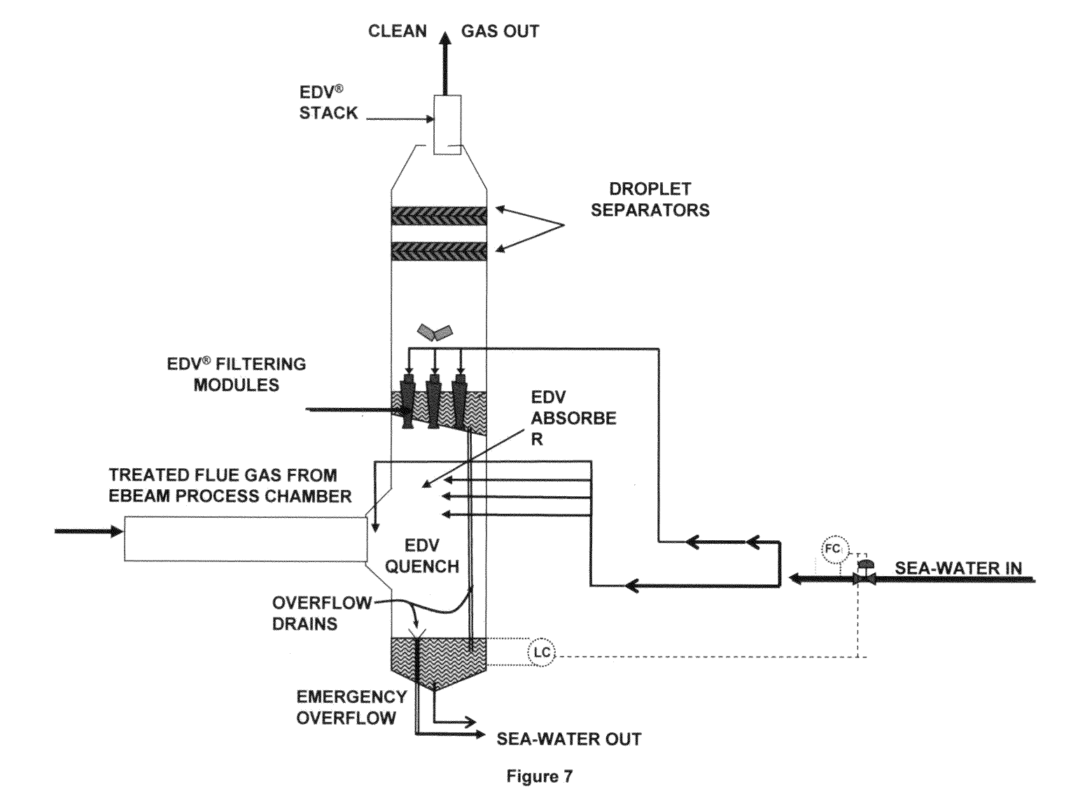

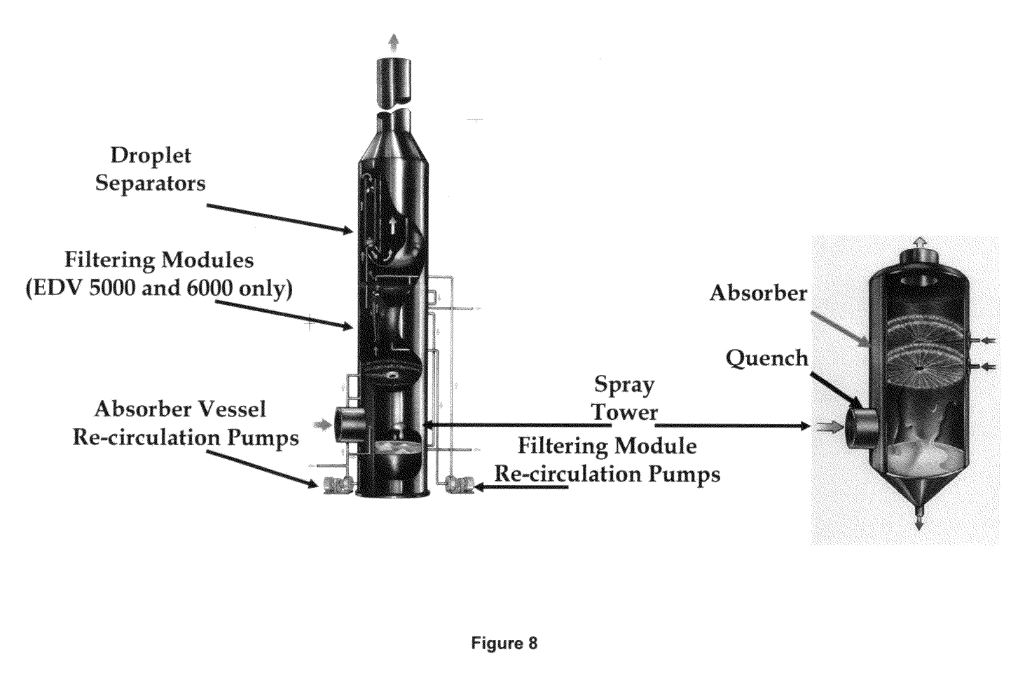

Referring now to FIGS. 4 and 5, exemplary wet-discharge scrubbing systems are shown retrofitted to each of an auxiliary engine and a main engine of a seagoing vessel. The systems may be substantially identical in operation, except for capacities. For example, to treat the gas flow from the main engine, two electron beam process chambers may be interfaced into the stack at two locations, as shown in FIG. 5. For example, a Nested High Voltage Tandem Accelerator commercially available from North Star Power Engineering electron beam process chamber may be used for this purpose, if modified in accordance with the teachings herein. An exemplary electron beam reaction chamber has eight electron beam generators. Each electron beam generator is self-shielded. To treat the flue gas across the range of operating conditions of the main engine, four WBCs may be used. A commercially available, wet by-product collector (WBC) supplied by Belco Technologies and employing Belco® EDV® technology, may be used for this purpose For example, a Belco EDV® 6000 UpFlow design that consists of Quench Section, Spray Tower, AggloFiltering Modules, Chevron-type proplet Separators and short stack to discharge the flue gas directly to the atmosphere may be used. See FIGS. 7 and 8. In one embodiment, as is appropriate for a seagoing vessel and a power plant or other facility having access to seawater, the WBC is configured to use seawater to remove nitric acid, sulfuric acid, particulate matter and unreacted SO₂ from the flu gas. These by-products are captured by circulated seawater used by the WBC. After treatment, the circulated seawater drains to the return seawater cooling loop to drain overboard, as permitted by applicable maritime laws. Additional aspects of the process are described in sections 3.3, 3.4, 3.5 and 3.6 of the Appendix hereto.

Dampers may be provided to direct flue gases from the stack to the wet-discharge scrubbing system, or to bypass the wet-discharge scrubbing system, and may be further provided to direct gases to one or more of the electron beam generators and WBCs, depending upon current scrubbing capacity requirements as a function of current engine conditions. In certain embodiments, the layouts of the interface of the electron beam process chambers to the auxiliary and main engines are accomplished on a non-interference basis. As a result the gas flow is directed into the e-SCRUB™@Sea system on a non-interference basis. Because of the height of the Belco units, the cleaned flue gas can be exhausted directly the atmosphere.

Thus, no additional interface is required with the existing stack to vent the cleaned gas. This arrangement allows the complete independent operation of the e-SCRUB™@Sea system for any and all operating conditions. If the e-SCRUB™@Sea system were to malfunction, then appropriate dampers would be closed to bypass the eSCRUB™@Sea system and allow the engines to operate in their original state.

For an auxiliary seagoing vessel's engine providing a lesser volume of flue gas flow, a single NSPE electron beam process chamber that has a single electron beam generator may be used, and a single Belco WBC may be used.

The electron beam generators used in the auxiliary and main engines may be identical, which is believed will achieve reduced manufacturing and maintenance costs.

The cross-sections for the process chambers for the auxiliary and main engines may be chosen to limit the gas velocity, e.g. to ≦26 m/s.

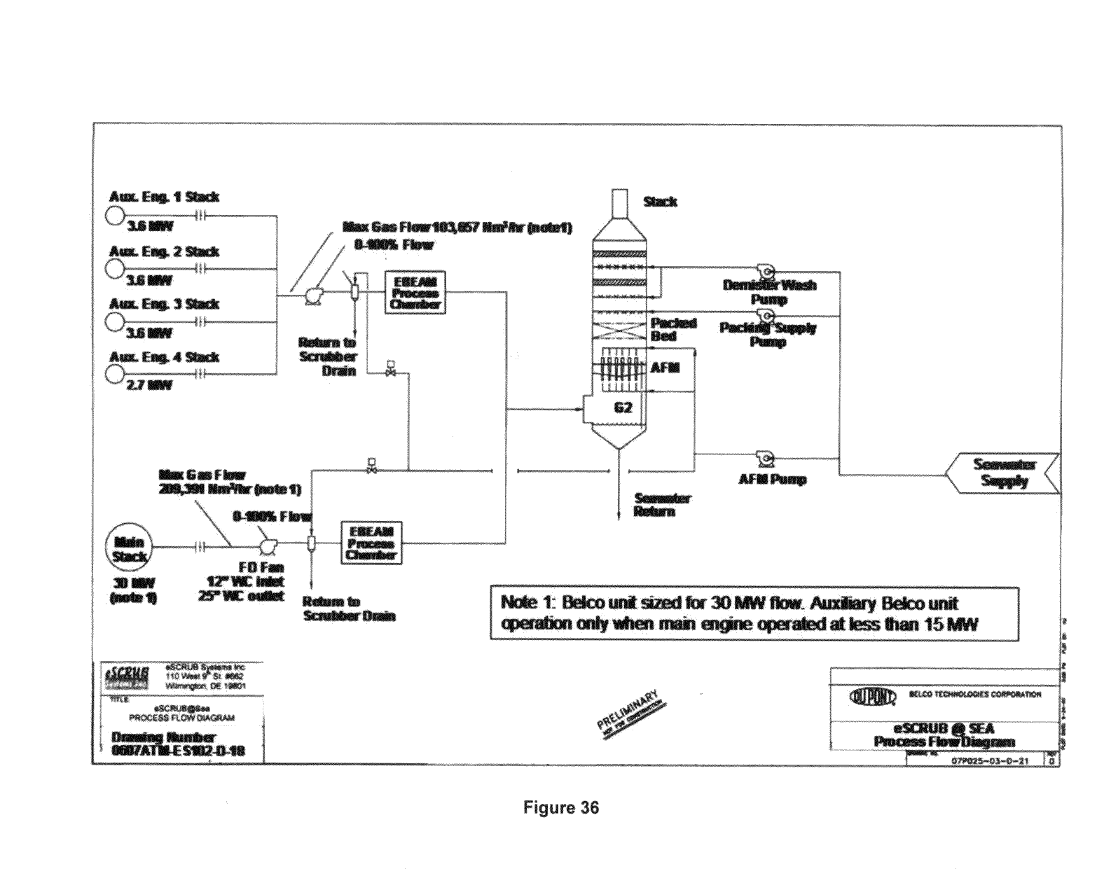

Referring now to FIG. 36, an exemplary wet-discharge scrubbing system is shown retrofitted to both an auxiliary engine and a main engine of a seagoing vessel in an arrangement in which the flue gases from the various engines are combined and fed to a single WBC for treatment consistent with the description herein. Engine operating conditions can be moderated to ensure that the capacity of the single WBC is not exceeded.

As defined here, Wet scrubbing systems are inclusive of EDV® scrubbers, packed bed scrubbers, ionizing wet scrubbers, misting scrubbers, tray scrubbers, spray towers, bubbling scrubbers, venturi scrubbers, ejector design scrubbers, wet electrostatic precipitators and any device that utilizes liquid to gas interface to reduce SOx or particulate”. However, for the best and most reliable performance, the EDV scrubbing system should be used.

Electron Beam Chamber Modifications

A modified electron beam reaction chamber is provided. It should be noted that the modified e-beam chamber is suitable for use not only in the @SEA/wet discharge processes described above, but also in dry discharge processes, such as that described in U.S. Pat. No. 5,695,616.

An exemplary NSPE e-beam reaction chamber includes cathode housing supporting cathode rods spaced for an anode. A vacuum housing contains the cathode and a wall of the vacuum housing holds the anode in a window that opens into a conduit for the flue gases to be e-beam treated. Electrons generated by the cathode rods propagate and are accelerated towards and through the anode and into the flue gases in the conduit as they pass the window. The anode includes a metal foil that is transparent to high energy electrons. The foil is typically a relatively thin, e.g. approximately 12 micron, titanium foil, which has relatively poor thermal conductivity properties, but is airtight, or light-tight, which prevents leakage through the foil as a result of a pressure differential across it.

However, because of its poor thermal conductivity, the titanium foil must be supported by a foil support structure that is cooled, e.g., water cooled. Moreover, the thin titanium foil cannot be used directly in contact with the irradiated flue gas because it will fail rapidly due to corrosion. Hence, double windows have been used, with a fixed-foil second window, and a blower for thermal management/cooling. The blower requires power to operate, and the titanium foil must nevertheless be replaced frequently, e.g., after only a few hundred hours of use.

The modified a-beam chamber allows for elimination of the blower, and thus saves energy and improves the overall efficiency of the scrubbing process. In particular, the modified chamber includes a fixed beryllium window in substitution for the titanium window. Beryllium is known to have better thermal conductivity properties than titanium. However, titanium has been preferred in electron beam reaction chambers because of its low permeability to gas, which is necessary in view of the vacuum required for the electro beam reaction chamber. In contrast, beryllium, as a low-molecular weight metal, is not airtight or light-tight over the areas and thickness of interest, and does not have the desirably low permeability of gas provided by titanium. This could suggest that beryllium cannot be used in substitution for titanium in this e-beam reaction chamber application, because the leak would compromise the vacuum requirements

However, applicant has found that beryllium may be used in substitution for the titanium in this application, although the gas permeability problem is not solved, if at least a partial vacuum (e.g. 1/10 atmosphere) is maintained opposite the beryllium foil, as show in FIG. 36. Additionally, use of beryllium, having better thermal conductivity properties, means that fewer cooling fins may be used in the foil support structure of the first window, and thus results in less beam energy loss due to collision with a cooling fin, and thus greater efficiency.

Additionally, the modified chamber includes a sacrificial second window that is placed adjacent to the beryllium foil. The second (sacrificial) foil is placed between the delicate beryllium foil and the corrosive flue gases, to protect and maintain the integrity of the beryllium foil. Preferably, the second foil is a Kapton foil, and is fed from a supply roll to a take-up be advanced from the roll by a drive mechanism, e.g. hourly, to expose a fresh segment of the Kapton foil. Accordingly, the delicate beryllium foil my be preserved and used for an extended period of time, and the inexpensive Kapton foil may be easily replaced by insertion of a new roll of Kapton foil onto a roll-supporting structure for use as the new supply roll.

Additional information relating to exemplary embodiments of the writing instrument is provided in the Appendix hereto.

While there have been described herein the principles of the invention, it is to be understood by those skilled in the art that this description is made only by way of example and not as a limitation to the scope of the invention.

### APPENDIX

### e-SCRUB™@Sea

### e-SCRUB™ Emission Control For Marine Engines

1. Objectives. International and domestic marine trade is predicted to more than double in the next twenty years, which reinforces the need to expeditiously develop and implement measures to abate vessel-generated air pollution. Consequently, the shipping industry is facing new local, national, and international regulations for controlling emissions of nitrogen oxides (NOx), sulfur oxides (SOx), particulate matter (PM) and other pollutants.

Emission reduction objectives are summarized in Tables 1 and 2. In view of these increasing regulations, suitable abatement strategies may be: small enough to fit on the maritime vessels; efficient enough to reduce the pollutants simultaneously to levels shown in Table 2; achieve these emission reductions while burning high sulfur fuel; and minimize environmentally harmful waste that needs to be disposed off.
The e-SCRUB™ air pollution control (APC) system addresses all major concerns that most maritime shippers have. As shown in FIGS. 1 & 2, the e-SCRUB™ process removes simultaneously up to 98% of SO₂, up to 95% of NOx and up to 99.9% of fine particulate (PM2.5) from flue gas, which is generated by boilers that burn high sulfur fuel. The high energy electrons serve as an electronic catalyst that interacts primarily with the water vapor in the flue gas via radiolysis to form acid mists.

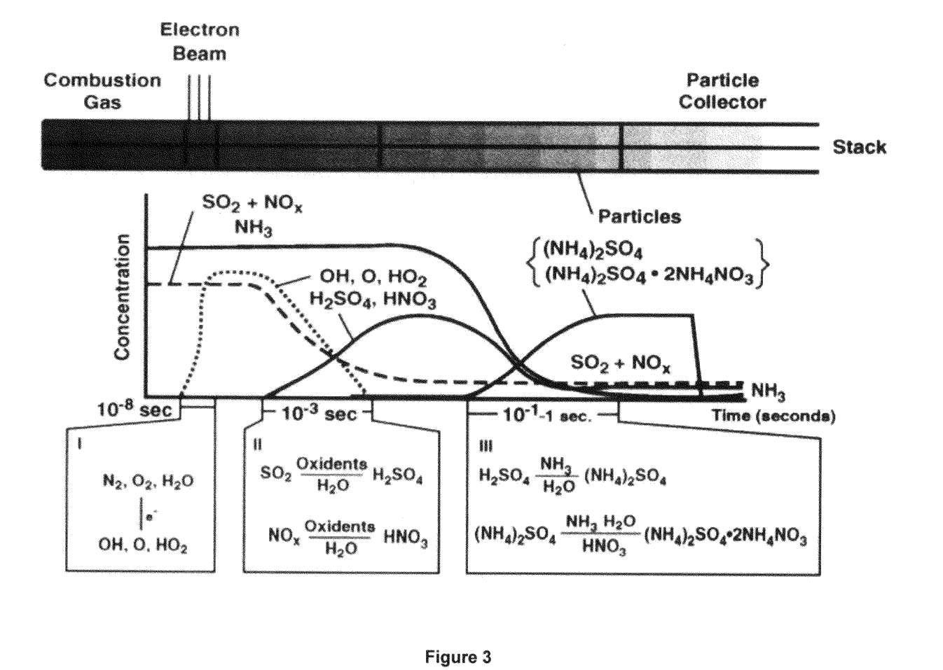

Process chemistry of a dry-discharge e-SCRUB™ process is illustrated in FIG. 3. It shows that through the addition of ammonia into the electron beam process chamber, the acid mists are reduced by the ammonia chemistry to form an ammonia-sulfate aerosol.

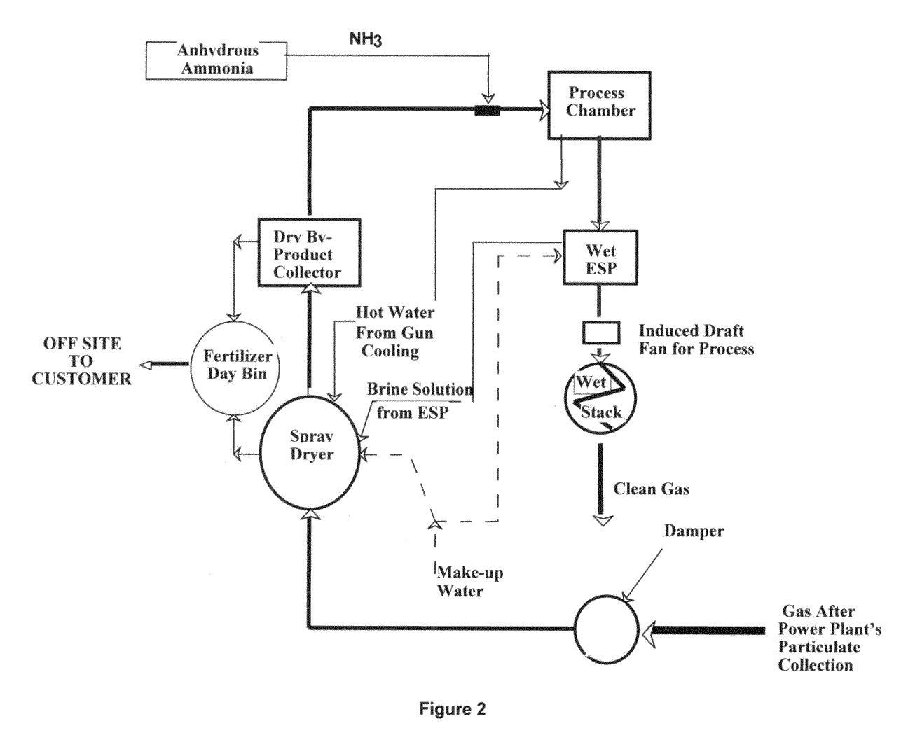

The ammonia-sulfate aerosol is removed at high efficiency by a wet electrostatic precipitator, which also allows the ammonia chemistry to go to completion. As shown in FIGS. 1 and 2, the addition of a spray dryer and dry by-product collector completes the transformation of the ammonia-sulfate aerosol into a high grade fertilizer—ammonium sulfate & ammonium-sulfate-nitrate—that is sold to offset the operating costs. The e-SCRUB™ process as described in FIGS. 1 and 2 generates no wastewater or solids requiring disposal. Thus, the e-SCRUB™ process that is covered by its patent is applicable to air pollution control at land-based power plants where it converts pollution into fertilizer. This process is described in detail in U.S. Pat. No. 6,695,616.

eSCRUB Systems Inc. has modified its dry-discharge e-SCRUB™ process to reduce air pollution from ships; and named the new application “e-SCRUB™@Sea”, which is described in more detail in the rest of this report.

This application of e-SCRUB™ process differs from its land-based application (FIGS. 1 & 2) mainly in that it does not convert pollution into fertilizer. Thus, no spray dryer; ammonia system or dry by-product collector are required. In addition, using the technology for shipboard application generates wet discharge. However, this wet discharge should only be seawater, whose ph should be less basic. When burning less-expensive, high-sulfur oil, e-SCRUB™@Sea is expected to satisfy the objectives that are described in Table 2 and remove up to: 90% SO₂; 70% NOx and 95% of fine particulate.

2. Requirements. As summarized in Table 2 and discussed above, the objectives are to reduce emissions of SOx by 90 to 95%; NOx by 60 to 70% and reduce particulate emission by more than 95%. The successful application of the e-SCRUB™@Sea to maritime use involves retrofitting scrubbing systems to the auxiliary and main engines. For exemplary maritime engines, the e-SCRUB™@Sea must process the gas flow that is given in “Input Data—Auxiliary Engine” Table 3 and “Input Data—Main Engine Table 4.

As shown there, the system must work effectively with high sulfur fuel oil. The emission reductions given in Table 2 must be achieved using bunker C fuel that contains sulfur concentrations ranging from 2% to 4.5%, with a global average of 2.7%. Moreover, the sea going vessels are operated continuously at a variety of engine speeds. Thus, the pollution control system should be equally effective under all loading conditions.

The e-SCRUB™@Sea is not “hardwired” into either the ship's auxiliary or main engines. It is designed to operate independently of both the main and auxiliary stacks by employing automated dampers. These arrangements are shown in FIG. 4 for the auxiliary engine and FIG. 5 for the main engine. Because of the volume of gas flow, only a single e-Beam process chamber that interfaces with a single wet by-product collector is needed for the auxiliary engine. Because of engine operating conditions and the volume of gas flow, two e-Beam process chambers that interface with four wet by-product collectors are required for the main engine.

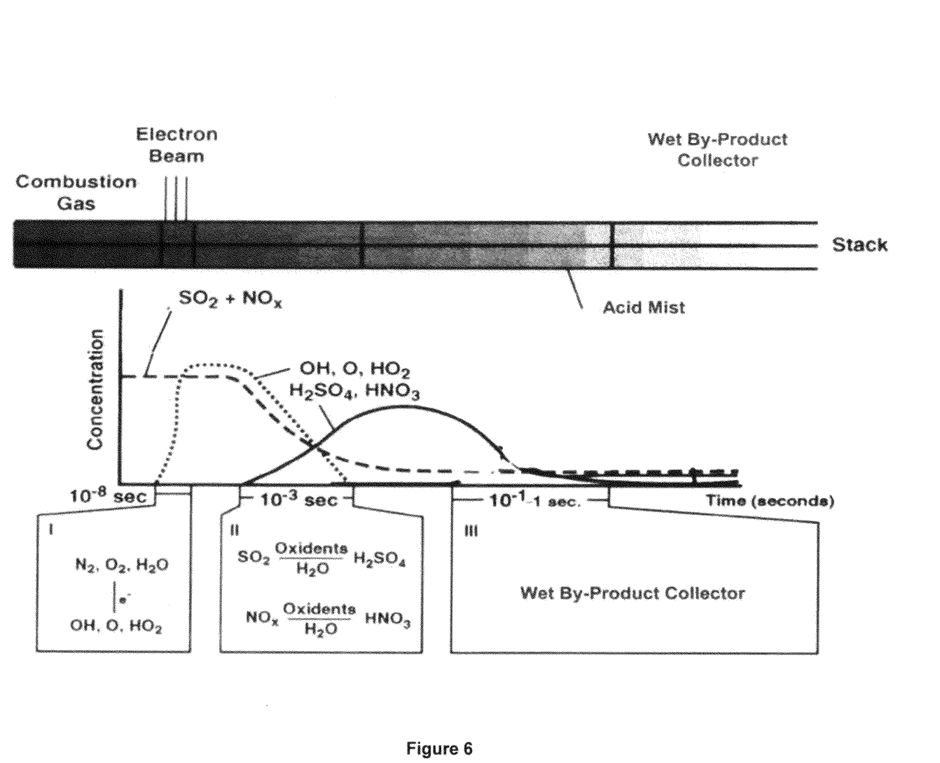

These dampers will take advantage of the flue gas pressure drop of ˜350 mm of Water Column (WC) found in the stack after the ships turbochargers. The pressure drop for the e-SCRUB™@Sea system that is shown in FIGS. 5 and 6 has been estimated to be only ˜63.5 cm WC. The maximum pressure drop from the ship is 35 cm WC. Thus, additional fans are needed. The dampers will direct flow from the ship's exhaust stack into the system to be treated. After treatment to remove SOx, NOx and fine particulate, the cleaned flue gas is exhausted into the atmosphere, without interfacing again with the ship's stack.

If the e-SCRUB™@Sea system were to malfunction, then the dampers would isolate the gas flow from it and redirect the gas flow back into the stack. Because of this arrangement, at no time would any malfunction of the e-SCRUB™@Sea system negatively affect the ship's operation of its engines.

3.0 Implementation—Electron Scrubbing Chemistry Without Ammonia. FIG. 6 is an illustration of the @SEA electron scrubbing chemistry, which does not include ammonia chemistry. As shown there, initially, energetic electrons irradiate flue gas and form powerful reactants such as OH, O and HO₂. This process takes about 10 ns. However, under flue gas conditions, it takes the energetic electrons about 1 ns to reach thermal equilibrium. It is an important design criterion to minimize the range of the energetic electrons, and thus their end-point energy, yet accommodate the gas flow conditions for both the auxiliary and main engines.

The energy loss, range and bremsstrahlung yield of energetic electrons in various materials, including air, has been tabulated in Reference 1. In traversing material, energy loss by collisions results from both ionization and excitation of atoms. The tables were calculated using Bethe's theory of continuous energy loss for the electrons. These formulae include the effects of mean excitation energy, which is a characteristic of each of each material involved. In addition, the decrease in energy loss by collision of electrons due to its polarization and dielectric properties are also included (the so-called density effects).

Finally, the energy loss by bremsstrahlung is also included. For the energy range of interest, the formulas used are those recommended by Koch and Motz as giving the best representation of theoretical considerations and experimental data. Estimates of these energy losses in mixtures and compounds such as air were made by calculating the relative mass of each component and summing the energy loss for each component. The results obtained were in good agreement with experiment and showed no discontinuity in the energy range studied.

Using the tables, we determined that the energy loss in air for a 250 keV electron satisfied the criteria above. In air at an ambient density of 1.29 g/cm³, the range is ˜56 cm. As will be shown later, the density of the flue gas for the auxiliary and main engines is ˜1.2 g/cm³, which corresponds to a range ˜60 cm.

The 60 cm will be used to specify the depth of the e-beam process chamber for the auxiliary engine. Here, a single electron beam generator will be used to treat the gas flow. For the main engine, because of the volume of the gas flow, opposing electron beam units will be utilized. For the main engine, these opposing units allow a depth of 1 m for the e-beam process chamber. Hence, we will use these results to specify that the electron beam generator must produce a beam kinetic energy ≦250 KeV in the flue gas.

As indicated in FIG. 6, the high energy electrons serve an electronic catalyst that initiate a number of concurrent chemical reactions. [A brief overview of the electron chemistry will be given here, with a more detailed discussion given in section 4.] These reactions are a direct result of the dissociation and ionization of the flue gas.

FIG. 6 shows the overall reaction mechanisms and their rate of change with time. The electron beam primarily ionizes the water vapor (radiolysis) and oxygen and creates powerful oxidants. These oxidants react with the SO₂ and NOx in the presence of the unreacted water vapor to form sulfuric and nitric acids. These acids are then collected and neutralized by using seawater in a wet by-product collector.

As will be shown in section 4, for a given NOx concentration, the higher the initial SO₂ concentration, the more efficient the e-SCRUB™@Sea process is in removing NOx. The SO₂ acts to enhance the NOx removal mechanism. In addition, under high humidity flue gas conditions, both NOx and SO₂ removal efficiency are enhanced. This is because water acts as a third body to allow the SO₂ removal to go to completion. Finally, under high humidity conditions, the initial particulate concentration present in the flue gas provides nucleation sites that also enhance the SO₂ removal efficiency.

3.1 Implementation—BELCO® Technologies. The e-SCRUB™@Sea process makes optimum use of BELCO®'s wet by-product collector experience, which is patented as the EDV® technology. To serve as the wet by-product collector for the project, the BELCO® EDV® technology is an excellent match to the capabilities of the electron scrubbing process that is described above. BELCO®'s EDV® is the ideal technology that will remove at high efficiency these acid mists; the unreacted SO₂ and fine particulate. They have demonstrated operational reliability of 100%.

Hence, the combined performance of the electron beam process with BELCO®'s wet by-product collector results in overall removal efficiencies of up to 90% NOx but baseline is 70%; 90% SO₂; 88% acid mists and 95% fine particulate that are generated by the ship's main and auxiliary engines. The cost effective achievement of these removal rates should be sufficient to retrofit seagoing vessels with e-SCRUB™@Sea technology.

For an exemplary e-SCRUB™@Sea Project, BELCO®'s EDV® wet by-product collector consists of multiple towers to achieve the required collection efficiency. As shown in FIGS. 4 and 5, one is required for the auxiliary engine and four are required for the main engine. The EDV® system has been the technology of choice for more than 300 installations worldwide. The BELCO® EDV® technology is discussed further in sections below.

3.2 Design Considerations—Wet By-Product Collector. EDV® systems are configured to handle flue gas flow during normal operation as well as during upset conditions. BELCO®'s approach is to design and supply systems that operate without service/maintenance outages for periods of excess of 5+ years (or more) of continuous operation in order to match/exceed client's requirements. This allows users to concentrate on the ships' operation and not the control of emissions. e-SCRUB™@Sea's wet by-product collectors (WBC) will use seawater from the ships' cooling system prior to discharging it in the sea.

Use of once through seawater sub-cools the flue gas, which enhances the performance of the e-SCRUB™@Sea process. FIG. 5 shows that the WBC, consisting of multiple and individual collectors, will be configured to treat gas flow that are irradiated by two electron beam process chambers. Each is sized to process up to 50% of flue gas flow from the main engine.

As shown in FIG. 7, there are four individual WBC, each treats up to 25% of the main engine flue gas flow. The system control for the four WBC will be ducted and controlled to allow an operation flexibility such that one WBC will operate at up to 25% engine throttle; two WBC will operate at up to 50% throttle; three WBC will operate at up to 75% throttle and four WBC will operate at up to 100% throttle.

To induce gas flow to the WBC, a set of stack dampers must provided that directs the flue gas from the main stack into the two electron beam process chamber. For treating up to 50% throttle, the stack damper in the main stack must be closed, while opening the corresponding damper to the duct work in the first e-beam process chamber. This arrangement will direct the flue gas from the main stack to be treated by first electron beam process chamber.

For treating up to 100% throttle, the stack damper in the main stack must remain closed, while opening the corresponding second damper to the duct work in the second e-beam process chamber. This arrangement will direct the flue gas from the main stack into the second electron beam process chamber. Both arrangements are illustrated in FIG. 5.

As illustrated in FIG. 7, the BELCO®'s EDV® WBC uses seawater to remove the nitric acid; particulate; sulfuric acid and unreacted SO₂ (by-products) from the flue gas. These by-products are captured/absorbed in the circulated seawater used by the WBC. After treatment, the circulated seawater drains to the return seawater cooling loop to drain overboard—subject to maritime laws which may be imposed.

3.3 EDV® Technology—Process Description. As shown in FIG. 8, to meet the application requirements, e-SCRUB™@Sea will use the EDV® 6000 UpFlow design that consists of Quench Section, Spray Tower, AggloFiltering Modules, Chevron-type proplet Separators and short stack to discharge the flue gas directly to the atmosphere. FIGS. 7 and 8 show that these components are arranged as a single up-flow vessel.

By incorporating a staged flue gas cleaning approach, the EDV® technology has a low flue gas pressure drop. The EDV® technology uses sprayed seawater energy for cleaning, rather than flue gas pressure drop energy, which further lowers the system pressure drop. This approach offers several advantages:
no formation of mist that is difficult to remove or cause corrosion of surrounding structures;
intense flushing of all internal walls, thus avoiding build-ups; and
high liquid to gas contact area that facilitates dealing with upset/load fluctuations.

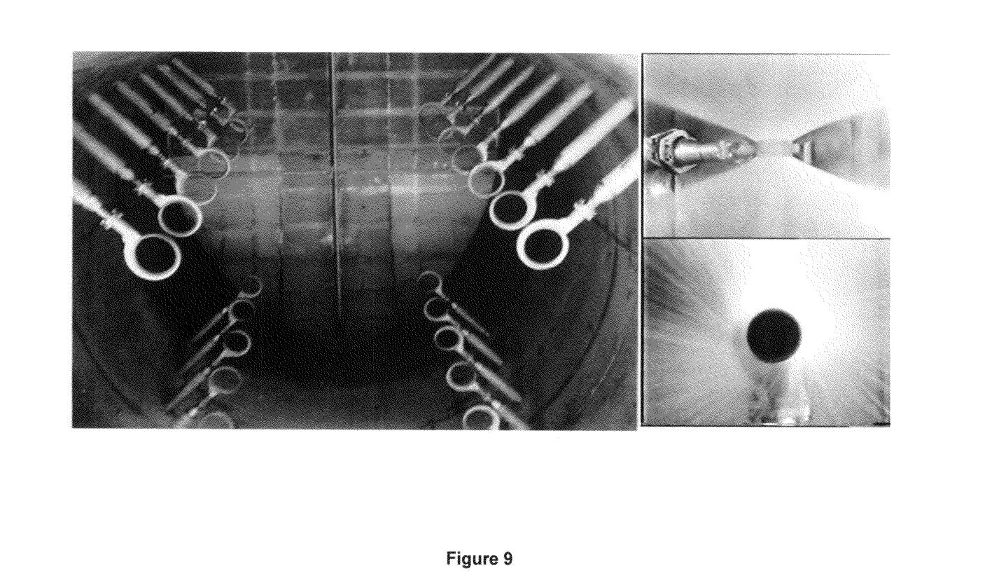

As shown in FIGS. 7 and 8, dirty flue gas enters the EDV® By-Product Collector system at the Spray Tower through a horizontal inlet where it is saturated in the inlet section. Sprays in the inlet assure the flue gas is quenched and cooled. The flue gas is quenched and saturated by means of high density water sprays generated by a set of BELCO-G spray nozzles (FIG. 9). Sea water is sprayed well in excess of what is required to saturate the flue gas.

The sprayed water droplets move in a cross-flow pattern relative to the flue gas, covering the entire gas stream and uniformly flushing the walls. While quenching the gas, some SO₃ is removed as well as coarse particulate >3 micron in size. Some SO₂ is also absorbed in the quench because of the higher pH of the seawater. The sprayed water flows down the walls to the bottom of vessel and drains to an integral recycle tank.

The gas turns upward and flows up through an Absorber Section. Water from the absorber pump drains to the bottom to return to the seawater cooling return loop. It also serves as the support base for the AggloFiltering Modules, chevron droplet separators and stack that are all located directly above. The Spray Tower contains only a set of spray nozzles. Due to the relatively low seawater temperature, sub-cooling occurs and condenses water from the flue gas. The water draining out from the spray tower is greater than the amount of incoming water.

3.4 Particulate Removal. Particulate in flue gas are mostly the product of combustion. Condensable compounds, such as sulfuric acid, nitric acid and hydrocarbons, generate additional particulate as the flue gas cools. These items, particulate size distribution, inlet loadings and desired outlet loadings are considered in determining the system design. As shown in FIG. 8 and FIG. 9, the coarse fraction of particulate is captured in the Spray Tower through the use of multiple water spray curtains. This first stage removes nearly 100% of particulate >2-3 micron in size and a smaller percentage of finer particulate. For the coarse fraction of particulate, the Spray Tower is basically a bulk removal device. It removes all the coarse particulate regardless of the inlet loading.

As illustrated in FIGS. 7 and 8, directly above the Spray Tower is a set of up-flow AggloFiltering Modules (AFM). Each module treats a portion of the flue gas. In the modules the flue gas is accelerated (compressed) and then decelerated (expanded). This causes water to condense. It condenses on the vessel walls, washing the surfaces. More importantly, a film of water condenses on the fine particle and acid mist (including condensed SO₃) present in the flue gas, increasing them all in size and mass. The remaining finer fraction is captured by a unique process of forced condensation, agglomeration and water spray filtration in the AggloFiltering Modules. Initially, no booster pumps have been provided; relying instead on the pressure in the seawater return line of 2 bar or 29 psig.

This staged approach provides excellent performance in handling upset conditions where large amounts of coarse particulate can be carried over. The bulk of this material is captured in the Spray Tower. This leaves the AggloFiltering Modules to continue to remove the finer particulate fraction.

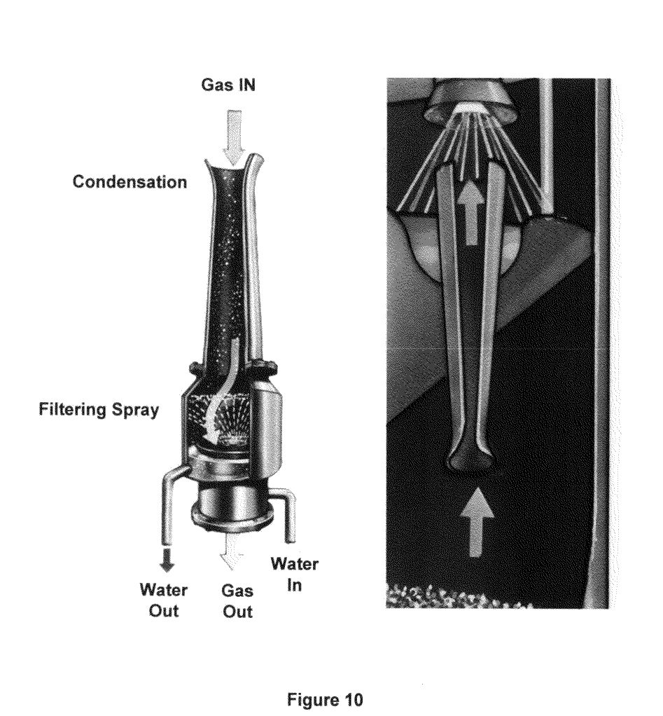

As shown in FIG. 10, agglomeration also takes place as the gas passes through the divergent zone. The now enlarged and agglomerated particulate and mist are captured by water spray filtration in a high density water spray at the end (top) of each module. The sprayed water drains to a recycle tank. An additional spray nozzle is used at the inlet to each module to provide some pre-filtration and enhanced particulate collection. BELCO-F130 nozzles are used in the AggloFiltering Modules. Some SO₂ is also absorbed because the scrubbing media is once through seawater.

Clean flue gas, free of water droplets, is directed to a stack that is integral to the unit. Stack velocities are kept low to allow condensing water (from gas cooling) to flow back down into the tower and not be entrained into the flue gas being exhausted to atmosphere. Spray nozzles and vessels do not plug or develop build-ups.

3.5 SO₂ Removal. The remaining unreacted SO₂ following the e-beam process chamber is absorbed from the flue gas through contact with seawater within the WBC. Multiple spray curtains in the Spray Tower provide the liquid to gas contact for a staged approach. The inlet SO₂ level, desired outlet requirement, and adiabatic saturation temperature are used in determining the liquid to gas contact (number of spray nozzles) required for the design.

As in the Quench Section, water droplets sprayed from BELCO-G spray nozzles (FIG. 9) move in a cross-flow pattern relative to the flue gas, covering the entire gas stream and uniformly flushing the walls. SO₂ is absorbed because of the higher pH of the seawater. The sprayed water flows down the walls to the bottom of the vessel and drains. Multiple levels of sprays are used to provide staged removal of SO₂.

In each stage a large portion of the SO₂ remaining in the flue gas (from the stage before) is removed. In the last stage, the flue gas with the final concentration of SO₂ is contacted with sea water to achieve a combined overall reduction of ˜90% from the initial inlet concentration of SO₂ in the stack (e-beam process chamber+WBC).

3.6 Removal Of SO₃, Sulfuric Acid And Nitric Acid proplets. Because of its basic design, significant SO₃; sulfuric acid and nitric acid by-products are removed by the WBC. A portion of the by-products are removed in the inlet. As the flue gas rapidly cools in the quench, SO₃ condenses to sulfuric acid droplets. A large portion of these droplets, along with a large portion of the droplets (both sulfuric and nitric acid) produced in the e-beam process chamber condense on the water droplets sprayed in the quench. The droplets that condense on the water droplets are captured.

Much of remaining acid droplets form a mist. The mist acts very much like fine particulate and is collected the same way as fine particulate. A large portion of this mist is collected in the AggloFiltering Modules. A series of chevron stages are provided to assure maximum droplet removal from the flue gas. Each stage of chevrons uses a zigzag arrangement of blades to effectively remove entrained water droplets by impaction. The droplet carry over provide washing to keep the blades free of build-ups. Liquid collected in this section drains below and back to the spray tower.

The EDV® system is unlike other technologies in that it does not produces additional mists that must later be removed. The only mist to be removed is the mist formed by the e-beam process chamber and that caused by condensation of any SO₃ that may be in the flue gas. As indicated above, the majority of the acid mist is removed in the Spray Tower and AggloFiltering Modules. Droplets of seawater that are carried by the flue gas are removed by Chevron-type proplet Separators.

4.0 Optimizing e-SCRUB™@Sea Overall Performance. An analysis will be performed in section 5.0 to determine the electron beam power and energy that is required to process the flue gas which is given in Tables 3 and 4. This estimate will be made while satisfying the overall emission reductions that are specified in Table 2. In addition, the electron beam power and energy specification must be analyzed while optimizing the e-SCRUB™@SEA overall performance using the BELCO WBC that was described in the previous section.

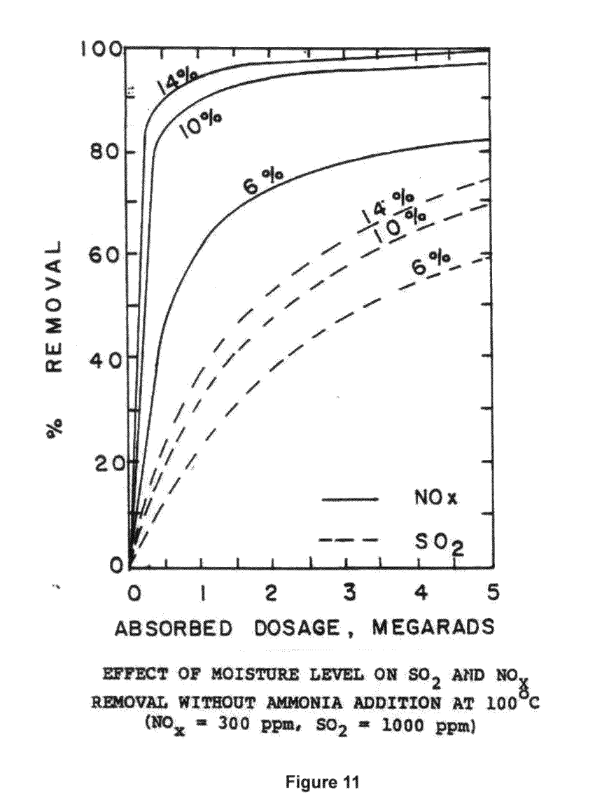

A more detailed analysis of the e-SCRUB™@SEA electron scrubbing chemistry, which is shown in FIG. 6, will be given below. The review and analysis was used to guide the selection and interpretation of the data that is given in FIGS. 11; 12; 13; 14 and 15 and summarized in Table 5. The results are taken from references 2 & 3.

4.1 Overview of Chemical Reaction Models of e-SCRUB™@SEA Electron Scrubbing Chemistry. Detailed model studies have provided much insight into the chemical kinetics of the process. The e-SCRUB™@SEA electron scrubbing process involves very different physicochemical steps: these include: energy absorption that was described in Section 3; reactions in homogeneous gas phase; heterogeneous aerosol particle and mass growth.

Energy absorption produces chemically active species at concentration levels that represent a highly unstable state compared to thermal equilibrium. Thus, irradiation by e-beam causes a sudden deviation from thermodynamic equilibrium in the flue gas. Subsequent relaxation establishes a new equilibrium state that is characterized by lower NOx/SO₂ concentrations and aerosol formation. A theoretical description of this relaxation process is hardly possible by simple thermodynamics, but requires the use of appropriate kinetic models. References 2 & 3 were developed for this purpose and their results are used here.

The goal of this analysis is to show how microscopic molecular interactions work together and determine the characteristics, performance and thereby the optimization of the e-SCRUB™@SEA electron scrubbing process. After a short description of the primary radiolytic events, the chemistry of the primary active species is considered. The reactions of positive ions are shown to constitute the major source of neutral radicals. These radicals are needed to convert NO to nitric acid and SO₂ to sulfuric acid. The OH radical turns out to be the most important radical for the formation of these acids and hence the final nitrate/sulfate aerosol. In addition, nitric acid is also produced directly from some ion-molecule reactions that work most efficiently at high concentrations of water vapor.

The oxidation of NOₓ by radicals is not a simple, straightforward reaction sequence, however. Part of the intermediate NO₂ is reduced back to NO by oxygen atoms. Furthermore, intermediate HNO₂ is likely to decompose at surfaces, which acts as an OH sink. Such “back-reactions” determine the dose dependence of NOₓ removal and thereby the efficiency of the e-SCRUB™@SEA process. [In the analysis that follows and used in FIGS. 11; 12; 13 and 14, the unit of energy per mass (dose) is used. One Mrad=10 kGy=10,000 J of energy deposited in the media (in this case flue gas) in one kg of mass.] Other reductive pathways yield N₂O as a gaseous by-product and also yield molecular nitrogen. However, the nitrogen formation is not easy to measure; therefore, the N₂ balance is difficult to investigate experimentally.

The properties of the developing aerosol are also reviewed and heterogeneous reactions at the aerosol surface are summarized. All of these physicochemical mechanisms work together simultaneously. Kinetic models in the referenced material were used to quantify the net effects of single mechanisms or reactions separately and to assess their contributions and importance for the entire process. This effort revealed the molecular interactions that are responsible for the measurable performance characteristics of the e-SCRUB™@SEA process. These include dose dependence of removal yields; NOx removal rates as a function of initial SO₂ concentration; NOx/SO₂ removal rates as a function of initial aerosol concentrations; and relative humidity effects.

4.2 Radiolysis Overview. The interaction of electrons with matter depends both on the electron energy and on certain material properties. As discussed in section 3.0, the energy of incident electrons in the e-SCRUB™@SEA process is 250 keV; and the incident electrons transfer part of their energy to the electron shells of molecules by inelastic collisions. These collisions are also associated with momentum transfer and the electrons are readily scattered throughout the irradiated medium. The energy loss in single collisions varies statistically between a few eV (“distant collisions”) and some tens of keV (“close collisions”). Both of these extremes are comparatively rare and leave the contact molecules in excited states or as (excited) ions, respectively. In the latter case, secondary electrons with a kinetic energy of many keV may be produced, which may cause further ionization themselves. In this way, tertiary & higher-order electrons result from ionization processes, which all contribute to the spatial energy distribution initiated by the primary electrons.

The overall gain of excited-state molecules, direct dissociation into neutral radicals and dissociation into ion pairs is described by G-values. These G-values are an average over the combined effects of all orders of electrons. The ionization gain is about three ion pairs per 100 eV absorbed energy in air. It is fairly independent of the primary electron energy, in this case 250 keV, but may depend on the peak dose rate. However, for both cases of interest—the e-SCRUB™ and e-SCRUB™@Sea-dose rates are well below these limits (see Reference 3).

4.3 Fate of Primary Species. Molecular excitation, homolytic dissociation, and ionization are counteracted by quenching, radical re-combination, and associative ion-electron recombination, respectively. The first two “deactivation” processes are not directly related to the energy absorption and will be discussed subsequently. Ion-electron recombination can occur only when the electrons have “cooled” down to thermal energy (kT˜0.01 eV at 2730K). For 250 keV electrons interacting with air at NTP, thermalization takes ˜1 ns. During this time, the primary ions may undergo charge transfer reactions or attach to neutral molecules and form ionic clusters.

Owing to Brownian motion, the positive charge (that is, a single or clustered ion) diffuses a linear distance of about 0.1 μm at NTP in the absence of external force fields. This range may be imagined as a spherical ion core, which develops around the ionization point prior to charge neutralization. Both charge transfer and dissociative neutralization reactions produce radicals.

As shown in Reference 2, the lifetime of radicals is at least 10 ns and the quenching of excited transients takes 200 ns on the average. The diffusive motion of these species constitutes a chemical core about the point of electron impact, which is in the micrometer range. According to common terminology, this is called a spur. Along the path of energetic electrons, numerous spurs are created.

An overlap of spurs (and hence tracks) generated by different electrons can be expected to favor the recombination of active species by a local increase of their concentrations above the normal level of independent energy transfer events. Also; the chemical mechanism may change in this way, for example, through preference of alternative reaction branches. This effect has been accepted to explain the dose-rate-dependent ozone formation in the radiolysis of pure oxygen.

4.4 Gas Phase Chemistry: Excited Species, Primary Radicals and Ions—Modeling Active Species Generation. The characteristics of the high energy electron scrubbing process have been discussed in terms of the chemical reactions in homogeneous gas phase, which precede and induce particulate formation. The results of those modeling studies, which are analyzed in the references and those references that are cited therein, provide an understanding of most experimental findings. A microscopic modeling of energy absorption and active species generation, for example, by Monte Carlo methods, has not been attempted in high energy electron scrubbing models. Rather, integral descriptions of the primary processes are in use, which relate active species formation directly to the dose rate experienced by flue gas:

dn/dt=Gₙ\check{D}xᵢρ

In this basic equation, n is the number concentration of species n, generated from species i with mole fraction xᵢ in the flue gas. Gₙ is the corresponding gain [molecules/100 eV], as discussed previously. \check{D}ρ is the dose rate times the average density in units of 100 eV/(cm³ s). Two basic assumptions are inherent in this equation:
a) energy absorption can be treated as a quasi-continuous process; and
b) the probability of electron impact is proportional to the (mass) concentration of the parent species.

The first assumption is applicable, because only low LET electrons are considered, and is supported by the dose rate consideration in the preceding section. The second assumption considers the collisional cross section for electron-molecule interaction as independent of electron energy and molecule nature. This is valid for electron energies down to about 30 keV and hence over at least 90% of the electron range.

The second assumption also suggests that one neglect radiolytic degradation of trace constituents in the flue gas and regard only the major components in energy absorption. Taking the G-values reported in the references, the relevant stoichiometric equations read:

4.43N₂^{100 ev}0.29N₂*+0.885N(²D)+0.295N(²P)+1.87N(⁴S)+2.27N₂⁺+0.69N⁺+2.96e⁻

5.377O₂ ^{100 ev}0.077O₂*+2.25O(¹D)+2.8O(³P)+0.18O*+2.07O₂⁺+1.23O⁺+3.3e⁻

7.33H₂O^{100 ev}0.51H₂+0.46O(³P)+4.25OH+4.15H+1.99H₂O⁺+0.01H₂⁺+0.57OH⁺+0.67H⁺+0.06O⁺+3.3e⁻

7.54CO₂ ^{100 ev}4.72CO+5.16O(³P)+2.24CO₂⁺+0.51CO⁺+0.07C⁺+0.21O⁺+3.03e⁻

This representation implies some simplifications concerning the nature of electronically excited nitrogen and oxygen molecules. Dissociative states have been treated as forming atoms directly. Therefore, N₂* and O₂* represent the sum of all not-dissociating excited-state molecules that is discussed in the references. In the present analysis, it is reasonable to treat these as N₂(A) and O₂(¹Δ_{g}), since it has been found that the numerical results do not change upon variation of the corresponding G-values by a factor of two. O* denotes a highly excited O atom above the O(¹S) level.

Using the above assumptions, an analysis can be undertaken to evaluate the importance of the various chemical reactions pathways to NOx and SO₂ removal from the flue Gas. This analysis shows that the reactions of primary radicals to the high energy electron scrubbing is not important and can be neglected. Similar analyses show that ion recombination and negative ion chemistry play no significant role in the removal of NOx and SO₂.

The reactions of the electronically excited state species arise only from nitrogen and oxygen radiolysis. The analysis has shown that excited species can thus initiate partial NO oxidation to NO₂. Thereafter, reduction reactions become important, yielding NO and N₂O from NO₂, and N₂ from NO. In this way, primary excited species lead to an oxidation-reduction cycle between NO and NO₂, which offers stable exit paths to gaseous products only. However, nitric and also sulfuric acid are not formed due to the lack of sufficient OH concentrations. Particulate formation therefore cannot be expected to originate from the generation of excited species.

However, positive ions are shown to undergo fast charge transfer reactions in which radicals are formed as “by-products.” Positive ion reaction pathways constitute the major radical source. In particular, positive ion reaction pathways are the only significant OH source in the high energy electron scrubbing process and thus, leads to NOₓ and SO₂ degradation.

4.5 NOx/SO2 Oxidation by Positive Ions. From the generalized theory of redox processes that are discussed in the references, it is well known that electron uptake constitutes the transition to a lower oxidation state. Hence, acquirement of a positive charge (that is, release of an electron) is synonymous with oxidation. Primary ionization can be interpreted in this way. Subsequent charge transfer processes can also be regarded as redox processes.

Charge transfer to trace contaminants proceeds at ˜10³ longer time scale (˜10⁻⁷ s) than charge transfer to major components, simply because of the difference in concentration. The most important waste gas contaminants are NO and SO₂, which can readily be oxidized to NO⁺ and SO₂⁺. Of course, these ions again are liable to lose their charge to neighboring neutrals and this is the simple fate of SO₂⁺.

But the chemistry of NO⁺ offers an important alternative: NO⁺ stabilizes through the attachment of one, two, or three water molecules. As the NO⁺ (H₂O) associate can be imagined as a mesomeric form of protonated nitrous acid, it appears very natural that NO⁺(H₂O) clusters can release nitrous acid. This is analogous to the reactions between gas-phase and aqueous-phase ion chemistry. Hence, oxidation of NO to NO⁺ eventually becomes manifest through the following reaction:

NO⁺(H₂O)₃+H₂O→HNO₂+H₃O⁺(H₂O)₂

k₉=2×10⁻⁶exp(−3000/T)cm³/s (1)

This reaction is only slightly opposed by the reverse reaction, k_{—9}=1.1×10⁻³ (300/T)^{2.6} cm³/s, which provides an indication that nitrous acid must be expected to form from gas-phase reactions. Nitrous acid is kinetically stable in the gas phase, which has particular consequences for the process to be discussed.

Positive charge transfer processes have been shown to produce radicals at a rate of the order of 100 ppm/s ˜2×10¹⁵ cm⁻³/s at \check{D}=10 kGy/s (T˜350 K, P˜1 bar). Radical production rate is essentially proportional to the dose rate. For example:

bimolecular radical-radical reactions may reduce total radical concentration—

H+H₂O→H₂+O₂

H+HO₂→H₂O+O

or keep it unchanged through formation of a new radical pair —

H+HO₂→2OH

NH₂+N→N₂+2H

Termolecular radical recombination always depletes the available radical reservoir, the rate constants are of the order of kₜₑᵣ˜5×10⁻³³ cm⁶/s, so that kₜₑᵣ[M]˜10⁻¹³ cm³/s. In the analysis below, the radical recombination will be treated using a bimolecular rate constant of 5×10⁻¹² cm³/s. For comparison, fast radical-molecule reactions proceed with equally high rate constants. Then, quasi-stationary radical concentrations [R] can be estimated from:

$$\frac{d [ R ]}{d t} ∼ 2 \times {10}^{15} {cm}^{- 3} / s - 5 \times {10}^{- 12} {cm}^{3} / s [ R ] n - 5 \times {10}^{- 12} {cm}^{3} / {s [ R ]}^{2} = 0$$

This gives radical levels in the ppb range for neutral concentrations n˜10¹⁶-10¹⁹ cm⁻³ at \check{D}˜10 kGy/s. The already overestimated quadratic term can be neglected (n>>R]). This means:
i) radical concentrations are proportional to the dose rate;
ii) radical recombination becomes important only at high dose rates, definitely above 2×10⁶ kGy/s (Reference 3).

These estimates were confirmed by detailed modeling studies and again exclude any dose rate effect from the more chemical side of the process. This agrees with the previously references that show the physical limit for the occurrence of dose rate effects are well above those of interest here.

Concerning the fate of radicals, two termolecular reactions must be considered:

O+O₂+M→O₃+M

H+O₂+M→HO₂+M

These reactions proceed with rate constants k[M]˜10⁻¹⁴ and 3×10⁻¹² cm³/s, respectively, and thus make the hydroperoxide radical and ozone substantial oxidizers for NO. Thereby, NO₂ production is started. These results are in a competition of NO, NO₂ and SO₂ for O:

NO+OH+M→NO₂+M K₁₀[M]˜4×10¹² cm³/s (2)

NO₂+OH+M˜4HNO₃+M K₁₁[M]˜9×10⁻¹² cm³/s (3)

SO₂+OH+M→HSO₃+M k₁₂[M]˜7×10⁻¹³ cm³/s (4)

The crucial importance of this competitive set of termolecular reactions for the high energy electron scrubbing process arises from the following arguments:
i) reaction (4) is practically the only important SO₂ sink in homogeneous gas phase;
ii) reaction (3) is the only important source of nitric acid from neutral reactants in homogeneous gas phase;
iii) reaction (2) is a very effective NO sink, but leads only to gaseous nitrous acid;
iv) reaction (4) is followed by the fast reaction HSO₃+O₂→SO₃+HO₂, which immediately induces sulfuric acid formation and nucleation and simultaneously releases HO₂.

Its competition with reaction (2) is therefore desirable in that it both inhibits HNO₂ formation and supports the sequence:

NO+HO₂→4NO₂+OH^{M}HNO₃

The last argument clearly demonstrates the simultaneous NOₓ/SO₂ removal by high energy electron scrubbing and explains the increase of NO removal with increasing SO₂ concentration that has been observed by experiment.

Despite their basic importance, these considerations do not constitute the whole story: According to the above arguments, a kind of turnover would be expected at very high SO₂ concentrations in that they would promote NO₂ formation but also inhibit nitric acid formation by consumption of OH. In this case, NOₓ removal would decrease with increasing sulfate formation. Such a turnover has never been reported from experimental investigations.

One explanation of the experimental data is the ionic pathway, which also contributes to nitric acid formation from NO₂. This path is in perfect analogy to the ionic NO oxidation described above and the key reaction is

NO₂⁺(H₂O)₂+H₂O HNO₃+H₃O⁺(H₂O)

This ionic pathway prohibits the observation of the turnover suggested above, especially because the destruction of HNO₃ by thermal electrons, albeit fast, is of negligible importance in the present context. In fact, also in agreement with experiment, the nitric acid formation is enhanced by increasing relative humidity via the radiation induced ionic pathway mentioned above.

A second and supplementary explanation stems from the observation that NO₂ (and NO) does not only enter into oxidation reactions but also into reduction reactions, which are briefly discussed below.

4.6 Oxidation versus Reduction. Neglecting negatively charged species, which mentioned earlier are not a significant factor under flue gas conditions, H and N atoms are favorite candidates to invoke reductive pathways. The fastest radical reaction is:

N+NO→N₂+O k₁₃=3.25×10⁻¹¹ cm³/s (5)

In this reaction, nitric oxide is reduced to molecular nitrogen, which is a welcome product. Under typical conditions, experiments have demonstrated roughly 10% of the NO is removed in this way. Note that in reaction (5) an oxygen atom is released, which is a really unfavorable intermediate,

It has been shown that the oxygen atoms attach to molecular oxygen only comparatively slowly. Instead, they effectively reduce NO₂ to NO:

NO₂+O→NO+O₂ k₁₄=5.2×10⁻¹²exp(+200/T)cm³/s (6)

This unfortunate reaction opposes NO oxidation extensively. Reaction (6) has been shown to account for the nonlinear NO removal as function of dose that is observed in the experimental data that is shown in FIGS. 11; 12; 13 and 14.

The H atoms mentioned previously preferably attach to molecular oxygen thereby forming HO₂, which is needed for NO oxidation. Part of the HO₂ (and also of OH) recombines under formation of H₂O₂ and this recombination is favored by high concentrations of water vapor. H₂O₂ is comparatively stable under typical high energy electron scrubbing conditions and has a vapor pressure low enough to suggest its condensation at the particulate surface. It is now become clear that NOₓ oxidation is partly complemented by NOₓ reduction through N₂ and N₂O formation.

However, reductive pathways also oppose oxidative reactions in a way to decrease the removal efficiency with rising dose. Thus, NO_{X} removal is a nonlinear function of dose and eventually attains saturation with increasing dose.

An additional important point can be learned from further analysis of the reduction chemistry. When an SCR is employed to reduce NOx emissions, over 50% of the NOx is converted to N₂O. Up to a dose around 10 kGy, the N₂O production is only a few ppm, since the N atoms are consumed preferentially by NO. Hence, high energy electron scrubbing is greatly superior to an SCR in this respect.

4.7 Heterogeneous Reactions. In addition to the chemical pathways discussed above, heterogeneous SO₂ removal mechanisms have become well established in high energy electron scrubbing research and development work. Large amounts of SO₂ have been found to form sulfate at the filter surface and similar reactions have been suggested to occur at the surface of the aerosol during and after irradiation.

The increase of measured sulfate concentrations with rising relative humidity has been taken as a major argument for the importance of heterogeneous SO₂ oxidation. Apart from nitrous acid the most likely heterogeneous oxidizers are H₂O₂, O₃, OH, and HO₂, which may considerably promote the oxidation of sulfur dioxide in airborne particles or cloud droplets.

However, the references reviewed here indicate that the calculated intermediate concentrations of these species do not show any pronounced dependence on the relative humidity. Moreover, only ppb amounts (H₂O₂) or less (O₃, OH, HO₂) of these species can be transferred to the particulate surface at the time scale available and a very effective catalysis would be required to generate measurable amounts of sulfate thereby. A similar argument holds for the case of molecular oxygen, which supports sulfate formation in droplets only through catalysis by metal ions.

The best hypothesis is related to the radical chemistry and claims that the termolecular SO₂+OH reaction is very sensitive to water vapor as a third body. In fact, the calculated intermediate OH concentration is high enough to permit a more extensive SO₂ oxidation than derived from literature data on k₁₂ that was listed above; and therefore, this assumption was investigated in the references cited.

It suggests that the reaction below is the major sulfate formation step at relative humidities above 20%:

SO₂+OH+H₂O products→k₂₄=4.4×10⁻³⁴exp(+2400 K/T)cm⁶/s (7)

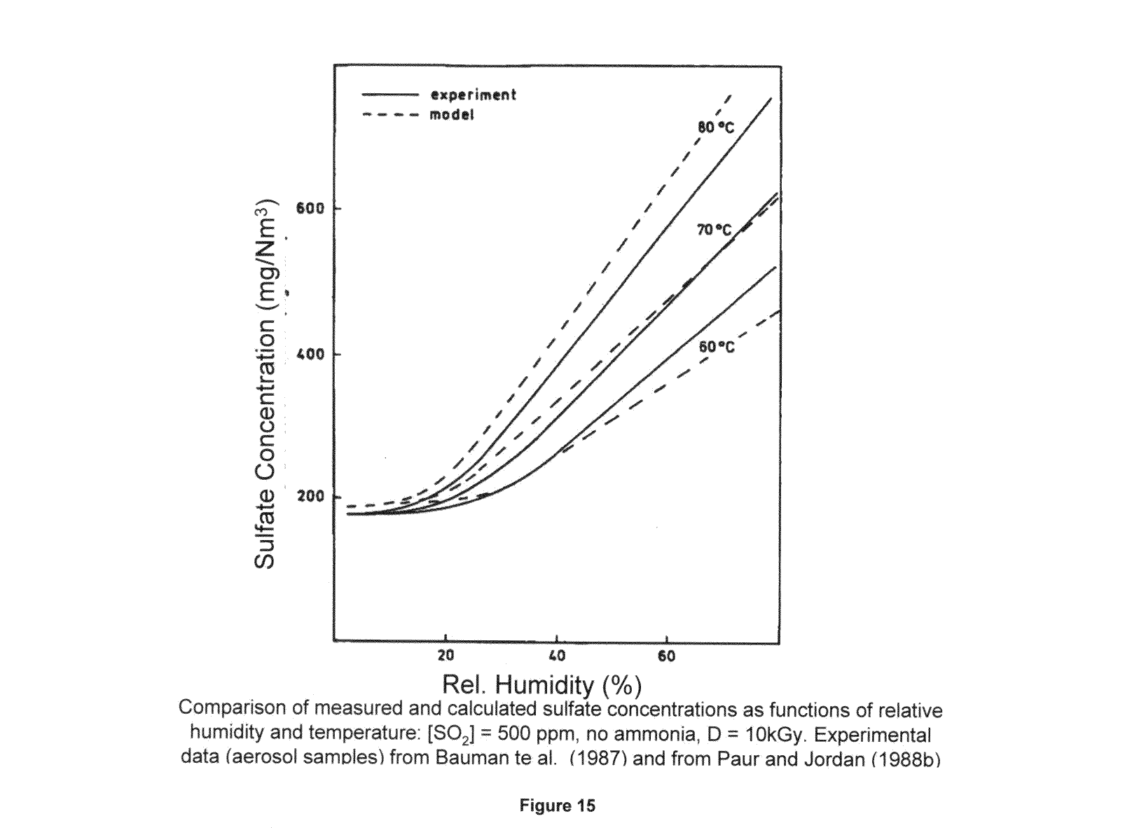

As shown in FIG. 15, close agreement between measured and calculated sulfate concentrations can be achieved in this way. It can be shown that Reaction (4) contributes only ˜200 mg SO₂⁴⁻/nm³, independent of relative humidity and temperature.

The magnitude of k₂₄ corresponds to a collisional efficiency of water which at 300° K. is about 75 times that of dry air. A small pre-exponential factor and a strongly negative formal activation energy must be chosen for reaction (7) in order to obtain agreement with experiment.

Hence, the suggested reaction (7) either represents the composite of a multistep mechanism and/or involves a strongly bonded transition state, for example, one that is associated with the nucleation of sulfuric acid. If HSO₃ radicals or H atoms are taken to be direct products of reaction (7), then it is found to contribute substantially to NO oxidation via HO₂ formation. The calculated NO removal thus becomes a linear function of the SO₂ inlet concentration, as observed in experiments.

4.8 Nucleation Considerations. Two stable acids are formed by the gas-phase chemistry of the High Energy Electron Scrubbing process, as described previously: HNO₃ and H₂SO₄. They have different physical properties and those of interest here are their vapor pressures that differ by many orders of magnitude. The vapor pressure of sulfuric acid, in particular, is so small at T=273-373 K that the existence of gaseous sulfuric acid even becomes questionable in this temperature range. It is therefore reasonable to assume that sulfuric acid nucleates prior to removal by WBC.

Previous calculations have shown that particle nucleation/coagulation cannot yield particles with diameters much larger than about 0.1 μm, since this would require coagulation times much longer than a second, that is, a much longer time than available under e-SCRUB™@Sea conditions.

Initial particulate density around 15 mg/m³, which is similar concentration to the particulate loading that is found in the auxiliary and main engines, were investigated. Experiments have shown that for this initial particulate loading, one finds a specific surface Aₛ>10 m²/g for the nucleating aerosol. This result is in excellent agreement with a rigorous treatment of the nucleation and growth of sulfuric acid droplets under high energy electron scrubbing conditions. According to previous studies, Aₛ is 30 m²/g at the incidence of H₂SO₄ nucleation and decreases to 5 m²/g within less than 2s.

Unlike sulfuric acid, nitric acid cannot be expected to nucleate under typical high energy electron scrubbing conditions and this view is strongly supported by the observation that in the absence of ammonia, no nitrate can be detected in the aerosol. Note that this experimental fact also is an argument against ion-assisted nucleation of nitric acid.

5.0 Irradiated Gas Dose; Electron Beam Power and Energy Requirements. Table 5 provides a summary of the data that is presented in FIGS. 11 through 15 inclusive. This analysis of the data was guided by the review and interpretation of the important chemical reactions that were presented in Section 4.

As shown in the references, there were two sets of experimental data that was reported by Research-Cottrell for conditions that are relevant to e-SCRUB™@Sea process. In addition, further data was taken at the Japan Atomic Energy Research Institute (JAERI). This data was found to be quite consistent with both sets of data that was taken by Research-Cottrell.

The principal findings of this analysis are the following. To achieve an overall removal efficiency of 90% SO₂ and 70% NOx [note 1 Gy=1 J/kg]:
i) set the dose delivered to the gas=8,000 Gy (10 kG=1 Mrad);
ii) satisfy the required nucleation sites by taking advantage of the initial concentration of particulate matter ˜25 mg/m³, which is present in engine's flue gas;
iii) set relative humidity of gas>14% to operate under enhanced SO₂ removal —H₂O operates as third body;
iv) e-SCRUB™@Sea process conditions have humidity >24% by mass;
v) use rectangular ducts that have opposing e-beams;
vi) insure the effective and efficient collection of by-products that are produced by using the BELCO WBC.

Using this information, we are now able to construct Table 6. Taking 8,000 Gy for the dose and starting with the mass gas flow that is given in Table 3 and 4, we are able to summarize the analysis of: electron beam power; number of electron beam modules required; process chamber cross section and axial flow velocity.

The electron beam power (P) is derived from the relationship that P=[mass flow rate (kg/s)]x[energy deposited in the flue gas (J/kg)]. The dimensions of the process chamber must incorporate the maximum range of the electron beam in the flue gas. As shown in section 3, taking the electron beam kinetic energy ˜250 keV, the range ˜60 cm. The other process chamber dimensions must be chosen to limit the axial gas low velocities. This requires an estimate of the normal volume flow rate for both the main and auxiliary engines. These calculations discussed in the Section 7.

Iterations were performed for both the main engine and auxiliary engines to determine the optimum module size for the electron beam unit. The optimization that was done took into account the requirement that, if possible, the module power should be the same for both units. The analysis finds that the optimum module power for both main engine and auxiliary engines is 60 kW that is delivered to the flue gas. The results presented in Table 6 hold for the increase in mass flow that was added to the initial mass of flue gas. This increased mass flow incorporates the increase in humidity (see Section 8) that was added to insure the optimum removal efficiency for both NOx and SO₂ (see Section 4).

Taking 60 kW as the optimum module power, we find that a single electron beam can process the flue gas from auxiliary engines, which generate an engine power from either 2.4 MW up to 3.65 MW. For a main engine that generates up to 50 MW, two electron beam process chambers are required. Each will have 8 electron beam units; thus a total of 16 e-beam units are needed.

For the main engine, there are two electron beam process chambers; each treats up to one half the gas flow from the main engine. This arrangement gives an axial flow velocity of up to 24.8 m/s for each of the electron beam process chambers that treat up to one half the flow from the main engines.

It should be noted that the electron beam generators that treat the gas flow for either the main or auxiliary engines can readily operate at lower output powers. This is accomplished by turning down the beam current, which lowers the electron beam power. This can be done without affecting the electron beam's kinetic energy, which will remain fixed at ˜250 keV. By lowering the electron beam output power in this manner, one can readily treat lower speed operating conditions that are found on the exemplary ships.

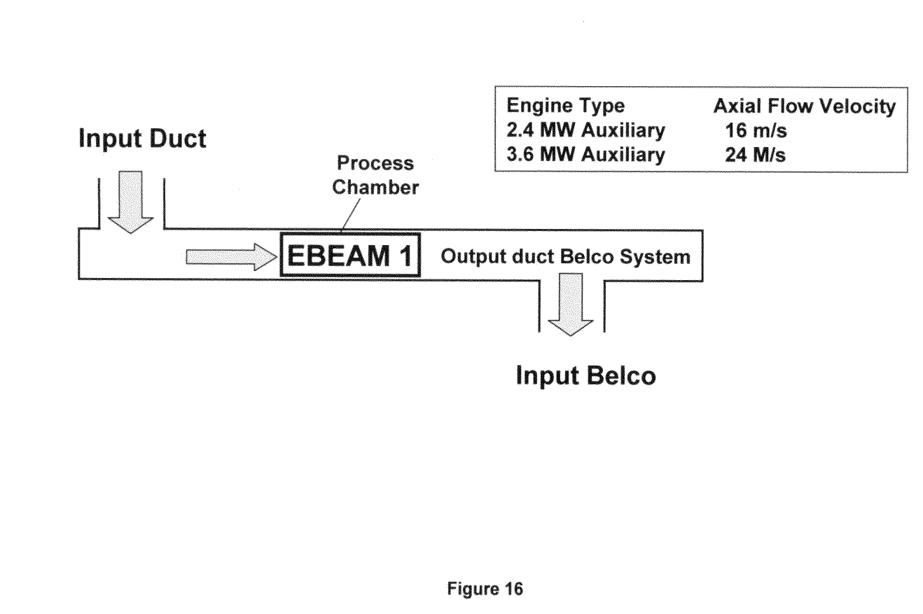

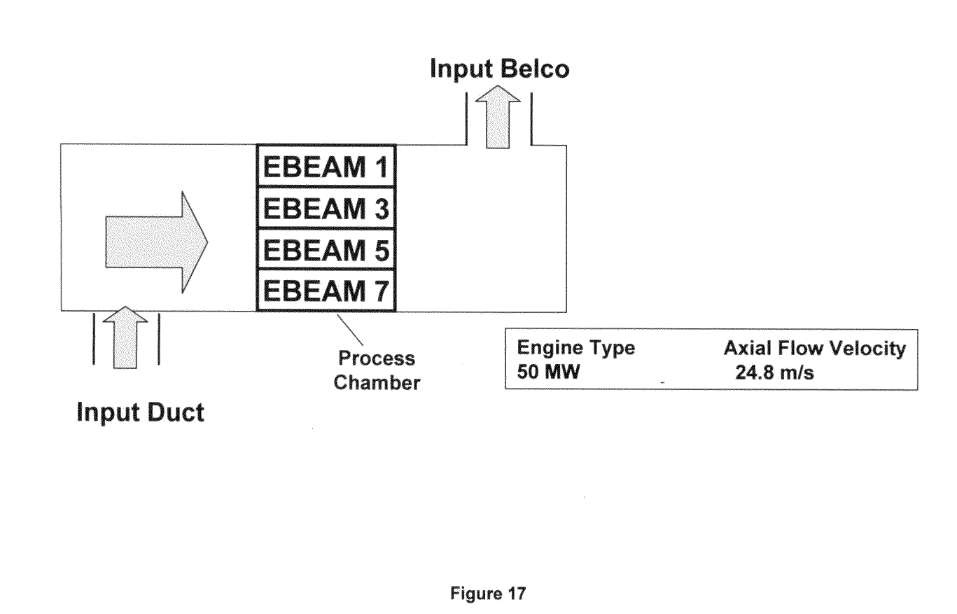

6.0 e-SCRUB™@SEA Initial Layout & Capital Cost. FIG. 16 and FIG. 17 were developed using the information about the electron beam process chamber's dimensions, an exemplary initial layout of the stack region and BELCO's WBC general layouts. As one can see, FIG. 16 shows the overall dimensions for the input and output ductwork and electron beam process chamber.

The damper arrangements for auxiliary & main stacks must be fully automated to allow the operation of e-SCRUB™@SEA process described above.

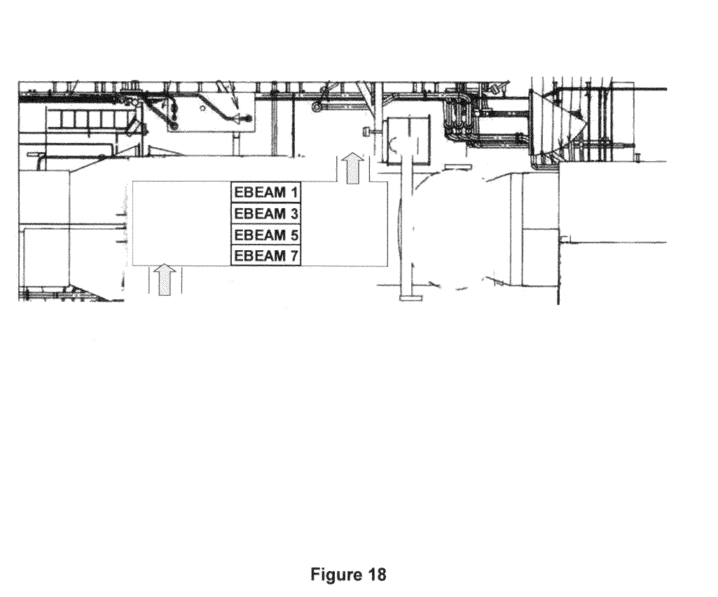

FIG. 18 shows the interface of the region around an exemplary main stack for a seagoing cargo container ship. Superimposed upon that drawing is the layout of the ductwork shown in FIG. 17 for the main engine. Here one can see that the electron beam process chambers interface quite readily with the ductwork that runs between the main stack and BELCO's WBC, which is not shown. To treat 100% of the gas flow from the main stack, a total of four BELCO's WBC are required; and a second electron beam process chamber (not shown) is placed symmetrically on the opposite side of the stack.

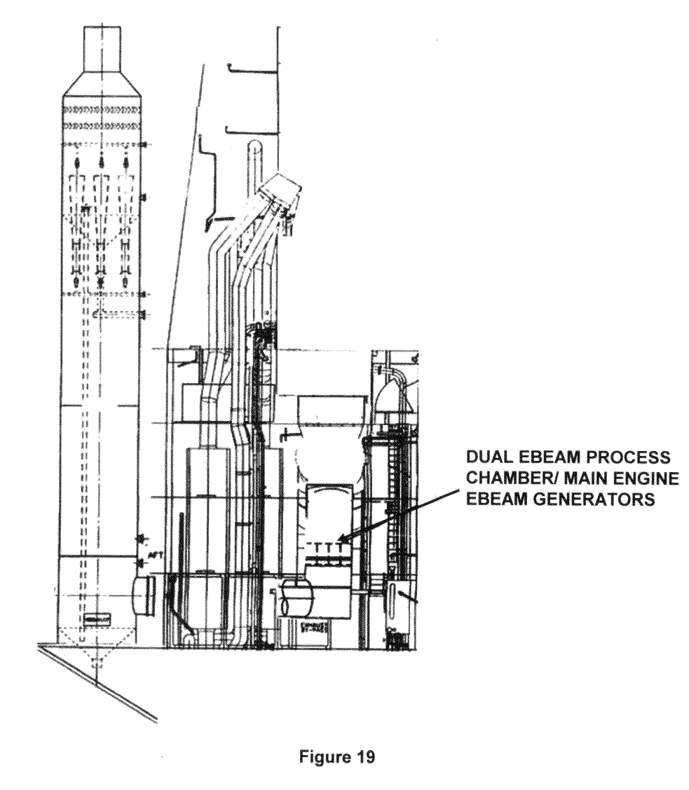

FIG. 19 show an arrangement for BELCO's WBC that interfaces with the electron beam process chamber and ductwork that was shown in FIG. 18. Note that the height of the BELCO WBC allows for the direct venting of the flue gas directly into the atmosphere without reentering the ship's existing stack.

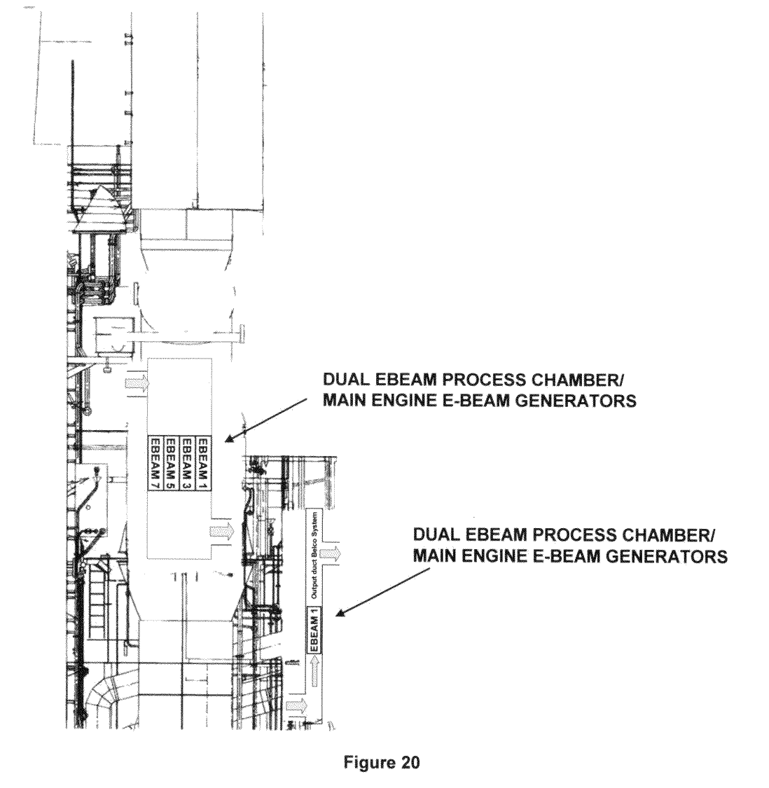

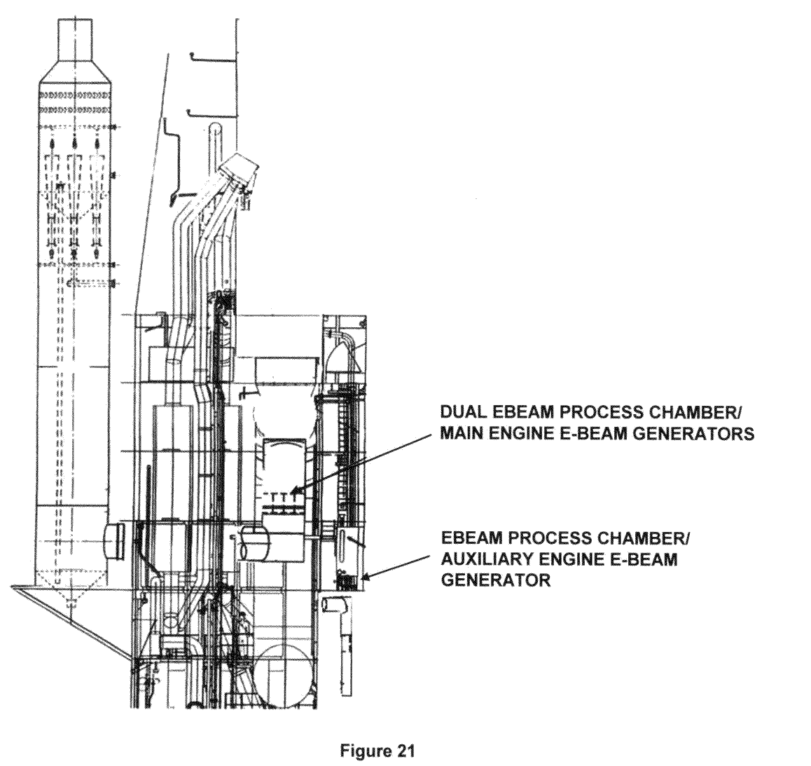

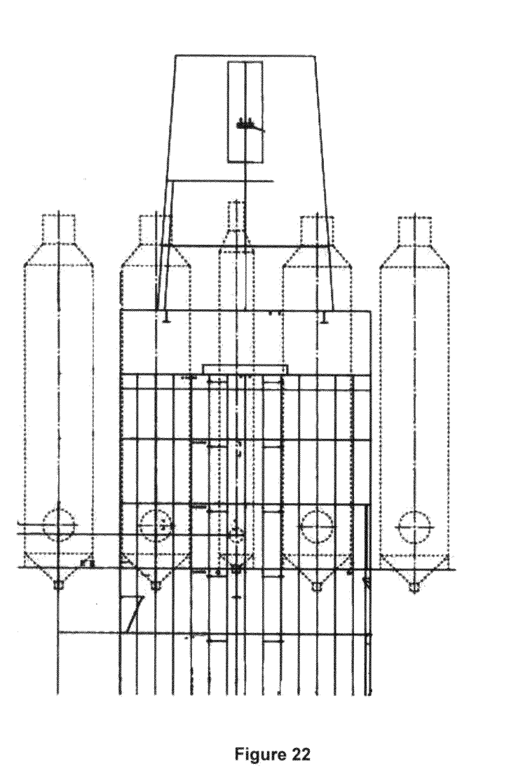

Using the information in FIG. 16, FIG. 20 and FIG. 21 show the initial concepts for both the main engine and auxiliary engine. These initial designs clearly show that it is possible to fit the e-SCRUB™@SEA equipment onto the cargo container. FIG. 22 shows another view that contains all four of BELCO's WBC, which are needed to treat the gas flow from the main engine. Two BELCO's WBC handle the gas flow from each electron beam process chamber. The smaller WBC shown in the center treats the emissions from the auxiliary engine.

Table 7 provides a summary of the over all power requirements for the main subsystems. For the case that is presented there, no fans or pumps are included for the BELCO WBC, which were initially sized to process the gas flow from the 50 MWe main engine. Based upon the duty factor that the main engines operate under, most of the operation for the BELCO WBC would not need either booster fans or pumps.

The BELCO WBC operate most effectively at high gas loadings. They are designed to reduce emissions at refineries that operate in excess of 8,000 h at full loads with very little down time. In fact, refineries often upgrade their equipment to increase output. Because of BELCO's unique design, the WBC will operate at enhanced efficiency under an increased loading ˜25%.

As noted in Table 7, the duty facto for both the engines is quite low. It probably means that the BELCO's WBC is more properly sized for a larger main engine. In addition, the low duty facto for the ship's auxiliary engine also means that a single electron beam processing chamber, which has a manifold that ties the gas flow from all the auxiliary engines together, would be more appropriate. Finally, it should be noted that the main engine never operates at even 85% loading when powering the 4 auxiliary engines.

Power for the electron beam equipment is supplied from the ship. For the system analyzed here, 55 kW (75 kW) are needed for the 2.4 MW (3.6) MW auxiliary engine. For the 50 MW main engine, 1.13 MW would be needed. This power should be provided by a step down transformer that has two taps—one for the pumps 480 V and 600 V for the electron beam equipment.

7.0 Flue Gas Analysis For e-SCRUB™@SEA. Using the gas flow concentrations that were given in Table 3 and 4 for the auxiliary and main engines, an analysis was performed to determine the flue gas characteristics. The gas flow characteristics that were analyzed included the initial and final concentrations for all constituents that was calculated for actual operating conditions and referenced to standard (normal) flow and temperature=273 OK. The initial mass flow was maintained throughout.

The increased mass flow was used in Table 6 to calculate the dose and beam power that are required to achieve removal efficiencies of 90% SO₂ and 70% NOx.

Table 8 through Table 14 contain the analysis for the ships main Engine for “Option” 2. Option 2 and Option 1 relate to different conditions in the electron scrubbing process chamber that optimizes the initial SO2 removal. In both cases, the combination of the electron scrubbing and BELCO's WBC yield removal of 90% SO₂. The initial SO₂ concentration was ˜3,000 ppmv and the initial NOx concentration ˜1,000 ppmv. The operating conditions in the electron beam processing chamber removed 70% in Option 2.

For the 50 MW main engine and Option 2, Tables 8 gives the final flue gas composition after the addition of water vapor to the gas that was needed to optimize the e-SCRUB™@SEA process. Table 9 provides the initial gas flow concentrations and flow conditions at normal temperature and pressure. The gas flow at the input to each item of equipment is given in Table 10. Normalizing the gas flow to standard pressure and temperature are given in Table 11. The increase in temperature due to deposition of the electron beam and chemical reaction products is given in Table 12. The compensation for the increase in temperature at each equipment location is shown in Table 13. The amount of acid production and consumption of water is shown in Table 14.

For the auxiliary engine and Option 2, Tables 15 gives the final flue gas composition after the addition of water vapor to the gas that was needed to optimize the e-SCRUB™@SEA process. Table 16 provides the initial gas flow concentrations and flow conditions at normal temperature and pressure. The gas flow at the input to each item of equipment is given in Table 17. Normalizing the gas flow to standard pressure and temperature are given in Table 18. The increase in temperature due to deposition of the electron beam and chemical reaction products is given in Table 19. The compensation for the increase in temperature at each equipment location is shown in Table 20. The amount of acid production and consumption of water is shown in Table 21.

For the 50 MW main engine and Option 1, Tables 22 gives the final flue gas composition after the addition of water vapor to the gas that was needed to optimize the e-SCRUB™@SEA process. Table 23 provides the initial gas flow concentrations and flow conditions at normal temperature and pressure. The gas flow at the input to each item of equipment is given in Table 24. Normalizing the gas flow to standard pressure and temperature are given in Table 25. The increase in temperature due to deposition of the electron beam and chemical reaction products is given in Table 26. The compensation for the increase in temperature at each equipment location is shown in Table 27. The amount of acid production and consumption of water is shown in Table 28.

For the auxiliary engine and Option 1, Tables 29 give the final flue gas composition after the addition of water vapor to the gas that was needed to optimize the e-SCRUB™@SEA process. Table 30 provides the initial gas flow concentrations and flow conditions at normal temperature and pressure. The gas flow at the input to each item of equipment is given in Table 31. Normalizing the gas flow to standard pressure and temperature are given in Table 32. The increase in temperature due to deposition of the electron beam and chemical reaction products is given in Table 33. The compensation for the increase in temperature at each equipment location is shown in Table 34. The amount of acid production and consumption of water is shown in Table 35.

Section 8 Electron beam Generator. The electron beam generator will be provided by North Star Power Engineering (NSPE), a division of Ionatron. NSPE has developed the commercial technology base for this application, the “Nested High Voltage Tandem Accelerator” and the “Plasma Source Ion Implementation for Enhancing Materials Surfaces”. Both of these NSPE's commercial items were noted by R&D Magazine as: “Selected by R&D Magazine as One of the 100 Most Technologically Significant New Products of the Year”.

NSPE's proposal to supply 60 kW electron beam systems, which irradiate flue gas for e-SCRUB™@Sea applications, is based upon specifications for the electron beam system that were provided by eSCRUB. NSPE will provide a single 60 kW electron beam system to treat the flue gas for the auxiliary engines. To treat the flue gas for the 50 MW main engine, a total of 16 units that are identical to the 60 kW electron beam systems that are used by the auxiliary engine will be needed.

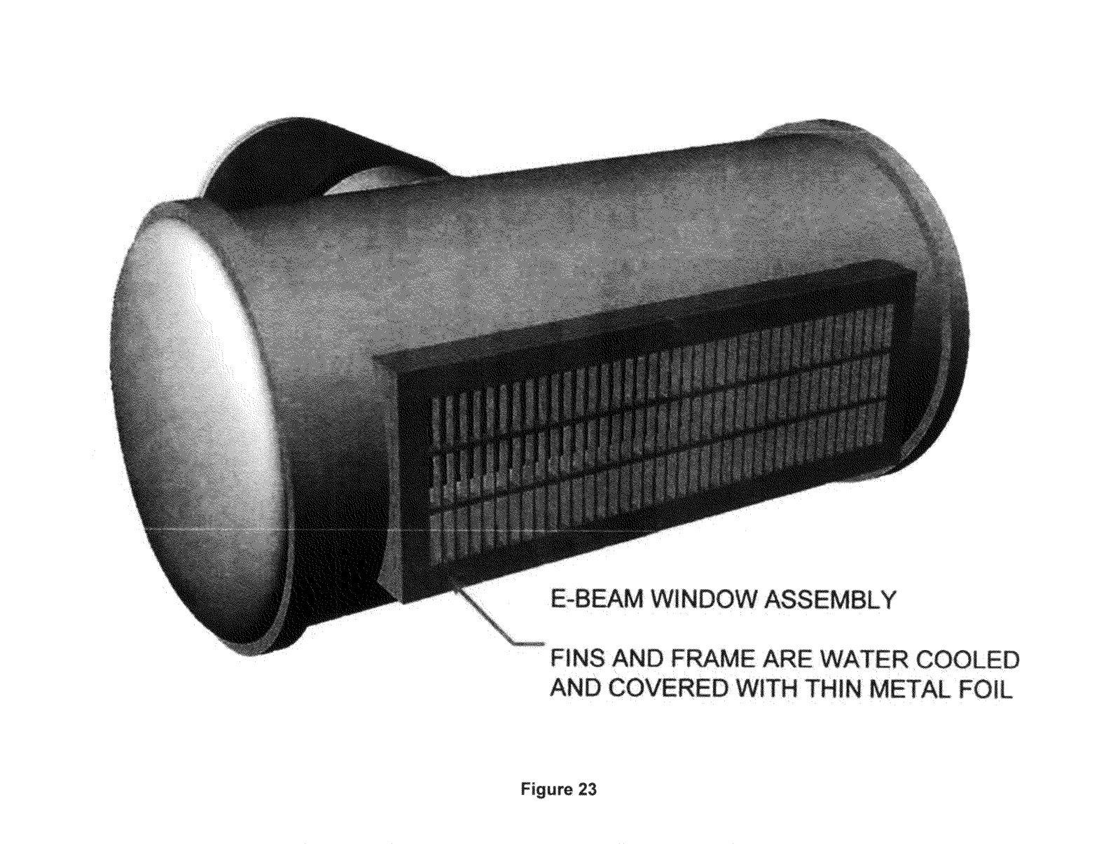

In order to achieve a gas energy deposition of 60 kW, NSPE have to take into account losses in the foil, hibachi foil support structure, and other factors. NSPE design assumes a 25 micron thick beryllium foil will be used. As shown in FIGS. 23, 24 and 25, this will be supported on conduction-cooled, mechanically-biased, copper fin array in a water cooled copper frame. This structure is colloquially known as a “Hibachi” structure. Typical guns that use titanium foil lose 20-25% of their current in the structure. However, because of beryllium has a factor of 10 higher thermal conductivity than titanium, yet similar yield strength, the foil support structure will have only half the losses or 12.5%.

In titanium foil, an additional loss from the beam kinetic energy would be ˜15 kV, which is ˜6% loss. That is, to generate a 250 keV electron in the flue gas would require an initial beam kinetic energy of ˜275 kV. Electron backscatter from a titanium foil leads to a population of electrons which are lower energy and in effect not useful, and this amounts to a 5% loss. However, use of a beryllium foil limits the beam kinetic energy loss ˜5 keV, while the scattering is negligible.

To provide 60 kW in the gas at a beam kinetic energy of 250 keV, the initial beam energy would be 255 keV at an input power of 70 kW. The beam current of 275 mA. Hence, to generate 60 kW in the gas, specifications are:

| | |
|---|---|
| Beam Voltage (electrons striking foil) | 255 kV |
| Beam Energy (Exit of foil) | 250 kV |
| Minimum Power in Gas | 60 kW |
| Minimum Power in Accelerated Electron Beam | 70 kW |
| (includes power in Hibachi losses, etc) | |
| Goal for Power in Accelerated Electron Beam | 90 kW |
| (includes power in Hibachi losses, etc) | |
| 3 Phase Input Voltage | 400 VAC 150 A, 480 VAC 120 A |
| | Or 600 VAC 100 A |
| Control Power | To be supplied from a separate 110VAC/220 |
| | VAC line to simplify troubleshooting |
| Size of core power supply unit | 50 cm (55 cm flange) Diameter |
| | Length of ~80 cm |
| Size of Window and Gun | 45 cm × 80 cm |
| Radiation Shielding | Capable of self-Shielding but no shielding |
| | will be supplied |
| CSDA Range in air (absolute max range of e-) | 60 cm after foil |
| Cooling | Water cooled ~10 Liters/minute egun |
| | 10-20 liters/minute support structure |
| Vacuum System | 10 cm ISO flange cryopump with compressor. |
| | Multiple croypumps can operate from |
| | compressor. The cryopump will have a gate |
| | valve in the first units with the necessity of a |
| | gate valve TBD in future. |
| | A 10 CFM roughing pump with a remote |
| | controlled valve is supplied for pump-down. |
| Orientation | Horizontal or vertical - planned for vertical |
| Power Disconnect Switch | (Mechanical lever type for lockout/tagout) |
| Circuit Breaker | As appropriate for type of power input selected |
| Contactor | Enables/connects 3 phase power to system |
| Remote PC type Control | Touch screen or membrane keyboard/mouse |
| | equivalent proposed) |
| User Controls: | |
| Voltage Control | |
| Current Control | |
| Warm-up Sequence On/Off | |
| Vacuum System On | |
| Monitors | |
| Voltage Output | |
| Current Output | |
| Warm-up Status | |
| Vacuum sequence Status | |
| HV Line Power Status | |
| Optional Internal Radiation meter | |
| Optional External Radiation meter | |
| Maintenance Controls | |
| Filament Current | |
| Filament Voltage | |
| Emergency Stops | |
| At accelerator | |
| At control panel | |
| Orientation | Horizontal or vertical- planned for horizontal |

An accelerator with the specification given above can be built in several different ways. The trade-offs are cost, complexity, suitability to task and reliability. Perhaps the most important factor will be reliability in an environment which has relatively severe temperature conditions, and requires the ability to run with some shock vibration and unpredictable motion.

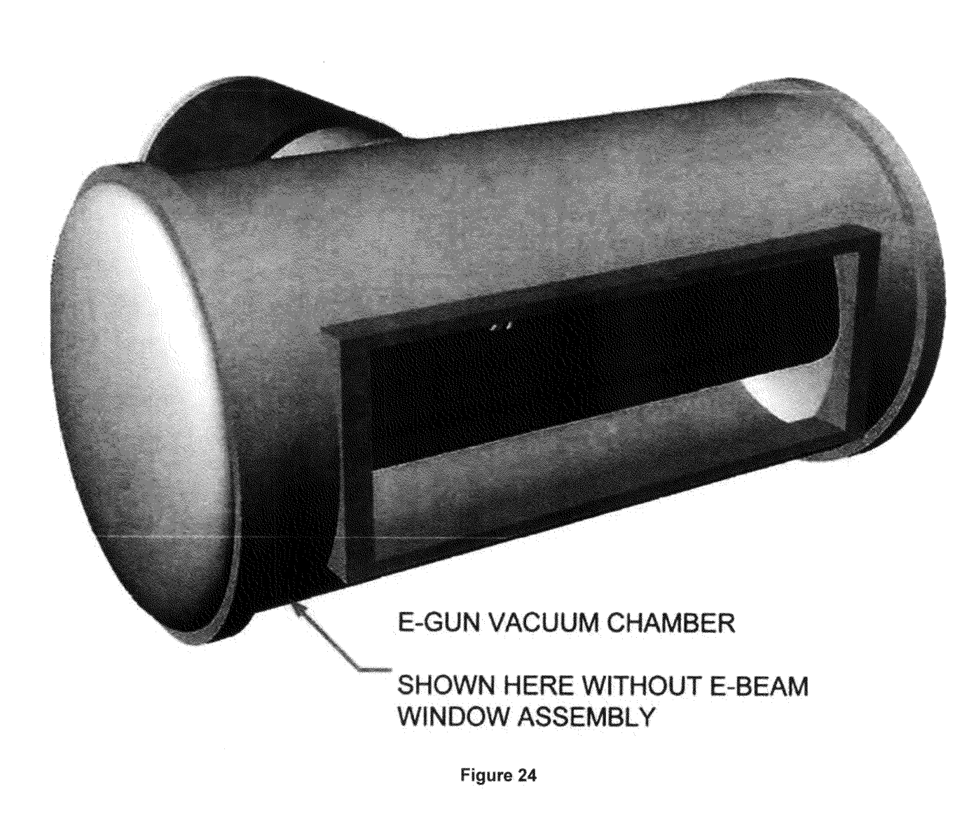

NSPE has several products for building equipment to this specification. NSPE has selected their “NHVG” technology—U.S. Pat. No. 5,124,658. To meet the e-SCRUB™@SEA specifications, NSPE has adapted their patented technology. FIGS. 24, 25, 26 and 27 show the modification this technology by NSPE that meets all of system requirements given above.

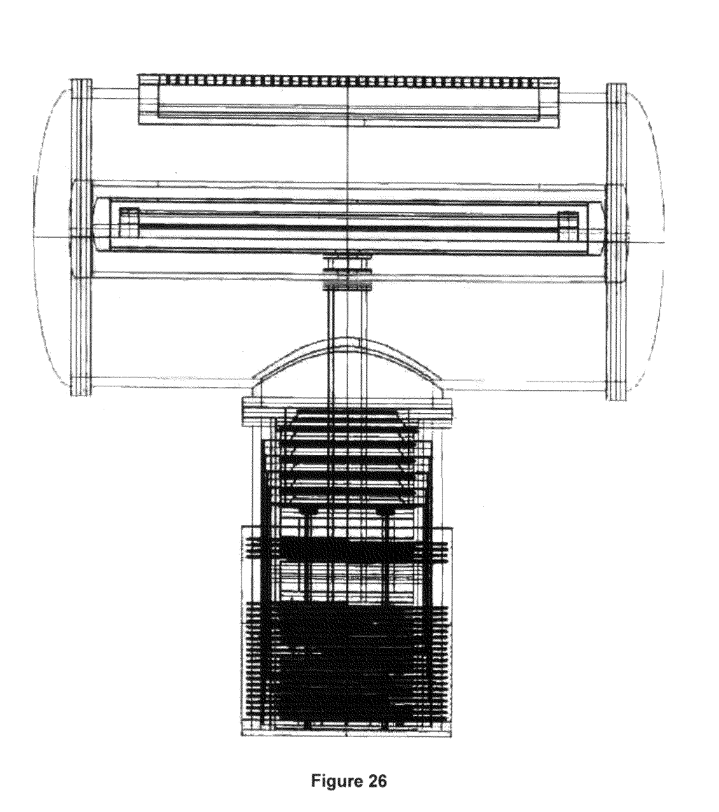

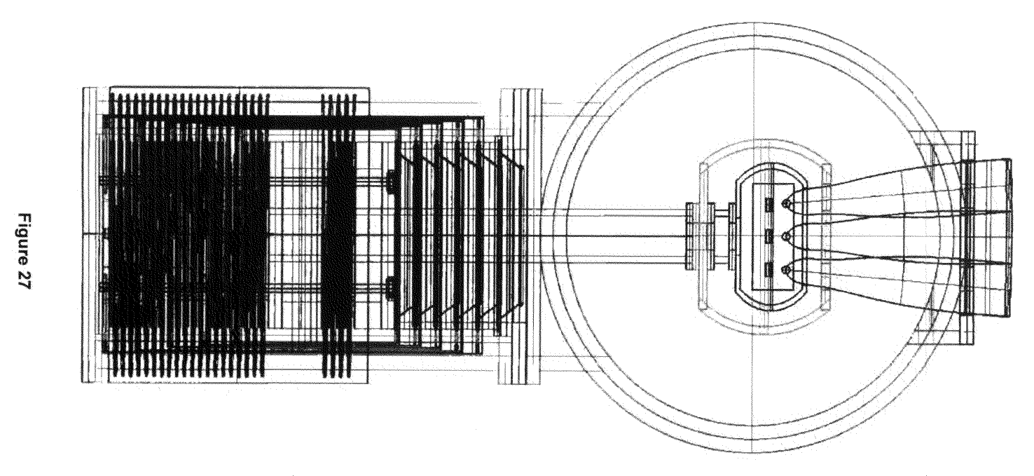

As illustrated in FIGS. 26 and 27, this type of high voltage (HV) generator has a well supported internal structure and we expect it to be smaller than other systems of this type. NSPE's reasons for using this type of accelerator is to create an integral structure consisting of the electron gun and the power supply.

Thus the size and the excellent physical supports of the NHVG topology are the reasons for this selection. The selection of the liquid insulation to be used will depend on temperature range of operation. The solid insulation will be Kapton polyimide film due to its excellent temperature characteristics and excellent radiation resistance.

The HV system will run from a 400 VAC, 480 VAC or 600 VAC 3 phase AC line which results in a rectified voltage of approximately 600 VDC. An other Nested topology with similar air core resonant topologies were selected to verify design parameters. Since this application is lower in voltage and higher in current than other NHVG systems, the unit may be simulated using an equivalent circuit.

The Nested topology creates power at high voltage in a manner similar to some other HV technologies. The primary and secondary are designed with intermediate (0.4-0.7) coupling to allow voltage build-up through primary resonance. The specific circuit values are:

| | |
|---|---|
| Primary Inductance | 58 μH |
| Secondary Inductance | 6000 μH (effective cumulative) |
| Coupling | 0.5 |
| Operating frequency | 30 kHz |
| Primary Series resonant capacitor | 51 nf |
| Energy Stored in Primary in operation | 6 J |
| Primary voltage | 5-6 kV peak |
| Primary turns | 14 |
| Primary current | 210 A RMS |

The primary turns are wound on the outside with multiple parallel layers. The inside consists of the standard NHVG radial insulation structure with internal multipliers which have the following parameters based on previous designs and circuit simulations:

Multiplier Parameters

| | |
|---|---|
| Number of turns | 100 |
| Multiplier AC input voltage | 45 kV peak |
| Multiplier series capacitance | 240 pf/stage |
| Multiplier shunt capacitance | 240 pf/stage |
| Shunt safety resistance | 1000 megohms (0.5 seconds |
| | discharge time) |
| Size of multiplier | 6.3 cm long × 37.5 cm diameter |

A noteworthy feature of the NHVG design is the low stored energy in the machine which allows the machine to go from full irradiation to “safe” in less than 1 second on turn-off or when an emergency stop is pressed.

The primary power is designed to match the requirements of the multiplier/HV circuit. It will consist of 8 parallel IGBT H-bridge modules with 1200 V capability and built-in fast diodes. The 6 kV eventually developed is applied across the resonant primary coil and capacitor and is never across the IGBT modules due to the protective effect of the anti-parallel diodes in the bridges. These are simulated using 4 switches and anti-parallel diodes in the simulation model.

The current per bridge is 300 A peak or 38 A/bridge—well below the rated current of the bridge. Each 4-bridge unit is housed in a standard 19″ wide rack module. These modules can be far (30 meters or more) from the actual gun/power supply setup. The resonant capacitor is distributed between modules and they are housed in the H-bridge boxes. In NSPE's proposed arrangement each H-bridge box has a rectifier built-in so all H-bridge boxes plug into the common AC mains. Note that this proposed arrangement eliminates troublesome X-ray cables which could otherwise be used. The maximum cable voltage required in this approach is 6.2 kV.

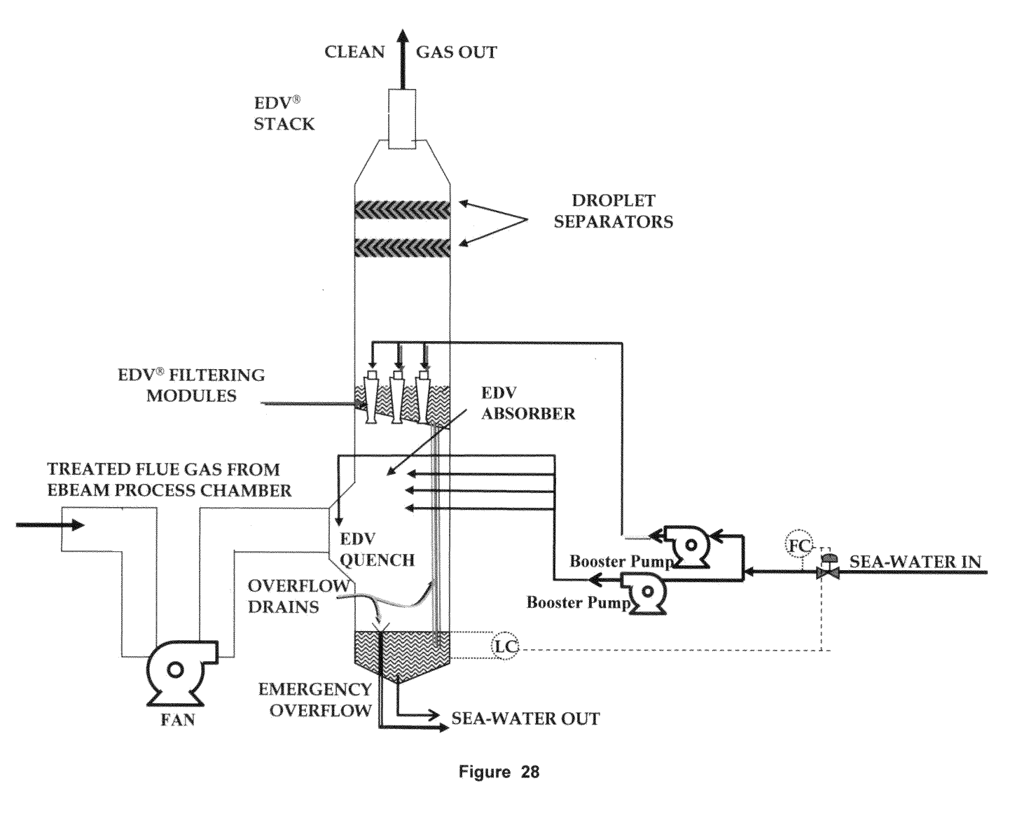

Section 9 Revised Design & Duty Factor Considerations. FIG. 28 shows a revised design for the wet by-product collector. This design has both auxiliary fans and seawater pumps.

The initial analysis showed that 100% of the flow for the wet by-product collector could be supplied from the ship's sea water return loop. When operated at full capacity, the ship's seawater return, which has two loops, will discharge ˜6,060 m³/h to the sea at temperatures in the range of 45° C. to 50° C. The pressure in this loop is in the range 2 bar. When operated with appropriate duty factor (see below), three wet by-product collectors are needed. Each unit needs 1,435 m³/h, which yields 4,305 m³/h. The auxiliary unit needs just 292 m³/h. Hence the total water flow is just <4,600 m³/h.

The total pressure that would be required by the wet by-product collector is 4.8 bar. Thus, if allowed to use the seawater return loop, the pump power is reduced by 42%; and this will limit the pump power to 213 kW per wet by-product collector. If one cannot use the seawater return loop and must draw the seawater directly from the ocean, the pump power is 366 kW per wet by-product collector. Thus, the three Belco's wet by-product collectors will use 639 kW with the seawater return system or 1,098 kW without.

The properties of the seawater that is discharged overboard by the wet by-product collector are as follows:

| | |
|---|---|
| pH of seawater | 2.75 |
| total dissolved solids (% wt) | 4.3 |
| total suspended solids (mg/l) | 2.44 |
| temperature of water [assumes | 36.9 |
| input temperature ~30° C.] (° C.) | |

The appropriate authorities should be able to permit these concentrations.

As noted FIG. 28, auxiliary fans are now included. The e-SCRUB™@SEA's pressure drop is determined completely by Belco's wet by-product collectors, which need ˜63.5 cm of WC. As noted earlier, after the exhaust boiler, the engine's gas flow can support ˜35 cm WC. Thus, approximately 50% of the pressure difference (˜31.75 WC) must be supplied by auxiliary fans. The fan power is estimated at 93 kW per wet by-product collector to support the main engine's exhaust flow. In addition, ˜4.5 kW needs to be supplied for the fan that supports the gas flow for the auxiliary engine.

Table 36 provides exemplary ship operating conditions. As shown in Table 36, the ships are limited to operating at 90% of rated output for the ship's main engine. An analysis of the data that is given in Table 36 indicates the following:

1) only 12.6% of the time does the ship operate at ˜96% of rated output;
2) over 88.4% of the time the ship operates ≦86% of rated output.

Using that data, we can construct Table 37, which is titled the e-Beam Power/Number of e-Beam Modules/Duty Factor/Process Chamber Cross Section and Axial flow Velocity. As shown there, because of the reduced duty factor, three wet by-product collectors are needed to process the flow. Approximately 12.6% of the time, the wet by-product collectors will operate at ˜11% added flow, which these units are ideally designed to handle.

To treat the flue gas with the duty factor in Table 36, the e-beam process chamber needs just six e-beam generators are required. Again, the axial flow velocities are in the range of ≦25 m/s.

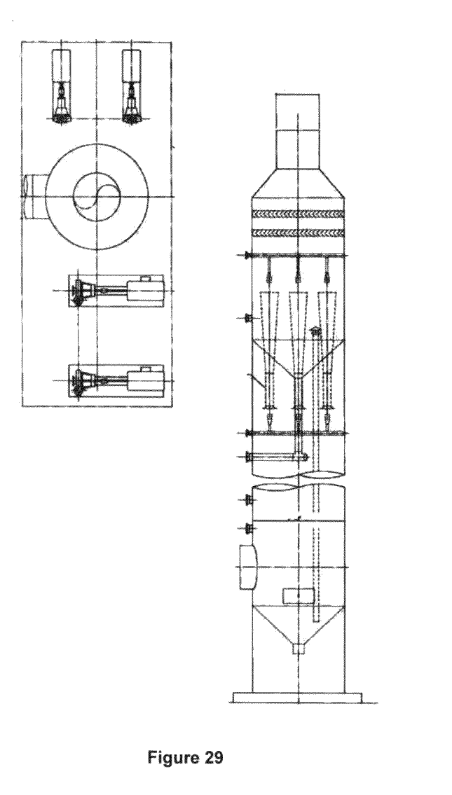

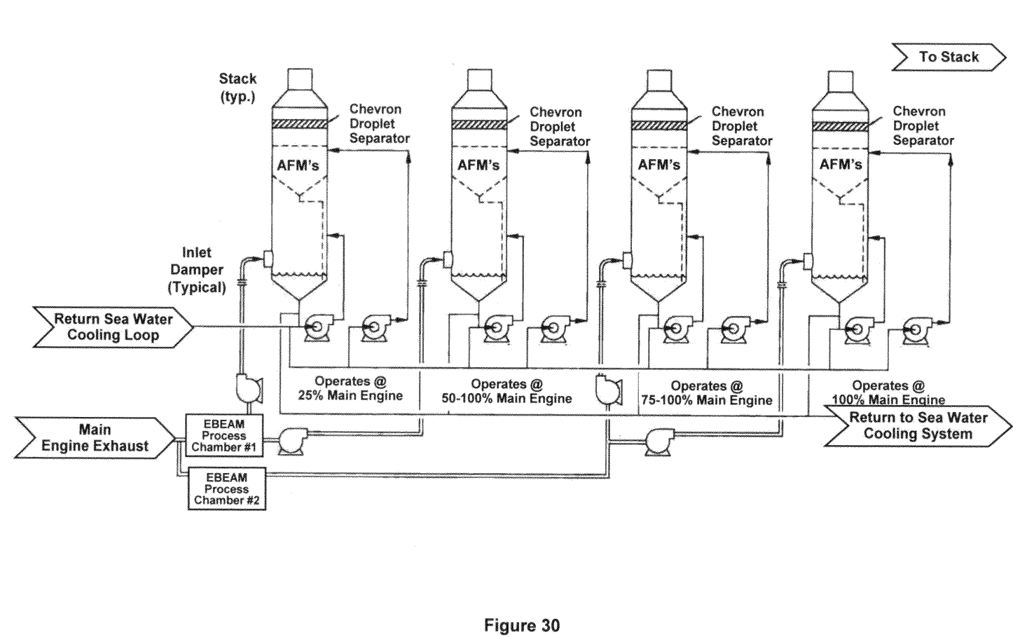

FIG. 29 show the wet by product collector layout for the main engine. Both plan & elevation views are given. FIG. 30 shows the main engine process flow diagram. This arrangement is for the original configuration for the main engine without any correction for the duty factor considerations given in Tables 36 and 37. Hence, provisions are made for four wet by-product collectors.

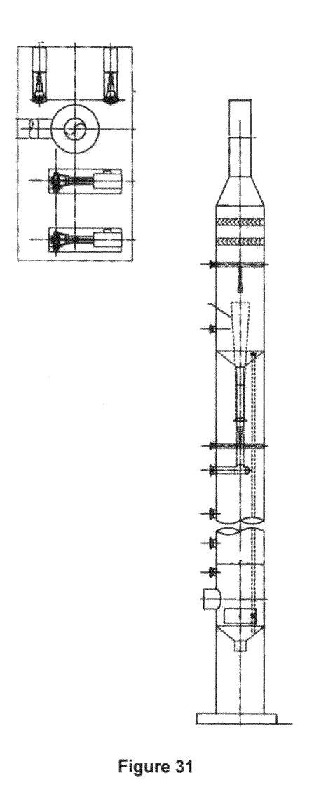

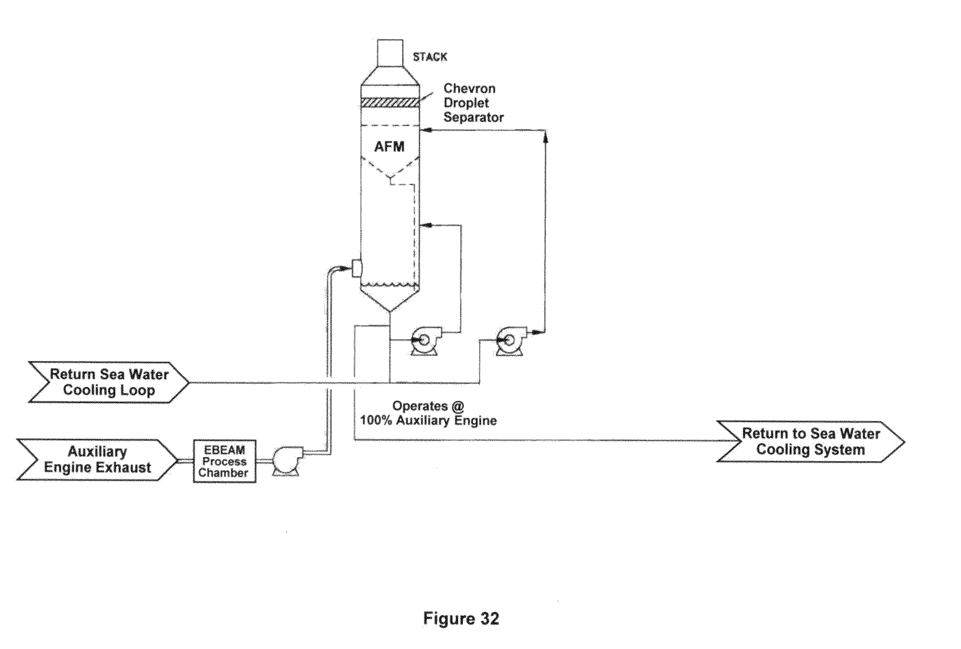

FIG. 31 shows the wet by-product collector arrangement for the auxiliary engine. Both plan and elevation views are presented. FIG. 32 shows the process flow diagram for the auxiliary engine.

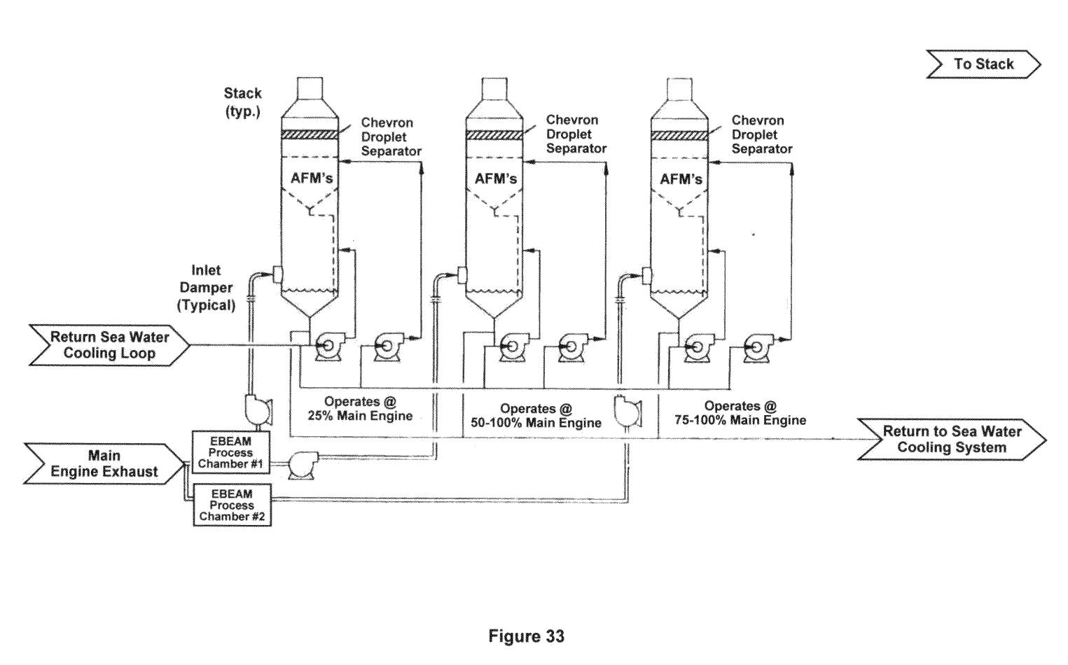

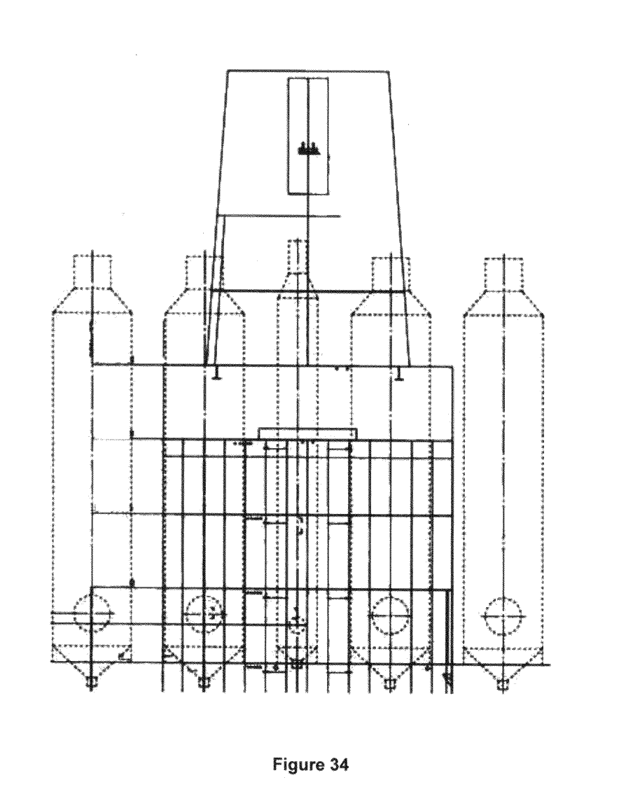

FIG. 33 shows the process flow diagram for the main engine when the duty factor (Tables 36 & 37) is taken into account. Here one sees that provisions are made for three wet by-product collectors. FIG. 34 shows the e-SCRUB™@Sea equipment layout for both main and auxiliary engines. This arrangement shows three wet by-product collectors for the main engine and one for the auxiliary engine.

If not allowed to use the seawater return loop for the 50 MW main engine, then the e-SCRUB™@SEA's total power requirements are 1,842,967 W. Of this amount, 1,098,000 W are for Belco's pumps. However, this load is only operating when the main engine is under the regulatory requirements to limit its emissions and thus can be turned off. A step down transformer must be provided by Maersk that provides two taps—one for electron beam generator (600 V) and one for the pumps and fans (480V).

The transformer tap at 600 V should be sized to supply ˜62,596 W for the e-beam system that treats the gas flow from the auxiliary engine and 465,967 W for the e-beam system that treats the gas flow from the 50 MW main engine. The transformer tap at 480 V should be sized to supply ˜77,464 W for Belco's pumps & fans that treats the gas flow from the auxiliary engine and 1,377,000 W for Belco's pumps & fans that treats the gas flow from the 50 MW main engine.

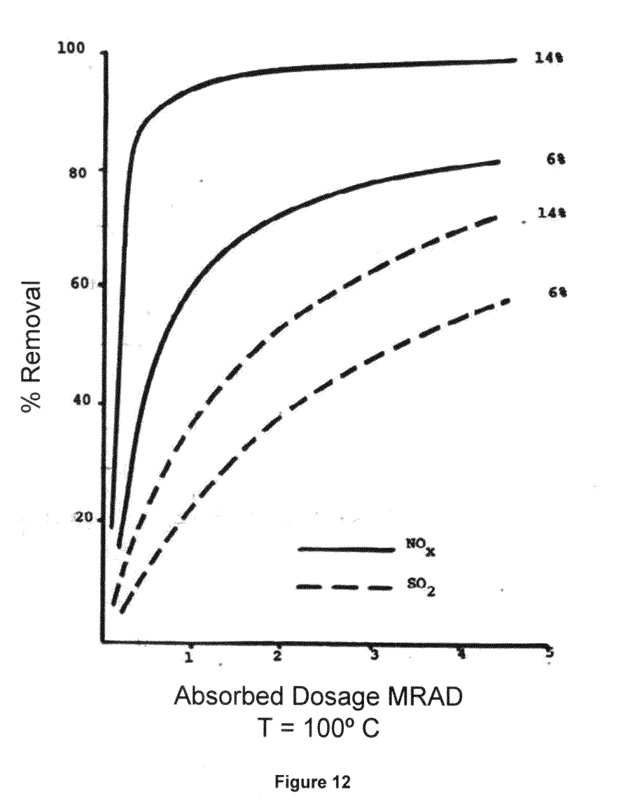

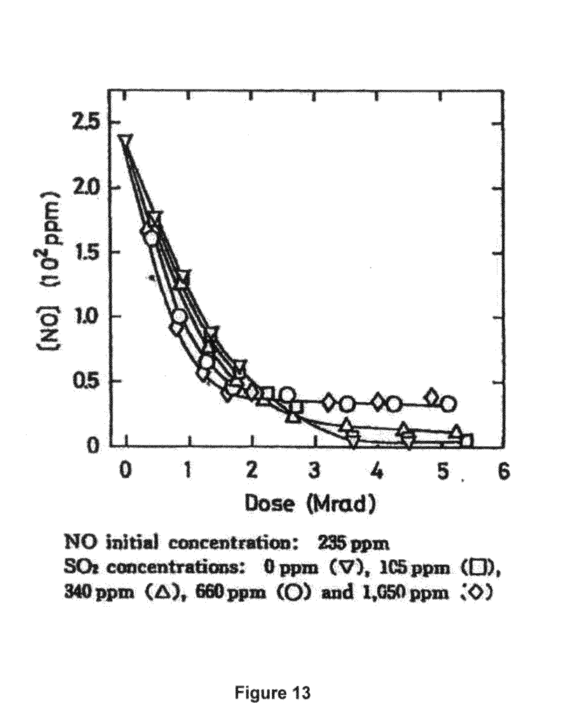

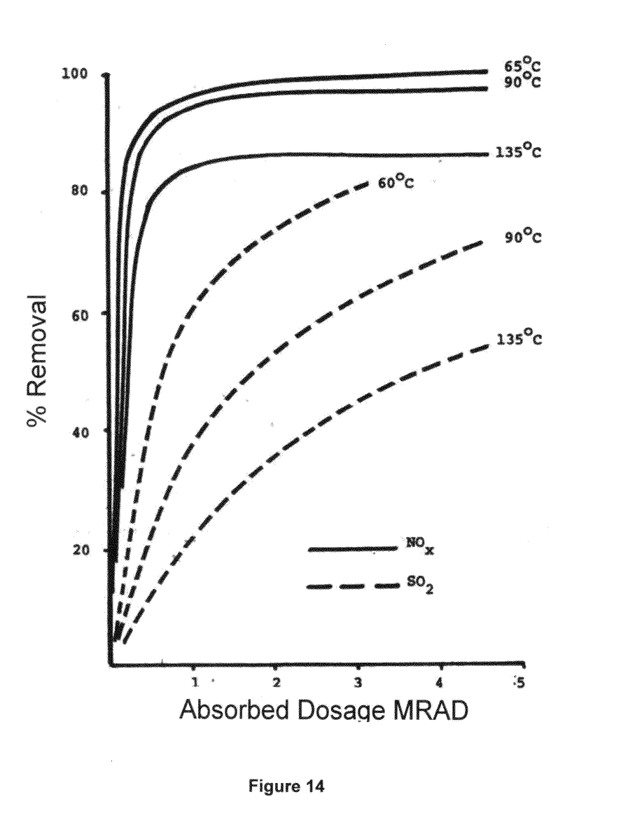

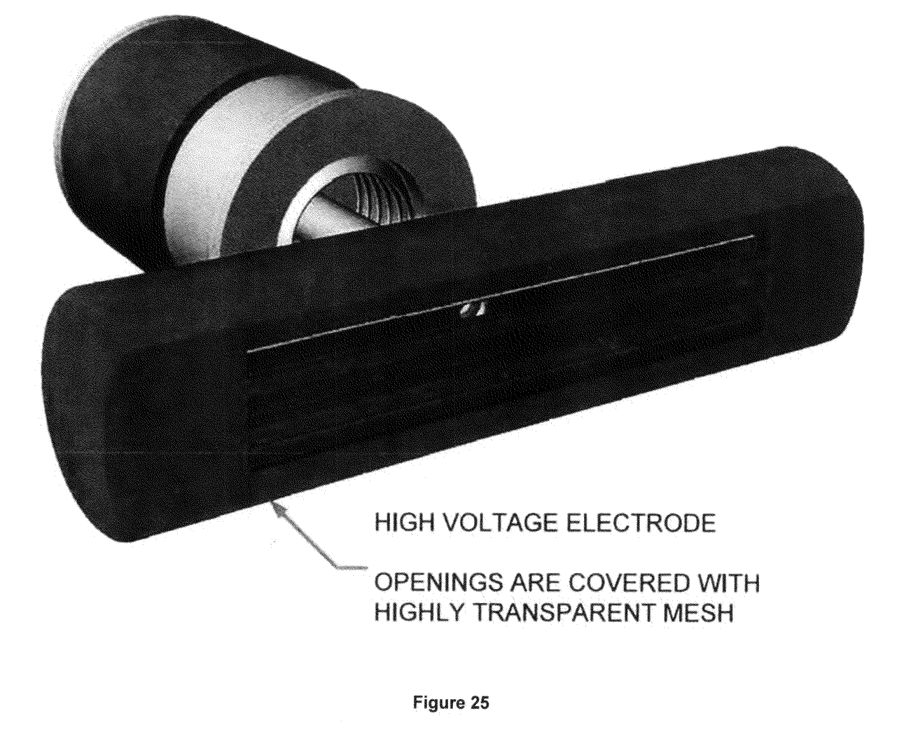

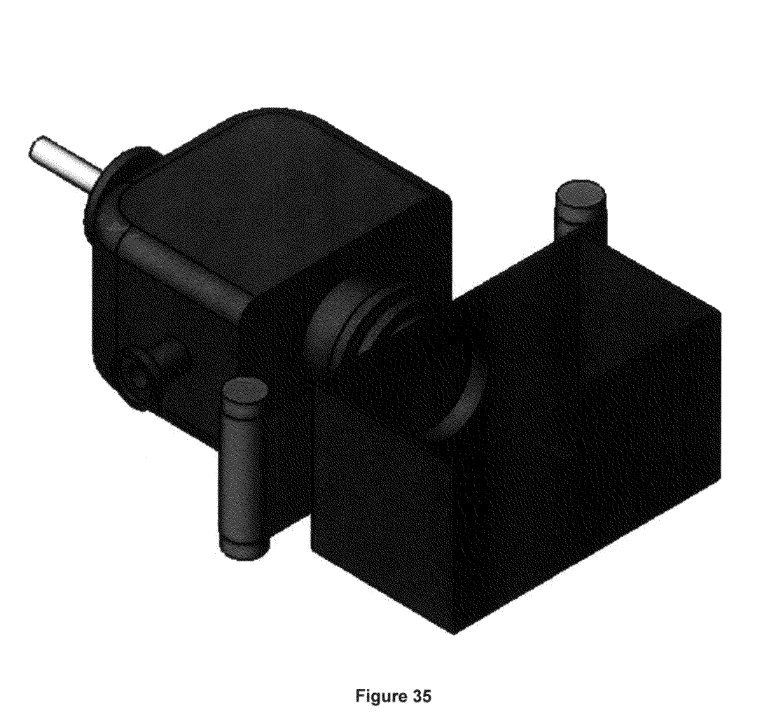

WET-DISCHARGE ELECTRON BEAM FLUE GAS SCRUBBING TREATMENT
List of Figures

| FIG. | Description | Page # |
|---|---|---|
| FIG. 1 | e-SCRUB ™ Equipment To Reduce Emissions of SO2, NOX | 1/36 |
| | and PM2.5 From Older & Smaller Power Plants That Burn High Sulfur | |
| | Fuel | |
| FIG. 2 | e-SCRUB ™ Process Flow Diagram | 2/36 |
| FIG. 3 | Electron Scrubbing Chemistry With Ammonia | 3/36 |
| FIG. 4 | Aux Engine Configuration - Fans Not Shown | 4/36 |
| FIG. 5 | Main Stack Configuration - Fans Not Shown | 5/36 |
| FIG. 6 | e-SCRUB ™@Sea -- Electron Scrubbing Chemistry Without | 6/36 |
| | Ammonia | |
| FIG. 7 | EDV ® Wet By-Product Collector Initial Design | 7/36 |
| FIG. 8 | EDV ® Wet By-Product Collector Process Description | 8/36 |
| FIG. 9 | Multiple G ® Nozzle Operation | 9/36 |
| FIG. 10 | EDV ® Wet By-Product Collector Condensation & Filtration | 10/36 |
| FIG. 11 | EDV ® Wet By-Product Collector Condensation & Filtration | 11/36 |
| FIG. 12 | Research Cottrell Data -- Removal Efficiency of SO2 and NOx | 12/36 |
| | via Formation of Acid Mists (2) | |
| FIG. 13 | JAERI Data -- Removal Efficiency of SO2 and NOx via | 13/36 |
| | Formation of Acid Mists | |
| FIG. 14 | Research Cottrell Data -- Removal Efficiency of SO2 and NOx | 14/36 |
| | via Formation of Acid Mists (3) | |
| FIG. 15 | SO2 Removal Enhanced Under High Humidity Conditions H2O | 15/36 |
| | Acts As A Third Body | |
| FIG. 16 | e-Beam Process Chamber Interface - Auxiliary Engine | 16/36 |
| FIG. 17 | E-Beam Process Chamber Interface - Half Flow Main Engine | 17/36 |
| FIG. 18 | Interface Dual e-Beam Process Chambers With Main Engine | 18/36 |
| | Stack & Output Ducts To Belco Equipment | |
| FIG. 19 | Initial e-SCRUB ™@Sea Equipment Layout For Main & | 19/36 |
| | Auxiliary Engines (1) | |
| FIG. 20 | Interfaces e-Beam Process Chambers With Main & Auxiliary | 20/36 |
| | Engine Stacks/Output Ducts To Belco Equipment | |
| FIG. 21 | Initial e-SCRUB ™@Sea Equipment Layout For Main & | 21/36 |
| | Auxiliary Engines (2) | |
| FIG. 22 | Initial e-SCRUB ™@Sea Equipment Layout For Main & | 22/36 |
| | Auxiliary Engines (3) | |
| FIG. 23 | Electron Beam Window Assembly | 23/36 |
| FIG. 24 | Electron Gun Vacuum Chamber Interface | 24/36 |
| FIG. 25 | High Voltage Electrode Assembly | 25/36 |
| FIG. 26 | Electron Beam Generator | 26/36 |
| FIG. 27 | Electron Beam Generator Plan View | 27/36 |
| FIG. 28 | EDV ® Wet By-Product Collector Design With Fan & Pumps | 28/36 |
| FIG. 29 | Wet By-Product Collector Main Engine - Plan & Elevation | 29/36 |
| FIG. 30 | Main Engine Process Flow Diagram - Four Wet By-Product | 30/36 |
| | Collectors | |
| FIG. 31 | Wet By-Product Collector Auxiliary Engine - Plan & Elevation | 31/36 |
| FIG. 32 | Auxiliary Engine Process Flow Diagram | 32/36 |
| FIG. 33 | Main Engine Process Flow Diagram - Three Wet By-Product | 33/36 |
| | Collectors | |
| FIG. 34 | e-SCRUB ™@Sea Equipment Layout For Main & Auxiliary | 34/36 |
| | Engines With Duty Factor | |
| FIG. 35 | Beryllium Window and Sacrificial Foil Assembly | 35/36 |
| FIG. 36 | Main & Auxiliary Engine Process Flow with Manifold - Single | 36/36 |
| | Wet By-Product Collector | |

TABLE 1
Emission Reduction Objectives (1)
Emission requirements and expected removal efficiency

| | | | | Expected |
|---|---|---|---|---|
| | | Regulations | Regulations | emission levels |
| | Current | 2011 | 2016 | using e-beam + |
| | regulations | (prognosis) | (prognosis) | scrubbing |
| SOx | Zones: 1.5% | Zones: 1.0% | Zones: 0.1% | 0.1% |
| | Global: 4.5% | Global: 3.5% | Global: 3.5% | |
| | | | ? 0.5% (2020) | |
| NOx | 17 g/kWh | 14.4 g/kWh | 3.4 g/kWh | 3.4 g/kWh |
| PM | — | Zones: | Zones: reduce | 0.003 g/kWh |
| | | 0.5 g/kWh | by 80% | |

TABLE 2
Emission Reduction Objectives (2)
Electronic scrubbing - proposal
Objectives

Reduce SOx emissions by 90-95%
Reduce NOx emissions by (at least) 60-70%
Reduce particulate matter emission by more than 95%

TABLE 3
Exemplary Input Data - Auxiliary Engine

| | | | Spec | | | |
|---|---|---|---|---|---|---|
| | | | ex- | | | |
| | | | haust | | | |
| | | | flow | | # | # |
| Load = | | | kg/ | # | kG/ | kG/ |
| 100% | % | | kWh | kW | hour | s |
| | | | 6.77 | 2400 | 16,248 | 4.51 |
| N2 | 74.98 | | | | | |
| O2 | 11.26 | | | | | |
| CO2 | 6.07 | | | | | |
| H2O | 6.9 | | | | | |
| Ar | 0.38 | | | | | |
| subtotal | 99.59 | | | | | |
| | | % | | | | |
| CO (ppm)* | 80 | 0.008 | | | | |
| NOX (ppm) | 979 | 0.0979 | | | | |
| SO2 (ppm) | 2700 | 0.27 | Maximum = 4.5% | | | |
| | | | (global average is 2.7%) | | | |
| HC (C3) | 328 | 0.0328 | | | | |
| (ppm) | | | | | | |
| subtotal | | 0.4087 | | | | |
| total | | 100.00 | | | | |
| PM | | | | | 7.20E−01 | |

| Load | Exhaust temperature in degree C. |
|---|---|
| 25% | 275 |
| 50% | 320 |
| 75% | 340 |
| 100% | 390 |

*assumes ppm is parts per million volume

TABLE 4
Exemplary Input Data - Main Engine (1)

| | | | Spec | | | |
|---|---|---|---|---|---|---|
| | | | ex- | | | |
| | | | haust | | | |
| | | | flow | | # | |
| Load = | | | kg/ | # | kG/ | # |
| 100% | % | | kWh | kW | hour | kG/s |
| | | | 6.77 | 5.00E+04 | 338,500 | 94.03 |
| N2 | 74.98 | | | | | |
| O2 | 11.26 | | | | | |
| CO2 | 6.07 | | | | | |
| H2O | 6.9 | | | | | |
| Ar | 0.38 | | | | | |
| subtotal | 99.59 | | | | | |
| | | % | | | | |
| CO (ppm)* | 80 | 0.008 | | | | |
| NOX (ppm) | 979 | 0.0979 | | | | |
| SO2 (ppm) | 2700 | 0.27 | Maximum = 4.5% | | | |
| | | | (global average is 2.7%) | | | |
| HC (C3) | 328 | 0.0328 | | | | |
| (ppm) | | | | | | |
| subtotal | | 0.4087 | | | | |
| total | | 100.00 | | | | |
| PM | | | | | 1.50E+01 | |

| Load | Exhaust temperature in degree C. |
|---|---|
| 25% | 293 |
| 50% | 255 |
| 75% | 277 |
| 100% | 295 |

*assumes ppm is parts per million volume

TABLE 5
Required Dose & Other Conditions For Efficient
Removal of SO2 and NOx by e-SCRUB ™@SEA

JAERI data consistent with Research Cottrell data
To achieve ovarall removal efficiency = 90% SO2 & 70% NOx:
Set dose delivered to gas = 8,000 Gy (10 kGy = 1 Mrad)
Required nucleation sites are satisfied by particulate concentration
Humidify gas ≧14% -- gas humidity ranges from 20%-24%
Use rectangular ducts with opposing e-beams
Insure collection of by-products produced via a wet by-product
collector

TABLE 6
e-beam Power/Number of e-Beam Modules/Process Chamber Cross Section and Axial Flow Velocity

| | | | | | | | | | # 60 kW |
|---|---|---|---|---|---|---|---|---|---|
| | | | | | | | | e-beam | deposited |
| | | | normal | | | e-beam | | generator | beam |
| | boiler power | | volume flow | mass fow | | power | | output power | power |
| Unit | MWe | | rate nm3/h | rate kg/s | dose (Gray) | required (W) | | (W) | modules |
| Auxiliary | 2.4 | | 15,554 | 5.17 | 8.00E+03 | 4.13E+04 | | 6.00E+04 | 1 |
| | 3.6 | | 23,331 | 7.11 | 8.00E+03 | 5.69E+04 | | 6.00E+04 | 1 |
| | | | normal | | | | deposited | | |
| | main boiler | | volume flow | mass flow | | | beam power | | Number of |
| Unit | MWe | | rate nm3/h | rate kg/s | dose (Gray) | | per unit (W) | Unit size | Units |
| Main Engine | 50 | | 3.22E+05 | 1.07E+02 | | | | | |
| | .125 | main eng | 4.02E+04 | 1.34E+01 | 8.00E+03 | 1.07E+05 | 5.35E+04 | 6.00E+04 | 2 |
| | .25 | main eng | 8.04E+04 | 2.68E+01 | 8.00E+03 | 2.14E+05 | 5.35E+04 | 6.00E+04 | 4 |
| | .5 | main eng | 1.61E+05 | 5.35E+01 | 8.00E+03 | 4.28E+05 | 5.35E+04 | 6.00E+04 | 8 |
| Second Ductwork | .75 | main eng | 8.04E+04 | 2.68E+01 | 8.00E+03 | 2.14E+05 | 5.35E+04 | 6.00E+04 | 4 |

| | | | | | | | |
|---|---|---|---|---|---|---|---|
| Main Engine | 1.61E+05 | 5.35E+01 | 8.00E+03 | 4.28E+05 | 5.35E+04 | 6.00E+04 | 8 |

| | | | | | axial flow |
|---|---|---|---|---|---|
| | boiler power | | generator | e baem wall | velocity |
| Unit | MWe | | efficiency | plug power | (m/s) |
| Auxiliary | 2.4 | | 0.75 | 5.51E+04 | 16.0 |
| | 3.6 | | 0.75 | 7.59E+04 | 24.0 |
| | main boiler | | | | |
| Unit | MWe | | | | |
| Main Engine | 50 | | | | |
| | .125 | main eng | 0.75 | 1.43E+05 | 6.2 |
| | .25 | main eng | 0.75 | 2.85E+05 | 12.4 |
| | .5 | main eng | 0.75 | 5.71E+05 | 24.8 |
| Second Ductwork | .75 | main eng | 0.75 | 2.85E+05 | 12.4 |

| | | | |
|---|---|---|---|
| Main Engine | 0.75 | 5.71E+05 | 24.8 |

TABLE 7
e-SCRUB ™@SEA Power Consumption

| | | | | | | | | e-beam | # 60 kW |
|---|---|---|---|---|---|---|---|---|---|
| | | | normal | | | e-beam | | generator | deposited |
| | boiler power | | volume flow | mass flow | | power | | output power | beam |
| Unit | MWe | | rate nm3/h | rate kg/s | dose (Gray) | required (W) | | (W) | power |
| auxiliary | 2.4 | | 15,554 | 5.17 | 8.00E+03 | 4.13E+04 | | 6.00E+04 | 1 |
| | 3.6 | | 23,331 | 7.11 | 8.00E+03 | 5.69E+04 | | 6.00E+04 | 1 |
| | | | normal | | | | deposited | | |
| | main boiler | | volume flow | mass flow | | | beam power | | Number of |
| unit | MWe | | rate nm3/h | rate kg/s | dose (Gray) | | per unit (W) | Unit size | Units |
| main engine | 50 | | 3.22E+05 | 1.07E+02 | | | | | |
| | .125 | main eng | 4.02E+04 | 1.34E+01 | 8.00E+03 | 1.07E+05 | 5.35E+04 | 6.00E+04 | 2 |
| | 25 | main eng | 8.04E+04 | 2.68E+01 | 8.00E+03 | 2.14E+05 | 5.35E+04 | 6.00E+04 | 4 |
| | .5 | main eng | 1.61E+05 | 5.35E+01 | 8.00E+03 | 4.28E+05 | 5.35E+04 | 6.00E+04 | 8 |
| second ductwork | .75 | main eng | 8.04E+04 | 2.68E+01 | 8.00E+03 | 2.14E+05 | 5.35E+04 | 6.00E+04 | 4 |

| | | | | | | | | |
|---|---|---|---|---|---|---|---|---|
| | Main Engine | 1.61E+05 | 5.35E+01 | 8.00E+03 | 4.28E+05 | 5.35E+04 | 6.00E+04 | 8 |
| total main engine | | | | | | | | |

| | | | | | | e-beam | | e-SCRUB ™ @ | |
|---|---|---|---|---|---|---|---|---|---|
| | | | | e-beam wall | e-beam | system | total e-beam | Sea power | Fraction |
| | boiler power | | generator | plug power | auxiliary 1 | auxiliary | system | requirements | Utilized |
| Unit | MWe | | efficiency | (W) | (W) | power (W) | power (W) | (W) | (%) |
| auxiliary | 2.4 | | 0.77 | 5.37E+04 | 500 | 500 | 54,665 | 54,665 | 2.28 |
| | 3.6 | | 0.77 | 7.39E+04 | 500 | 750 | 75,132 | 75,132 | 2.09 |
| | main boiler | | | | | | | | |
| unit | MWe | | | | | | | | |
| main engine | 50 | | | | | | | | |
| | .125 | main eng | 0.77 | 1.39E+05 | 1,000 | 1,292 | 141,321 | | |
| | 25 | main eng | 0.77 | 2.78E+05 | 2,000 | 2,584 | 282,642 | 282,642 | 2.26 |
| | .5 | main eng | 0.77 | 5.56E+05 | 4,000 | 5,168 | 565,284 | 565,284 | 2.26 |
| second ductwork | .75 | main eng | 0.77 | 2.78E+05 | 2,000 | 2,584 | 282,642 | 282,642 | 2.26 |

| | | | | | | | | |
|---|---|---|---|---|---|---|---|---|
| | Main Engine | 0.77 | 5.56E+05 | 4,000 | 5,168 | 565,284 | 565,284 | 2.26 |
| total main engine | | | | | | 1,130,567 | 1,130,567 | 2.26 |

Duty Factor
auxiliary engine - normally operate 1,000 kW to 1,700 kW while at sea. If have 2,000 kW for refrigerator load, use two auxiliary engines.
main engine - maximum shaft speed limited to 85% of maximum main engine output
minimum shaft speed limited to 12,930 MW = 30% of maximum main engine output
typical runs are 600 h/month or 7,000 h/a

TABLE 8
50 MW Engine Quarter Gas Flow Final Concentrations - Option 2

| | | | concentration | concentration | | flow rate | | | initial flow rate |
|---|---|---|---|---|---|---|---|---|---|
| | Mol wt | mole vol | mg/n3m | ppmv | concentration | nm3/h -- | Vol (%) | | nm3/h wet base |
| Component | kg/kmoles | (m3/kmole) | dry base | dry base | % wet base | wet base | wet base | # of kmoles/h | calculated |
| N2 | 28 | 2.24E+01 | | | | 65605 | 74.98 | 2.20E+03 | 4.92E+04 |
| O2 | 32 | 2.24E+01 | | | | 65605 | 11.26 | 3.30E+02 | 7.39E+03 |
| CO2 | 44 | 2.24E+01 | | | | 65605 | 6.07 | 1.78E+02 | 3.98E+03 |
| H2O | 18 | 2.24E+01 | | | | 65605 | 6.9 | 2.02E+02 | 4.53E+03 |
| Argon | 40 | 2.24E+01 | | | | 65605 | 0.410 | 1.20E+01 | 2.69E+02 |
| sum | | | | | | 65605 | 99.620 | 2.918E+03 | 65.515 |
| Density | | | | | | | | | |
| (kg/nm3/wet | | | | | | | | | |
| CO | 28 | 2.24E+01 | 164 | 80 | 0.00754 | 65605 | 0.008 | 2.21E−01 | 4.95E+00 |
| NO2 initial | 46 | 2.24E+01 | 40 | 20 | 0.0018 | 65605 | 0.002 | 5.41E−02 | |
| NO initial | 30 | 2.24E+01 | 1970 | 959 | 0.0897 | 65605 | 0.090 | 2.63E+00 | |
| SO2 initial | 64 | 2.24E+01 | 8259 | 2891 | 0.2704 | 65605 | 0.270 | 7.92E+00 | |
| SO3 initial | 80 | 2.24E+01 | 83 | 29 | 0.0029 | 65605 | 0.003 | 8.43E−02 | |
| VOC (as CH4) | 16 | 2.24E+01 | 0.83 | 328 | 0.0327 | 65605 | 0.033 | 9.57E−01 | 2.14E+01 |
| sum | | | | | | | | | |
| NO final | 30 | 2.24E+01 | 201 | 98 | 0.0092 | 65605 | 0.009 | 2.68E−01 | 6.01E+00 |
| SO2 final | 64 | 2.24E+01 | 5864 | 2053 | 0.1920 | 65605 | 0.192 | 5.62E+00 | 1.26E+02 |
| | | | | | | | | | 158.35 |
| DELTA SO2 | | | | | | | | 2.30E+00 | |
| DELTA NO | | | | | | | | 2.36E+00 | |
| PM initial | | | | | | | | | |
| PM final | | | | | | | | | |
| DELTA PM | | | | | | | | | |

| | | | added | | final flow rate | initial flow rate | final flow rate |
|---|---|---|---|---|---|---|---|
| | | | water | | nm3/h wet base | nm3/h | nm3/h -- |
| Component | kg/nm3 | initial kg/h | (kg/h) | final kg/h | calculated | dry base | dry base |
| N2 | 1.2504 | 6.15E+04 | | 6.15E+04 | 4.919E+04 | | |
| O2 | 1.4286 | 1.06E+04 | | 1.06E+04 | 7.387E+03 | | |
| CO2 | 1.9643 | 7.82E+03 | | 7.82E+03 | 3.982E+03 | | |
| H2O | 0.8036 | 3.64E+03 | 11,950 | 1.56E+04 | 1.940E+04 | | |
| Argon | 1.7857 | 4.80E+02 | | 4.80E+02 | 2.69E+02 | | |
| sum | | 84,625 | | 96.347 | 80,386 | 61,079 | 60,988 |
| Density (kg/nm3/wet | | 1.29E+00 | | | | | |
| CO | 1.2500 | 6.19E+00 | | 6.19E+00 | 4.948E+00 | | |
| NO2 initial | | 2.49E+00 | | | | | |
| NO initial | | 7.89E+01 | | | | | |
| SO2 initial | | 5.07E+02 | | | | 1.12E+03 | |
| SO3 initial | | 6.75E+00 | | | | | |
| VOC (as CH4) | 0.7143 | 1.53E+01 | | 1.53E+01 | 2.143E+01 | | |
| sum | | 6.17E+02 | | | | | |
| NO final | 1.3393 | 8.04E+00 | | 8.04E+00 | 6.006E+00 | | |
| SO2 final | 2.8571 | 3.60E+02 | | 3.60E+02 | 1.260E+02 | | |
| | | | | 389.44 | 158.35 | | |
| DELTA SO2 | | 1.47E+02 | | | | | |
| DELTA NO | | 7.08E+01 | | | | | |
| PM initial | | 3.75 | | 3.75 | | | |
| PM final | | 0.075 | | | | | |
| DELTA PM | | 3.675 | | | | | |

TABLE 9
50 MW Engine Quarter Gas Flow Initial Concentrations - Option 2

| | Mol wt | mole vol | Concentration | concentration | | flow rate | Vol | | | flow rate |
|---|---|---|---|---|---|---|---|---|---|---|
| | kg/ | (m3/ | mg/n3m dry | ppmv dry | concentration | nm3/h -- wet | (%) | | | nm3/h -- |
| Component | kmoles | kmole) | base | base | % wet base | base | wet base | #of kmoles/h | kg/h | dry base |
| N2 | 28 | 2.24E+01 | | | | 65,605 | 74.98 | 2.20E+03 | 6.15E+04 | |
| O2 | 32 | 2.24E+01 | | | | 65,605 | 11.26 | 3.30E+02 | 1.06E+04 | |
| CO2 | 44 | 2.24E+01 | | | | 65,605 | 6.07 | 1.78E+02 | 7.82E+03 | |
| H2O | 18 | 2.24E+01 | | | | 65,605 | 6.9 | 2.02E+02 | 3.64E+03 | |
| Argon | 40 | 2.24E+01 | | | | 65,605 | 0.410 | 1.20E+01 | 4.80E+02 | |
| sum | | | | | | 65,605 | 99.620 | 2.918E+03 | 84,625 | 61,079 |
| Density | | | | | | | | | 1.29 | |
| (Kg/nm3/h | | | | | | | | | | |
| wet | | | | | | | | | | |
| CO | 28 | 2.24E+01 | 164 | 80 | 0.00754 | 65605 | 0.008 | 2.21E−01 | 6.19E+00 | |
| NO2 initial | 46 | 2.24E+01 | 40 | 20 | 0.0018 | 65605 | 0.002 | 5.41E−02 | 2.49E+00 | |
| NO initial | 30 | 2.24E+01 | 1970 | 959 | 0.0897 | 65605 | 0.090 | 2.63E+00 | 7.89E+01 | |
| SO2 initial | 64 | 2.24E+01 | 8259 | 2891 | 0.2704 | 65605 | 0.270 | 7.92E+00 | 5.07E+02 | 1.12E+03 |
| SO3 initial | 80 | 2.24E+01 | 83 | 29 | 0.0029 | 65605 | 0.003 | 8.43E−02 | 6.75E+00 | |
| VOC | 16 | 2.24E+01 | 0.83 | 328 | 0.0327 | 65605 | 0.033 | 9.57E−01 | 1.53E+01 | |
| (as CH4) | | | | | | | | | | |
| sum | | | | | | | 0.405 | | 616.96 | |
| NO final | 30 | 2.24E+01 | 201 | 98 | 0.0092 | 65605 | 0.009 | 2.68E−01 | 8.04E+00 | |
| SO2 final | 64 | 2.24E+01 | 5864 | 2053 | 0.1920 | 65605 | 0.192 | 5.62E+00 | 3.60E+02 | |
| DELTA SO2 | | | | | | | | 2.30E+00 | 147.48 | |
| DELTA NO | | | | | | | | 2.36E+00 | 7.08E+01 | |
| PM initial | | | | | | | | | 3.75 | |
| PM final | | | | | | | | | 0.075 | |
| DELTA PM | | | | | | | | | 3.675 | |

TABLE 10
50 MW Engine Quarter Gas Flow Equipment Gas Flow - Option 2

| Gas | | | Fow | | Conversion | | | | Gas | |
|---|---|---|---|---|---|---|---|---|---|---|
| Flow @ | | Conversion | rate @ | Gas | factor | Flow rate | Flow rate @ | | Density | |
| Tactual | | factor (acfm) | Gas Temp | Temperature | Tactual to | Tref = 0 C. | Gas Temp | Molecular | @ Tref | mass flow |
| wet (acfm) | Equipment Input | to (m3/h) | m3/h | (° C.) | Tref | wet (nm3/h) | wet (nm3/h) | Weight | (kg/m3) | (kg/h) |
| 9.38E+04 | input duct | 1.70 | 1.59E+05 | 390 | 2.43 | 65,605 | | | 1.275 | 8.36E+04 |
| 5.13E+04 | duct | 1.70 | 8.72E+04 | 90 | 1.33 | | | | | |
| 5.64E+04 | reaction chamber | 1.70 | 9.59E+04 | 126 | 1.46 | | 9.59E+04 | 28.5 | 8.72E−01 | 8.36E+04 |
| | without | | | | | | | | | |
| | humidification | | | | | | | | | |
| 5.13E+04 | reaction chamber | 1.70 | 8.72E+04 | 90 | 320.54 | | 2.10E+07 | 28.5 | 3.98E−03 | 8.36E+04 |
| | (with | | | | | | | | | |
| | humidification) | | | | | | | | | |
| 5.13E+04 | wet by-product | 1.70 | 8.72E+04 | 90 | 1.33 | | 8.72E+04 | | | |
| | collector without | | | | | | | | | |
| | humidification) | | | | | | | | | |
| 4.71E+04 | wet by-product | 1.70 | 8.00E+04 | 60 | 1.22 | | 8.00E+04 | | | |
| | collector (after | | | | | | | | | |
| | humidification) | | | | | | | | | |
| 4.65E+04 | stack (133° F.) | 1.70 | 7.91E+04 | 56 | 1.21 | | 7.91E+04 | | | |

TABLE 11
50 MW Engine Quarter Gas Flow Pressure Effects - Option 2

| | | | | | | Pressure | Engine | | | Flow rate |
|---|---|---|---|---|---|---|---|---|---|---|
| | | Conversion | Fow rate | | Conversion | Drop | Flow | Standard | Flow | Tref = 0 C. |
| Gas Flow | | factor | @ Gas | | factor | DELTA -- | Pressure -- | Pressure -- | refenced to | & Standard |
| @ Tactual | | (acfm) to | Temp | Gas Temp | Tactual to | inches Hg | inches Hg | inches Hg | Standard | Pressure |
| wet (acfm) | Equipment Input | (m3/h) | m3/h | (° C.) | Tref | (wc) | (wc) | (wc) | Pressure | wet (nm3/h) |
| 4.13E+04 | reference @ 68° F. | 1.70 | 7.02E+04 | 20 | 1.07E+00 | 0.091 | 30.0125 | 29.9213 | 9.97E−01 | 65,644 |
| 4.65E+04 | reference @ 133° F. | 1.70 | 7.91E+04 | 56 | 1.21E+00 | | | | | |
| 4.71E+04 | reference @ 140° F. | 1.70 | 8.01E+04 | 60 | 1.22E+00 | | | | | |
| 5.13E+04 | reference @ 176° F. | 1.70 | 8.73E+04 | 90 | 1.33E+00 | | | | | |
| | | 132.80 | | | | | | | | |
| 5.64E+04 | reference @ 255° F. | 1.70 | 9.59E+04 | 126 | 1.46E+00 | | | | | |
| 5.13E+04 | reference @ 176° F. | 1.70 | 8.73E+04 | 90 | 1.33E+00 | | | | | |
| 5.13E+04 | reference @ 253° F. | 1.70 | 8.73E+04 | 90 | 1.33E+00 | | | | | |
| 9.38E+04 | reference @ 734° F. | 1.70 | 1.59E+05 | 390 | 2.43E+00 | | | | | |

TABLE 12
50 MW Engine Quarter Gas Flow Temperature Increase - Option 2

| | Reduction | Reduction | heat of | | | | | Reaction | Reaction | Quench |
|---|---|---|---|---|---|---|---|---|---|---|
| | NOx | SO2 | reaction | Total heat | Specific heat gas | Flue Gas Mass | | Temp. | Chamber | section 0 C. |
| Item | kmoles/h | kmoles/h | kcal/mole | kcal/hour | j/kg ° C. | flow kg/h | dose j/kg | Increase 0 C. | Share ° C. | ° C. |
| byproduct | | 2.30 | 131 | 3.01E+05 | 1.00E+03 | 9.56E+04 | 1.32E+04 | 1.32E+01 | | |
| formation | | | | | | | | | | |
| Nitric Acid | 2.36E+00 | | 49.8 | 1.18E+05 | 1.00E+03 | 9.56E+04 | 5.15E+03 | 5.15E+00 | 5.15E+00 | |
| Sulfuric | | 2.30 | 207.5 | 4.77E+05 | 1.00E+03 | 9.56E+04 | 2.09E+04 | 2.09E+01 | 2.09E+01 | 0.00E+00 |
| Acid | | | | | | | | | | |
| e-beam | | | | | 1.00E+03 | 9.56E+04 | 1.00E+04 | 1.00E+01 | 1.00E+01 | 0 |
| deposition | | | | | | | | | | |
| Total | | | | | | | 3.60E+04 | 3.60E+01 | 3.60E+01 | 0.00E+00 |

TABLE 13
50 MW Engine Quarter Gas Flow
Sea Water Flow Requirements - Option 2

| | | | | Com- | | | | Final | | | Replace- |
|---|---|---|---|---|---|---|---|---|---|---|---|
| | | | No | pressed | | | | Gas Flow | | Added | ment |
| | | Gas | Compressed | Air − | Gas Flow + | Initial | Required | Mass | Added | Water | water |
| | Average | Flow @ | Air − Mass | Mass Gas | Compressed | Mass | Water | Flow | Mass | Flow | form acid |
| Gas | density | Temp | Gas | Flow | Air − Mass | H2O flow | Flow | Rate | Fraction | gallons | production |
| Temp (C.) | (kg/m3) | (m3/h) | Flow (kg)/h | (kg)/h | Flow (kg)/h | (kg)/h | kg/h | (kg/h) | water/air | per minute | (gpm) |
| Water | | | | | | | | | | | |
| Injection | | | | | | | | | | | |
| into duct | | | | | | | | | | | |
| 390 | 5.31E−01 | 1.59E+05 | 8.46E+04 | | | 3.64E+03 | | | | | |
| 66 | | | | 5.92E+02 | | | | | | | |
| 388 | 5.31E−01 | | | | 8.52E+04 | | | | | | |
| 90 | 1.10E+00 | 8.72E+04 | | | | | 1.04E+04 | 9.56E+04 | 1.08E−01 | 4.56E+01 | 7.38E−01 |
| reaction | | | | | | | | | | | |
| chamber | | | | | | | | | | | |
| without | | | | | | | | | | | |
| sea water | | | | | | | | | | | |
| 1.26E+02 | 9.97E−01 | 9.59E+04 | | | | | | | | | |
| reaction | | | | | | | | | | | |
| chamber | | | | | | | | | | | |
| with sea | | | | | | | | | | | |
| water | | | | | | | | | | | |
| 90 | 1.11E+00 | 8.72E+04 | 9.56E+04 | 1.95E+02 | 9.58E+04 | 7.38E−01 | 1.41E+03 | 9.72E+04 | 1.45E−02 | 6.20E+00 | |
| wet by- | | | | | | | | | | | |
| product | | | | | | | | | | | |
| collector | | | | | | | | | | | |
| without | | | | | | | | | | | |
| sea water | | | | | | | | | | | |
| 9.00E+01 | 1.11 | 8.72E+04 | | | | | | | | | |
| quench | | | | | | | | | | | |
| section | | | | | | | | | | | |
| wet by- | | | | | | | | | | | |
| product | | | | | | | | | | | |
| coll with | | | | | | | | | | | |
| sea water | | | | | | | | | | | |
| 60 | 1.23 | 8.00E+04 | 9.72E+04 | 1.95E+02 | 9.74E+04 | 0.00E+00 | 1.19E+03 | 9.86E+04 | 1.21E−02 | 5.25E+00 | |
| INCREASE | | | | | | | | | | | |
| MASS/ | | | | | | | | | | | |
| MASS | | | | | | | | | | | |
| FRACTION | | | | | | | | | | | |

| | | | Fraction | Total Water | | Solution | | | |
|---|---|---|---|---|---|---|---|---|---|
| | density | mass flow | before | content before | | available for | H2SO4 | H2SO4 quench | Final |
| Concentration | (kg/m3) | kg/h | quench | quench kg/h | concentration | quench kg/h | quench kg/h | concentration | concentration |
| Nitric Acid HNO3 | 1.60E+03 | 1.49E+02 | 1 | 1.40E+04 | 1.06E−02 | 9.73E−01 | | | 1.06E−02 |
| Sulfuric Acid | 1.84E+03 | 2.25E+02 | 1 | 1.40E+04 | 1.61E−02 | 1.50E+04 | 0.00E+00 | 0.00E+00 | 1.61E−02 |
| H2SO4 | | | | | | | | | |

TABLE 14
50 MW Engine Quarter Gas Flow Acid Mist Production - Option 2

| | | | | | # H2O | Reduction of | | |
|---|---|---|---|---|---|---|---|---|
| | | Specific | Boiling | # moles/ | moles/SO2 | SO2 kmoles | #H2O moles/ | Reduction of NO |
| Item | mol wt | gravity | point | SO2 Moles | Moles | per hour | NO Moles | kmoles per hour |
| H2O | 18 | | | | 2 | 2.30E+00 | 2 | 2.36E+00 |
| HNO3 | 63 | 1.6 | 83 | | | | | 2.36E+00 |
| H2SO4 | 98 | 1.84 | 338 | | | 2.30E+00 | | |
| total acid mist | | | | | | | | |
| HNO3 Formation | | | | 2 | | | | |
| NO + OH—HNO2 | | | | 1 | | | | |
| NO + O + N2—NO2 + N2 | | | | | | | | |
| NO2 + OH—HNO3 | | | | 1 | | | | |
| Sulfuric Acid formation | | | | 2 | | | | |
| SO2 + OH—HSO3 | | | | 1 | | | | |
| SO2 + O—SO3 | | | | | | | | |
| SO3 + H2O—H2SO4 | | | | 1 | | | | |

| | H2O | Item | Item | Item | Liquid |
|---|---|---|---|---|---|
| Item | kmoles/hour | kg/h | lb/h | kg/day | gallons/hr |
| H2O | 9.31E+00 | 1.68E+02 | 3.69E+02 | | 1 gal H20 = 8.3 lb |
| | | | | | 4.43E+01 |
| HNO3 | | 1.49E+02 | 3.27E+02 | | 1 gal HN03 = 8.3 * (1.6) lb |
| | | | | | 2.45E+01 |
| H2SO4 | | 2.25E+02 | 4.95E+02 | | 1 gal H2S04 = 8.3 * (1.84) lb |
| | | | | | 3.71E+01 |
| total acid mist [symbol] | | 3.74E+02 | 8.22E+02 | 8.97E+03 | |
| HNO3 Formation | | | | | |
| NO + OH—HNO2 | | | | | |
| NO + O + N2—NO2 + N2 | | | | | |
| NO2 + OH—HNO3 | | | | | |
| Sulfuric Acid formation | | | | | |
| SO2 + OH—HSO3 | | | | | |
| SO2 + O—SO3 | | | | | |
| SO3 + H2O—H2SO4 | | | | | |

[symbol]

indicates data missing or illegible when filed

TABLE 15
Auxiliary Engine Gas Flow Final Concentrations - Option 2

| | | | concentration | concentration | | flow rate | | | initial flow rate |
|---|---|---|---|---|---|---|---|---|---|
| | Mol wt | mole vol | mg/n3m | ppmv | concentration | nm3/h -- | Vol (%) | | nm3/h wet base |
| Component | kg/kmoles | (m3/kmole) | dry base | dry base | % wet base | wet base | wet base | # of kmoles/h | calculated |
| N2 | 28 | 2.24E+01 | | | | 12596 | 74.98 | 4.22E+02 | 9.44E+03 |
| O2 | 32 | 2.24E+01 | | | | 12596 | 11.26 | 6.33E+01 | 1.42E+03 |
| CO2 | 44 | 2.24E+01 | | | | 12596 | 6.07 | 3.41E+01 | 7.65E+02 |
| H2O | 18 | 2.24E+01 | | | | 12596 | 6.9 | 3.88E+01 | 8.69E+02 |
| Argon | 40 | 2.24E+01 | | | | 12596 | 0.410 | 2.31E+00 | 5.16E+01 |
| sum | | | | | | 12596 | 99.620 | 5.602E+02 | 12,600 |
| Density | | | | | | | | | |
| (kg/nm3/wet | | | | | | | | | |
| CO | 28 | 2.24E+01 | 164 | 80 | 0.00754 | 12596 | 0.008 | 4.24E−02 | 9.50E−01 |
| NO2 initial | 46 | 2.24E+01 | 40 | 20 | 0.0018 | 12596 | 0.002 | 1.04E−02 | 2.33E−01 |
| NO initial | 30 | 2.24E+01 | 1970 | 959 | 0.0897 | 12596 | 0.090 | 5.05E−01 | 1.13E+01 |
| SO2 initial | 64 | 2.24E+01 | 8259 | 2891 | 0.2704 | 12596 | 0.270 | 1.52E+00 | 3.41E+01 |
| SO3 initial | 80 | 2.24E+01 | 83 | 29 | 0.0029 | 12596 | 0.003 | 1.62E−02 | 3.63E−01 |
| VOC (as CH4) | 16 | 2.24E+01 | 0.83 | 328 | 0.0327 | 12596 | 0.033 | 1.84E−01 | 4.11E+00 |
| sum | | | | | | | | | 51 |
| No final | 30 | 2.24E+01 | 199 | 97 | 0.0091 | 12596 | 0.009 | 5.10E−02 | 1.14E+00 |
| SO2 final | 84 | 2.24E+01 | 5864 | 2053 | 0.1920 | 12596 | 0.192 | 1.08E+00 | 2.42E+01 |
| DELTA SO2 | | | | | | | | 4.41E−01 | |
| DELTA NO | | | | | | | | 4.54E−01 | |
| PM initial | | | | | | | | | |
| PM final | | | | | | | | | |
| DELTA PM | | | | | | | | | |

| | | | added | | final flow rate | initial flow rate | final flow rate |
|---|---|---|---|---|---|---|---|
| | | | water | | nm3/h wet base | nm3/h | nm3/h -- |
| Component | kg/nm3 | initial kg/h | (kg/h) | final kg/h | calculated | dry base | dry base |
| N2 | 1.2504 | 1.18E+04 | | 1.18E+04 | 9.445E+03 | | |
| O2 | 1.4286 | 2.03E+03 | | 2.03E+03 | 1.418E+03 | | |
| CO2 | 1.9643 | 1.50E+03 | | 1.50E+03 | 7.646E+02 | | |
| H2O | 0.8036 | 6.98E+02 | 2,390 | 3.09E+03 | 3.844E+03 | | |
| Argon | 1.7857 | 9.22E+01 | | 9.22E+01 | 5.16E+01 | | |
| sum | | 16,248 | | 18,595 | 15,554 | 11,727 | 11,710 |
| Density (kg/nm3/wet | | 1.29E+00 | | | | | |
| CO | 1.2500 | 1.19E+00 | | 1.19E+00 | 9.500E−01 | | |
| NO2 initial | 2.0536 | 4.78E−01 | | | | | |
| NO initial | 1.3393 | 1.51E+01 | | | | | |
| SO2 initial | 2.8598 | 9.74E+01 | | | | 2.14E+02 | |
| SO3 initial | 3.5714 | 1.30E+00 | | | | | |
| VOC (as CH4) | 0.7143 | 2.94E+01 | | 2.94E+00 | 4.115E+00 | | |
| sum | | 1.18E+02 | | | | | |
| No final | 1.3393 | 1.53E+00 | | 1.53E+00 | 1.143E+00 | | |
| SO2 final | 2.8571 | 6.91E+01 | | 6.91E+01 | 2.419E+01 | | |
| | | | | 74.76 | 30.39 | | |
| DELTA SO2 | | 2.83E+01 | | | | | |
| DELTA NO | | 1.36E+01 | | | | | |
| PM initial | | 0.72 | | 0.72 | | | |
| PM final | | 0.0144 | | | | | |
| DELTA PM | | 0.7056 | | | | | |

TABLE 16
Auxiliary Engine Gas Flow Initial Concentrations - Option 2

| | Mol wt | mole vol | Concentration | concentration | | flow rate | Vol | | | flow rate |
|---|---|---|---|---|---|---|---|---|---|---|
| | kg/ | (m3/ | mg/n3m dry | ppmv dry | concentration | nm3/h -- | (%) | # of | | nm3/h -- dry |
| Component | kmoles | kmole) | base | base | % wet base | wet base | wet base | kmoles/h | kg/h | base |
| N2 | 28 | 2.24E+01 | | | | 12,596 | 74.98 | 4.22E+02 | 1.18E+04 | |
| O2 | 32 | 2.24E+01 | | | | 12,596 | 11.26 | 6.33E+01 | 2.03E+03 | |
| CO2 | 44 | 2.24E+01 | | | | 12,596 | 6.07 | 3.41E+01 | 1.50E+03 | |
| H2O | 18 | 2.24E+01 | | | | 12,596 | 6.9 | 3.88E+01 | 6.98E+02 | |
| Argon | 40 | 2.24E+01 | | | | 12,596 | 0.410 | 2.31E+00 | 9.22E+01 | |
| sum | | | | | | 12,596 | 99.620 | 5.602E+02 | 16,248 | 11,727 |
| Kg/nm3/h | | | | | | | | | 1.29 | |
| wet | | | | | | | | | | |
| CO | 28 | 2.24E+01 | 164 | 80 | 0.00754 | 12596 | 0.008 | 4.24E−02 | 1.19E+00 | |
| NO2 initial | 46 | 2.24E+01 | 40 | 20 | 0.0018 | 12596 | 0.002 | 1.04E−02 | 4.78E−01 | |
| NO initial | 30 | 2.24E+01 | 1970 | 959 | 0.0897 | 12596 | 0.090 | 5.05E−01 | 1.51E+01 | |
| SO2 initial | 64 | 2.24E+01 | 8259 | 2891 | 0.2704 | 12596 | 0.270 | 1.52E+00 | 9.74E+01 | 2.14E+02 |
| SO3 initial | 80 | 2.24E+01 | 83 | 29 | 0.0029 | 12596 | 0.003 | 1.62E−02 | 1.30E+00 | |
| VOC | 16 | 2.24E+01 | 0.83 | 328 | 0.0327 | 12596 | 0.033 | 1.84E−01 | 2.94E+00 | |
| (as CH4) | | | | | | | | | | |
| sum | | | | | | | 0.405 | | 118.46 | |
| NO final | 30 | 2.24E+01 | 199 | 97 | 0.0091 | 12596 | 0.009 | 5.10E−02 | 1.53E+00 | |
| SO2 final | 64 | 2.24E+01 | 5864 | 2053 | 0.1920 | 12596 | 0.192 | 1.08E+00 | 6.91E+01 | |
| DELTA SO2 | | | | | | | | 4.41E−01 | 28.32 | |
| DELTA NO | | | | | | | | 4.54E−01 | 1.36E+01 | |
| PM initial | | | | | | | | | 0.72 | |
| PM final | | | | | | | | | 0.0144 | |
| DELTA PM | | | | | | | | | 0.7056 | |

TABLE 17
Auxiliary Engine Equipment Gas Flow - Option 2

| Gas | | Conversion | Fow | | Conversion | | | | Gas | |
|---|---|---|---|---|---|---|---|---|---|---|
| Flow @ | | factor | rate @ | Gas | factor | Flow rate | Flow rate @ | | Density | |
| Tactual | | (acfm) | Gas Temp | Temperature | Tactual to | Tref = 0 C. | Gas Temp | Molecular | @ Tref | mass flow |
| wet (acfm) | Equipment Input | to (m3/h) | m3/h | (° C.) | Tref | wet (nm3/h) | wet (m3/h) | Weight | (kg/m3) | (kg/h) |
| 1.80E+04 | input duct | 1.70 | 3.06E+04 | 390 | 2.43 | 12,596 | | | 1.275 | 1.61E+04 |
| 9.86E+03 | duct | 1.70 | 1.67E+04 | 90 | 1.33 | | | | | |
| 1.08E+04 | reaction | 1.70 | 1.84E+04 | 126 | 1.46 | | 1.84E+04 | 28.5 | 8.72E−01 | 1.61E+04 |
| | chamber without | | | | | | | | | |
| | humidification | | | | | | | | | |
| 9.86E+03 | reaction chamber | 1.70 | 1.67E+04 | 90 | 62.35 | | 7.85E+05 | 28.5 | 2.04E−02 | 1.61E+04 |
| | (after | | | | | | | | | |
| | humidification) | | | | | | | | | |
| 9.86E+03 | wet by-product | 1.70 | 1.67E+04 | 90 | 1.33 | | 1.67E+04 | | | |
| | collector without | | | | | | | | | |
| | humidification | | | | | | | | | |
| 9.04E+03 | wet by-product | 1.70 | 1.54E+04 | 60 | 1.22 | | 1.54E+04 | | | |
| | collector (after | | | | | | | | | |
| | humidification) | | | | | | | | | |
| 8.93E+03 | stack (133° F.) | 1.70 | 1.52E+04 | 56 | 1.21 | | 1.52E+04 | | | |

TABLE 18
Auxiliary Engine Gas Flow Pressure Effects - Option 2

| | | | | | | Pressure | Engine | | | Flow rate |
|---|---|---|---|---|---|---|---|---|---|---|
| | | Conversion | Fow rate | | Conversion | Drop | Flow | Standard | Flow | Tref = 0 C. |
| Gas Flow | | factor | @ Gas | | factor | DELTA -- | Pressure -- | Pressure -- | refenced to | & Standard |
| @ Tactual | | (acfm) to | Temp | Gas Temp | Tactual to | inches Hg | inches Hg | inches Hg | Standard | Pressure |
| wet (acfm) | Equipment Input | (m3/h) | m3/h | (° C.) | Tref | (wc) | (wc) | (wc) | Pressure | wet (nm3/h) |
| 7.93E+03 | reference @ 68° F. | 1.70 | 1.35E+04 | 20 | 1.07E+00 | 0.091 | 30.0125 | 29.9213 | 9.97E−01 | 12,604 |
| 8.93E+03 | reference @ 133° F. | 1.70 | 1.52E+04 | 56 | 1.21E+00 | | | | | |
| 9.04E+03 | reference @ 140° F. | 1.70 | 1.54E+04 | 60 | 1.22E+00 | | | | | |
| 9.86E+03 | reference @ 176° F. | 1.70 | 1.68E+04 | 90 | 1.33E+00 | | | | | |
| | | 132.80 | | | | | | | | |
| 1.08E+04 | reference @ 255° F. | 1.70 | 1.84E+04 | 126 | 1.46E+00 | | | | | |
| 9.86E+03 | reference @ 176° F. | 1.70 | 1.68E+04 | 90 | 1.33E+00 | | | | | |
| 9.86E+03 | reference @ 253° F. | 1.70 | 1.68E+04 | 90 | 1.33E+00 | | | | | |
| 1.80E+04 | reference @ 734° F. | 1.70 | 3.06E+04 | 390 | 2.43E+00 | | | | | |

TABLE 19
Auxiliary Engine Gas Flow Temperature Increase - Option 2

| | Reduction | Reduction | heat of | | | | | Reaction | Reaction | Quench |
|---|---|---|---|---|---|---|---|---|---|---|
| | NOx | SO2 | reaction | Total heat | Specific heat gas | Flue Gas Mass | | Temp. | Chamber | section 0 C. |
| Item | kmoles/h | kmoles/h | kcal/mole | kcal/hour | j/kg ° C. | flow kg/h | dose j/kg | Increase 0 C. | Share ° C. | ° C. |
| byproduct | | 0.44 | 131 | 5.78E+04 | 1.00E+03 | 1.84E+04 | 1.32E+04 | 1.32E+01 | | |
| formation | | | | | | | | | | |
| Nitric Acid | 4.54E−01 | | 49.8 | 2.26E+04 | 1.00E+03 | 1.84E+04 | 5.15E+03 | 5.15E+00 | 5.15E+00 | |
| Sulfuric | | 0.44 | 207.5 | 9.15E+04 | 1.00E+03 | 1.84E+04 | 2.09E+04 | 2.09E+01 | 2.09E+01 | 0.00E+00 |
| Acid | | | | | | | | | | |
| e-beam | | | | | 1.00E+03 | 1.84E+04 | 1.00E+04 | 1.00E+01 | 1.00E+01 | 0 |
| deposition | | | | | | | | | | |
| Total | | | | | | | 3.60E+04 | 3.60E+01 | 3.60E+01 | 0.00E+00 |

TABLE 20
Auxiliary Engine Sea Water Flow Requirements - Option 2

| | | | | Com- | | | | Final | | | Replace- |
|---|---|---|---|---|---|---|---|---|---|---|---|
| | | | No | pressed | | | | Gas Flow | | Added | ment |
| | | Gas | Compressed | Air − | Gas Flow + | Initial | Required | Mass | Added | Water | water |
| | Average | Flow @ | Air − Mass | Mass Gas | Compressed | Mass | Water | Flow | Mass | Flow | form acid |
| Gas | density | Temp | Gas | Flow | Air − Mass | H2O flow | Flow | Rate | Fraction | gallons | production |
| Temp (C.) | (kg/m3) | (m3/h) | Flow (kg)/h | (kg)/h | Flow (kg)/h | (kg)/h | kg/h | (kg/h) | water/air | per minute | (gpm) |
| water | | | | | | | | | | | |
| injection | | | | | | | | | | | |
| into duct | | | | | | | | | | | |
| 390 | 5.31E−01 | 3.06E+04 | 1.62E+04 | | | 6.98E+02 | | | | | |
| 66 | | | | 1.14E+02 | | | | | | | |
| 388 | 5.31E−01 | | | | 1.64E+04 | | | | | | |
| 90 | 1.10E+00 | 1.67E+04 | | | | | 1.99E+03 | 1.84E+04 | 1.08E−01 | 8.75E+00 | 1.42E−01 |
| reaction | | | | | | | | | | | |
| chamber | | | | | | | | | | | |
| without | | | | | | | | | | | |
| sea water | | | | | | | | | | | |
| 1.26E+02 | 9.97E−01 | 1.84E+04 | | | | | | | | | |
| reaction | | | | | | | | | | | |
| chamber | | | | | | | | | | | |
| with sea | | | | | | | | | | | |
| water | | | | | | | | | | | |
| 90 | 1.11E+00 | 1.67E+04 | 1.84E+04 | 3.75E+01 | 1.84E+04 | 1.42E−01 | 2.71E+02 | 1.87E+04 | 1.45E−02 | 1.19E+00 | |
| quench | | | | | | | | | | | |
| section | | | | | | | | | | | |
| wet by- | | | | | | | | | | | |
| product | | | | | | | | | | | |
| collector | | | | | | | | | | | |
| without | | | | | | | | | | | |
| sea water | | | | | | | | | | | |
| 9.00E+01 | 1.11 | 1.67E+04 | | | | | | | | | |
| quench | | | | | | | | | | | |
| section | | | | | | | | | | | |
| wet by- | | | | | | | | | | | |
| product | | | | | | | | | | | |
| collector | | | | | | | | | | | |
| with sea | | | | | | | | | | | |
| water | | | | | | | | | | | |
| 60 | 1.23 | 1.54E+04 | 1.87E+04 | 3.75E+01 | 1.87E+04 | 0.00E+00 | 2.29E+02 | 1.89E+04 | 1.21E−02 | 1.01E+00 | |
| INCREASE | | | | | | | 2,489 | | 1.135 | | |
| MASS/ | | | | | | | | | | | |
| MASS | | | | | | | | | | | |
| FRACTION | | | | | | | | | | | |

| | | | Fraction | Total Water | | Solution | | | |
|---|---|---|---|---|---|---|---|---|---|
| | density | mass flow | before | content before | | available for | H2SO4 | H2SO4 quench | Final |
| Concentration | (kg/m3) | kg/h | quench | quench kg/h | concentration | quench kg/h | quench kg/h | concentration | concentration |
| Nitric Acid HNO3 | 1.60E+03 | 2.86E+01 | 1 | 2.69E+03 | 1.06E−02 | 0.00E+00 | 0 | 0.00E+00 | 1.06E−02 |
| Sulfuric Acid | 1.84E+03 | 4.32E+01 | 1 | 2.69E+03 | 1.61E−02 | 2.88E+03 | 0.00E+00 | 0.00E+00 | 1.61E−02 |
| H2SO4 | | | | | | | | | |

TABLE 21
Auxiliary Engine Acid Mist Production - Option 2

| | | | | | # H2O | Reduction of | | |
|---|---|---|---|---|---|---|---|---|
| | | Specific | Boiling | # moles/ | moles/SO2 | SO2 kmoles | #H2O moles/ | Reduction of NO |
| Item | mol wt | gravity | point | SO2 Moles | Moles | per hour | NO Moles | kmoles per hour |
| H2O | 18 | | | | 2 | 4.41E−01 | 2 | 4.54E−01 |
| NHO3 | 63 | 1.6 | 83 | | | | | 4.54E−01 |
| H2SO4 | 98 | 1.84 | 338 | | | 4.41E−01 | | |
| total acid mist | | | | | | | | |
| HNO3 Formation | | | | 2 | | | | |
| NO + OH—HNO2 | | | | 1 | | | | |
| NO + O + N2—NO2 + N2 | | | | | | | | |
| NO2 + OH—HNO3 | | | | 1 | | | | |
| Sulfuric Acid formation | | | | 2 | | | | |
| SO2 + OH—HSO3 | | | | 1 | | | | |
| SO2 + O—SO3 | | | | | | | | |
| SO3 + H2O—H2SO4 | | | | 1 | | | | |

| | H2O | Item | Item | Item | Liquid |
|---|---|---|---|---|---|
| Item | kmoles/hour | kg/h | lb/h | kg/day | gallons/hr |
| H2O | 1.79E+00 | 3.22E+01 | 7.09E+01 | | 1 gal H20 = 8.3 lb |
| | | | | | 8.50E+00 |
| NHO3 | | 2.86E+01 | 6.29E+01 | | 1 gal HN03 = 8.3 * (1.6) lb |
| | | | | | 4.72E+00 |
| H2SO4 | | 4.32E+01 | 9.51E+01 | | 1 gal H2S04 = 8.3 * (1.84) lb |
| | | | | | 7.13E+00 |
| total acid mist [symbol] | | 7.18E+01 | 1.58E+02 | 1.72E+03 | |
| HNO3 Formation | | | | | |
| NO + OH—HNO2 | | | | | |
| NO + O + N2—NO2 + N2 | | | | | |
| NO2 + OH—HNO3 | | | | | |
| Sulfuric Acid formation | | | | | |
| SO2 + OH—HSO3 | | | | | |
| SO2 + O—SO3 | | | | | |
| SO3 + H2O—H2SO4 | | | | | |

[symbol]

indicates data missing or illegible when filed

TABLE 22
50 MW Engine Quarter Gas Flow Final Concentrations - Option 1

| | | | concentration | concentration | | flow rate | | | initial flow rate |
|---|---|---|---|---|---|---|---|---|---|
| | Mol wt | mole vol | mg/n3m | ppmv | concentration | nm3/h -- | Vol (%) | | nm3/h wet base |
| Component | kg/kmoles | (m3/kmole) | dry base | dry base | % wet base | wet base | wet base | # of kmoles/h | calculated |
| N2 | 28 | 2.24E+01 | | | | 65605 | 74.98 | 2.20E+03 | 4.92E+01 |
| O2 | 32 | 2.24E+01 | | | | 65605 | 11.26 | 3.30E+02 | 7.39E+03 |
| CO2 | 44 | 2.24E+01 | | | | 65605 | 6.07 | 1.78E+02 | 3.98E+03 |
| H2O | 18 | 2.24E+01 | | | | 65605 | 6.9 | 2.02E+02 | 4.53E+03 |
| Argon | 40 | 2.24E+01 | | | | 65605 | 0.410 | 1.20E+01 | 2.69E+02 |
| sum | | | | | | 65605 | 99.620 | 2.918E+03 | 65.622 |
| Density | | | | | | | | | |
| (kg/nm3/wet | | | | | | | | | |
| CO | 28 | 2.24E+01 | 164 | 80 | 0.00754 | 65605 | 0.008 | 2.21E−01 | 4.95E+00 |
| NO2 initial | 46 | 2.24E+01 | 40 | 20 | 0.0018 | 65605 | 0.002 | 5.41E−02 | 1.21E+00 |
| NO initial | 30 | 2.24E+01 | 1970 | 959 | 0.0897 | 65605 | 0.090 | 2.63E+00 | 5.89E+01 |
| SO2 initial | 64 | 2.24E+01 | 8259 | 2891 | 0.2704 | 65605 | 0.270 | 7.92E+00 | 1.77E+02 |
| SO3 initial | 80 | 2.24E+01 | 83 | 29 | 0.0029 | 65605 | 0.003 | 8.43E−02 | 1.89E+00 |
| VOC (as CH4) | 16 | 2.24E+01 | 0.83 | 328 | 0.0327 | 65605 | 0.033 | 9.57E−01 | 2.14E+01 |
| sum | | | | | | | | | 2.66E+02 |
| NO final | 30 | 2.24E+01 | 197 | 96 | 0.0090 | 65605 | 0.009 | 2.63E−01 | 5.89E+00 |
| SO2 final | 64 | 2.24E+01 | 165 | 58 | 0.0054 | 65605 | 0.005 | 1.58E−01 | 3.55E+00 |
| sum | | | | | | | | | |
| DELTA SO2 | | | | | | | | 7.76E+00 | |
| DELTA NO | | | | | | | | 2.37E+00 | |
| PM initial | | | | | | | | | |
| PM final | | | | | | | | | |
| DELTA PM | | | | | | | | | |

| | | | added | | final flow rate | initial flow rate | final flow rate |
|---|---|---|---|---|---|---|---|
| | | | water | | nm3/h wet base | nm3/h | nm3/h -- |
| Component | kg/nm3 | initial kg/h | (kg/h) | final kg/h | calculated | dry base | dry base |
| N2 | 1.2504 | 6.15E+04 | | 6.15E+04 | 4.919E+04 | | |
| O2 | 1.4286 | 1.06E+04 | | 1.06E+04 | 7.387E+03 | | |
| CO2 | 1.9643 | 7.82E+03 | | 7.82E+03 | 3.982E+03 | | |
| H2O | 0.8036 | 3.64E+03 | 15,906 | 1.95E+04 | 2.432E+04 | | |
| Argon | 1.7857 | 4.80E+02 | | 4.80E+02 | 2.69E+02 | | |
| sum | | 84.625 | | 99.954 | 85.186 | 61,079 | 60,865 |
| Density (kg/nm3/wet | | 1.29E+00 | | | | | |
| CO | 1.2500 | 6.19E+00 | | 6.19E+00 | 4.948E+00 | | |
| NO2 initial | 2.0536 | 2.49E+00 | | | | | |
| NO initial | 1.3393 | 7.89E+01 | | | | | |
| SO2 initial | 2.8598 | 5.07E+02 | | | | 1.12E+03 | |
| SO3 initial | 3.5714 | 6.75E+00 | | | | | |
| VOC (as CH4) | 0.7143 | 1.53E+01 | | 1.53E+01 | 2.143E+01 | | |
| sum | | 6.17E+02 | | | | | |
| NO final | 1.3393 | 7.89E+00 | | 7.89E+00 | 5.888E+00 | | |
| SO2 final | 2.8571 | 1.01E+01 | | 1.01E+01 | 3.548E+00 | | |
| sum | | | | 39.52 | 35.82 | | |
| DELTA SO2 | | 4.97E+02 | | | | | |
| DELTA NO | | 7.10E+01 | | | | | |
| PM initial | | 3.75 | | 3.75 | | | |
| PM final | | 0.075 | | | | | |
| DELTA PM | | 3.675 | | | | | |

TABLE 23
50 MW Engine Quarter Gas Flow Initial Concentrations - Option 1

| | Mol wt | mole vol | Concentration | concentration | | flow rate | Vol (%) | | | flow rate |
|---|---|---|---|---|---|---|---|---|---|---|
| | kg/ | (m3/ | mg/n3m dry | ppmv dry | concentration | nm3/h -- | wet | # of | | nm3/h -- |
| Component | kmoles | kmole) | base | base | % wet base | wet base | base | kmoles/h | kg/h | dry base |
| N2 | 28 | 2.24E+01 | | | | 65,605 | 74.98 | 2.20E+03 | 6.15E+04 | |
| O2 | 32 | 2.24E+01 | | | | 65,605 | 11.26 | 3.30E+02 | 1.06E+04 | |
| CO2 | 44 | 2.24E+01 | | | | 65,605 | 6.07 | 1.78E+02 | 7.82E+03 | |
| H2O | 18 | 2.24E+01 | | | | 65,605 | 6.9 | 2.02E+02 | 3.64E+03 | |
| Argon | 40 | 2.24E+01 | | | | 65,605 | 0.410 | 1.20E+01 | 4.80E+02 | |
| sum | | | | | | 65,605 | 99.620 | 2.918E+03 | 84,625 | 61,079 |
| Kg/nm3/h wet | | | | | | | | | 1.29 | |
| CO | 28 | 2.24E+01 | 164 | 80 | 0.00754 | 65605 | 0.008 | 2.21E−01 | 6.19E+00 | |
| NO2 initial | 46 | 2.24E+01 | 40 | 20 | 0.0018 | 65605 | 0.002 | 5.41E−02 | 2.49E+00 | |
| NO initial | 30 | 2.24E+01 | 1970 | 959 | 0.0897 | 65605 | 0.090 | 2.63E+00 | 7.89E+01 | |
| SO2 initial | 64 | 2.24E+01 | 8259 | 2891 | 0.2704 | 65605 | 0.270 | 7.92E+00 | 5.07E+02 | 1.12E+03 |
| SO3 initial | 80 | 2.24E+01 | 83 | 29 | 0.0029 | 65605 | 0.003 | 8.43E−02 | 6.75E+00 | |
| VOC (as CH4) | 16 | 2.24E+01 | 0.83 | 328 | 0.0327 | 65605 | 0.033 | 9.57E−01 | 1.53E+01 | |
| sum | | | | | | | 0.405 | | 616.96 | |
| NO final | 30 | 2.24E+01 | 197 | 96 | 0.0090 | 65605 | 0.009 | 2.63E−01 | 7.89E+00 | |
| SO2 final | 64 | 2.24E+01 | 165 | 58 | 0.0054 | 65605 | 0.005 | 1.58E−01 | 1.01E+01 | |
| DELTA SO2 | | | | | | | | 7.76E+00 | 497.24 | |
| DELTA NO | | | | | | | | 2.37E+00 | 7.10E+01 | |
| PM initial | | | | | | | | | 3.75 | |
| PM final | | | | | | | | | 0.075 | |
| DELTA PM | | | | | | | | | 3.675 | |

TABLE 24
50 MW Engine Quarter Gas Flow Equipment Gas Flow - Option 1

| Gas | | | Fow | | Conversion | | | | Gas | |
|---|---|---|---|---|---|---|---|---|---|---|
| Flow @ | | Conversion | rate @ | Gas | factor | Flow rate | Flow rate @ | | Density | |
| Tactual | | factor (acfm) | Gas Temp | Temperature | Tactual | Tref = 0 C. | Gas Temp | Molecular | @ Tref | mass flow |
| wet (acfm) | Equipment Input | to (m3/h) | m3/h | (° C.) | to Tref | wet (nm3/h) | wet(m3/h) | Weight | (kg/m3) | (kg/h) |
| 9.38E+04 | input duct | 1.70 | 1.59E+05 | 390 | 2.43 | 65,605 | | | 1.275 | 8.36E+04 |
| 4.99E+04 | duct | 1.70 | 8.48E+04 | 80 | 1.29 | | | | | |
| 5.60E+04 | reaction chamber | 1.70 | 9.52E+04 | 123 | 1.45 | | 9.52E+04 | 28.5 | 8.78E−01 | 8.36E+04 |
| | without | | | | | | | | | |
| | humidification | | | | | | | | | |
| 4.99E+04 | reaction chamber | 1.70 | 8.48E+04 | 80 | 348.86 | | 2.29E+07 | 28.5 | 3.65E−03 | 8.36E+04 |
| | (after | | | | | | | | | |
| | humidification) | | | | | | | | | |
| 5.59E+04 | wet by-product | 1.70 | 9.50E+04 | 122 | 1.29 | | 8.48E+04 | | | |
| | collector without | | | | | | | | | |
| | humidification | | | | | | | | | |
| 4.71E+04 | wet by-product | 1.70 | 8.00E+04 | 60 | 1.22 | | 8.00E+04 | | | |
| | collector (after | | | | | | | | | |
| | humidification) | | | | | | | | | |
| 4.65E+04 | stack (133° F.) | 1.70 | 7.91E+04 | 56 | 1.21 | | 7.91E+04 | | | |

TABLE 25
50 MW Engine Quarter Gas Flow Pressure Effects - Option 1

| | | | | | | Pressure | Engine | | | Flow rate |
|---|---|---|---|---|---|---|---|---|---|---|
| | | Conversion | Fow rate | | Conversion | Drop | Flow | Standard | Flow | Tref = 0 C. |
| Gas Flow | | factor | @ Gas | | factor | DELTA -- | Pressure -- | Pressure -- | refenced to | & Standard |
| @ Tactual | | (acfm) to | Temp | Gas Temp | Tactual to | Inches Hg | Inches Hg | Inches Hg | Standard | Pressure |
| wet (acfm) | Equipment Input | (m3/h) | m3/h | (° C.) | Tref | (wc) | (wc) | (wc) | Pressure | wet (nm3/h) |
| 4.13E+04 | reference @ 68° F. | 1.70 | 7.02E+04 | 20 | 1.07E+00 | 0.091 | 30.0125 | 29.9213 | 9.97E−01 | 65,644 |
| 4.65E+04 | reference @ 133° F. | 1.70 | 7.91E+04 | 56 | 1.21E+00 | | | | | |
| 4.71E+04 | reference @ 140° F. | 1.70 | 8.01E+04 | 60 | 1.22E+00 | | | | | |
| 4.99E+04 | reference @ 176° F. | 1.70 | 8.49E+04 | 80 | 1.29E+00 | | | | | |
| | | 132.80 | | | | | | | | |
| 5.60E+04 | reference @ 255° F. | 1.70 | 9.53E+04 | 123 | 1.45E+00 | | | | | |
| 4.99E+04 | reference @ 176° F. | 1.70 | 8.49E+04 | 80 | 1.29E+00 | | | | | |
| 5.59E+04 | reference @ 253° F. | 1.70 | 9.50E+04 | 122 | 1.45E+00 | | | | | |
| 9.38E+04 | reference @ 734° F. | 1.70 | 1.59E+05 | 390 | 2.43E+00 | | | | | |

TABLE 26
50 MW Engine Quarter Gas Flow Temperature Increase - Option 1

| | Reduction | Reduction | heat of | | Specific | Flue Gas | | Reaction | Reaction | Quench |
|---|---|---|---|---|---|---|---|---|---|---|
| | NOx | SO2 | reaction | Total heat | heat gas | Mass | | Temp. | Chamber | section 0 C. |
| Item | kmoles/h | kmoles/h | kcal/mole | kcal/hour | j/kg ° C. | flow kg/h | dose j/kg | Increase 0 C. | Share ° C. | ° C. |
| byproduct | | 7.76 | 131 | 1.02E+06 | 1.00E+03 | 9.59E+04 | 4.44E+04 | 4.44E+01 | | |
| formation | | | | | | | | | | |
| Nitric Acid | 2.37E+00 | | 49.8 | 1.18E+05 | 1.00E+03 | 9.59E+04 | 5.14E+03 | 5.14E+00 | 5.14E+00 | |
| Sulfuric | | 7.76 | 207.5 | 1.61E+06 | 1.00E+03 | 9.59E+04 | 7.03E+04 | 7.03E+01 | 2.81E+01 | 4.22E+01 |
| Acid | | | | | | | | | | |
| e-beam | | | | | 1.00E+03 | 9.59E+04 | 1.00E+04 | 1.00E+01 | 1.00E+01 | 0 |
| deposition | | | | | | | | | | |
| Total | | | | | | | 8.54E+04 | 8.54E+01 | 4.33E+01 | 4.22E+01 |

TABLE 27
50 MW Engine Quarter Gas Flow
Sea Water Flow Requirements - Option 1

| | | | No | | | | | | | | |
|---|---|---|---|---|---|---|---|---|---|---|---|
| | | | Com- | Com- | Gas | | | | | | Replace- |
| | | | pressed | pressed | Flow + | | | Final | | Added | ment |
| | | Gas | Air − | Air − | Compressed | Initial | Required | Gas Flow | Added | Water | water |
| | Average | Flow @ | Mass | Mass | Air − Mass | Mass | Water | Mass | Mass | Flow | form acid |
| | density | Temp | Gas Flow | Gas Flow | Flow | H2O flow | Flow | Flow Rate | Fraction | gallons | production |
| Gas Temp (C.) | (kg/m3) | (m3/h) | (kg)/h | (kg)/h | (kg)/h | (kg)/h | kg/h | (kg/h) | water/air | per minute | (gpm) |
| water injection | | | | | | | | | | | |
| into duct | | | | | | | | | | | |
| 390 | 5.31E−01 | 1.59E+05 | 8.46E+04 | | | 3.64E+03 | | | | | |
| 66 | | | | 5.92E+02 | | | | | | | |
| 388 | 5.31E−01 | | | | 8.52E+04 | | | | | | |
| 80 | 1.13E+00 | 8.48E+04 | | | | | 1.07E+04 | 9.59E+04 | 1.12E−01 | 4.71E+01 | 1.60E+00 |
| reaction | | | | | | | | | | | |
| chamber | | | | | | | | | | | |
| without | | | | | | | | | | | |
| sea water | | | | | | | | | | | |
| 1.23E+02 | 1.01E+00 | 9.52E+04 | | | | | | | | | |
| reaction | | | | | | | | | | | |
| chamber with | | | | | | | | | | | |
| sea water | | | | | | | | | | | |
| 80 | 1.15E+00 | 8.48E+04 | 9.59E+04 | 1.95E+02 | 9.61E+04 | 1.60E+00 | 1.70E+03 | 9.78E+04 | 1.74E−02 | 7.48E+00 | |
| quench section | | | | | | | | | | | |
| wet by-product | | | | | | | | | | | |
| collector | | | | | | | | | | | |
| without | | | | | | | | | | | |
| sea water | | | | | | | | | | | |
| 1.22E+02 | 1.03 | 9.50E+04 | | | | | | | | | |
| quench section | | | | | | | | | | | |
| wet by-product | | | | | | | | | | | |
| collector with | | | | | | | | | | | |
| sea water | | | | | | | | | | | |
| 60 | 1.26 | 8.00E+04 | 9.78E+04 | 1.95E+02 | 9.80E+04 | 0.00E+00 | 2.49E+03 | 1.01E+05 | 2.48E−02 | 1.09E+01 | |
| INCREASE | | | | | | | 1.49E+04 | | 1.154 | | |
| MASS | | | | | | | | | | | |
| MASS | | | | | | | | | | | |
| FRACTION | | | | | | | | | | | |

| | | | Fraction | Total Water | | Solution | H2SO4 | | |
|---|---|---|---|---|---|---|---|---|---|
| | density | mass flow | before | content before | | available for | quench | H2SO4 quench | Final |
| Concentration | (kg/m3) | kg/h | quench | quench kg/h | concentration | quench kg/h | kg/h | concentration | concentration |
| Nitric Acid HNO3 | 1.60E+03 | 1.49E+02 | 1 | 1.60E+04 | 9.29E−03 | 9.72E−01 | | | 9.29E−03 |
| Sulfuric Acid | 1.84E+03 | 7.61E+02 | 0.4 | 1.60E+04 | 1.90E−02 | 1.72E+04 | 4.56E+02 | 2.65E−02 | 4.54E−02 |
| H2SO4 | | | | | | | | | |

TABLE 28
50 MW Engine Quarter Gas Flow Acid Mist Production - Option 1

| | | | | | # H2O | Reduction of | | |
|---|---|---|---|---|---|---|---|---|
| | | Specific | Boiling | # moles/ | moles/SO2 | SO2 kmoles | #H2O moles/ | Reduction of NO |
| Item | mol wt | gravity | point | SO2 Moles | Moles | per hour | NO Moles | kmoles per hour |
| H2O | 18 | | | | 2 | 7.76E+00 | 2 | 2.37E+00 |
| HNO3 | 63 | 1.6 | 83 | | | | | 2.37E+00 |
| H2SO4 | 98 | 1.84 | 338 | | | 7.76E+00 | | |
| total acid mist | | | | | | | | |
| HNO3 Formation | | | | 2 | | | | |
| NO + OH—HNO2 | | | | 1 | | | | |
| NO + O + N2—NO2 + N2 | | | | | | | | |
| NO2 + OH—HNO3 | | | | 1 | | | | |
| Sulfuric Acid formation | | | | 2 | | | | |
| SO2 + OH—HSO3 | | | | 1 | | | | |
| SO2 + O—SO3 | | | | | | | | |
| SO3 + H2O—H2SO4 | | | | 1 | | | | |

| | H2O | Item | Item | Item | Liquid |
|---|---|---|---|---|---|
| Item | kmoles/hour | kg/h | lb/h | kg/day | gallons/hr |
| H2O | 2.03E+01 | 3.65E+02 | 8.02E+02 | | 1 gal H20 = 8.3 lb |
| | | | | | 9.63E+01 |
| HNO3 | | 1.49E+02 | 3.28E+02 | | 1 gal HN03 = 8.3 * (1.6) lb |
| | | | | | 2.46E+01 |
| H2SO4 | | 7.61E+02 | 1.67E+03 | | 1 gal H2S04 = 8.3 * (1.84) lb |
| | | | | | 1.26E+02 |
| total acid mist [symbol] | | 9.10E+02 | 2.00E+03 | 2.18E+04 | |
| HNO3 Formation | | | | | |
| NO + OH—HNO2 | | | | | |
| NO + O + N2—NO2 + N2 | | | | | |
| NO2 + OH—HNO3 | | | | | |
| Sulfuric Acid formation | | | | | |
| SO2 + OH—HSO3 | | | | | |
| SO2 + O—SO3 | | | | | |
| SO3 + H2O—H2SO4 | | | | | |

[symbol]

indicates data missing or illegible when filed

TABLE 29
Auxiliary Engine Gas Flow Final Concentrations - Option 1

| | | | concentration | concentration | | flow rate | | |
|---|---|---|---|---|---|---|---|---|
| | Mol wt | mole vol | mg/n3m | ppmv | concentration | nm3/h -- | Vol (%) | # of |
| Component | kg/kmoles | (m3/kmole) | dry base | dry base | % wet base | wet base | wet base | kmoles/h |
| N2 | 28 | 2.24E+01 | | | | 12596 | 74.98 | 4.22E+02 |
| O2 | 32 | 2.24E+01 | | | | 12596 | 11.26 | 6.33E+01 |
| CO2 | 44 | 2.24E+01 | | | | 12596 | 6.07 | 3.41E+01 |
| H2O | 18 | 2.24E+01 | | | | 12596 | 6.9 | 3.88E+01 |
| Argon | 40 | 2.24E+01 | | | | 12596 | 0.410 | 2.31E+00 |
| sum | | | | | | 12596 | 99.620 | 5.602E+02 |
| Density (kg/nm3/wet | | | | | | | | |
| CO | 28 | 2.24E+01 | 164 | 80 | 0.00754 | 12596 | 0.008 | 4.24E−02 |
| NO2 initial | 46 | 2.24E+01 | 40 | 20 | 0.0018 | 12596 | 0.002 | 1.04E−02 |
| NO initial | 30 | 2.24E+01 | 1970 | 959 | 0.0897 | 12596 | 0.090 | 5.05E−01 |
| SO2 initial | 64 | 2.24E+01 | 8259 | 2891 | 0.2704 | 12596 | 0.270 | 1.52E+00 |
| SO3 initial | 80 | 2.24E+01 | 83 | 29 | 0.0029 | 12596 | 0.003 | 1.62E−02 |
| VOC (as CH4) | 16 | 2.24E+01 | 0.83 | 328 | 0.0327 | 12596 | 0.033 | 1.84E−01 |
| sum | | | | | | | | |
| NO final | 30 | 2.24E+01 | 197 | 96 | 0.0090 | 12596 | 0.009 | 5.05E−02 |
| SO2 final | 64 | 2.24E+01 | 165 | 58 | 0.0054 | 12596 | 0.005 | 3.04E−02 |
| DELTA SO2 | | | | | | | | 1.49E+00 |
| DELTA NO | | | | | | | | 4.54E−01 |
| PM initial | | | | | | | | |
| PM final | | | | | | | | |
| DELTA PM | | | | | | | | |

| | initial flow rate | | | added | | final flow rate | initial flow rate | final flow rate |
|---|---|---|---|---|---|---|---|---|
| | nm3/h wet base | | | water | | nm3/h wet base | nm3/h | nm3/h -- |
| Component | calculated | kg/nm3 | initial kg/h | (kg/h) | final kg/h | calculated | dry base | dry base |
| N2 | 9.44E+03 | 1.2504 | 1.18E+04 | | 1.18E+04 | 9.445E+03 | | |
| O2 | 1.42E+03 | 1.4286 | 2.03E+03 | | 2.03E+03 | 1.418E+03 | | |
| CO2 | 7.65E+02 | 1.9643 | 1.50E+03 | | 1.50E+03 | 7.646E+02 | | |
| H2O | 8.69E+02 | 0.8036 | 6.98E+02 | 3,054 | 3.75E+03 | 4.670E+03 | | |
| Argon | 5.16E+01 | 1.7857 | 9.22E+01 | | 9.22E+01 | 5.16E+01 | | |
| sum | 12,600 | | 16,248 | | 19,191 | 16,356 | 11,727 | 11,686 |
| Density (kg/nm3/wet | | | 1.29E+00 | | | | | |
| CO | 9.50E−01 | 1.2500 | 1.19E+00 | | 1.19E+00 | 9.500E−01 | | |
| NO2 initial | 2.33E−01 | 2.0536 | 4.78E−01 | | | | | |
| NO initial | 1.13E+01 | 1.3393 | 1.51E+01 | | | | | |
| SO2 initial | 3.41E−01 | 2.8598 | 9.74E+01 | | | | 2.14E+02 | |
| SO3 initial | 3.63E−01 | 3.5714 | 1.30E+00 | | | | | |
| VOC (as CH4) | 4.11E+00 | 0.7143 | 2.94E+00 | | 2.94E+00 | 4.115E+00 | | |
| sum | 51 | | 1.18E+02 | | | | | |
| NO final | 1.13E+00 | 1.3393 | 1.51E+00 | | 1.51E+00 | 1.131E+00 | | |
| SO2 final | 6.81E−01 | 2.8571 | 1.95E+00 | | 1.95E+00 | 6.813E−01 | | |
| | | | | | 7.59 | 6.88 | | |
| DELTA SO2 | | | 9.55E+01 | | | | | |
| DELTA NO | | | 1.36E+01 | | | | | |
| PM initial | | | 0.72 | | 0.72 | | | |
| PM final | | | 0.0144 | | | | | |
| DELTA PM | | | 0.7056 | | | | | |

TABLE 30
Auxiliary Engine Gas Flow Initial Concentrations - Option 1

| | Mol wt | mole vol | Concentration | concentration | | flow rate | Vol (%) | | | flow rate |
|---|---|---|---|---|---|---|---|---|---|---|
| | kg/ | (m3/ | mg/n3m dry | ppmv dry | concentration | nm3/h -- | wet | # of | | nm3/h -- |
| Component | kmoles | kmole) | base | base | % wet base | wet base | base | kmoles/h | kg/h | dry base |
| N2 | 28 | 2.24E+01 | | | | 12,596 | 74.98 | 4.22E+02 | 1.18E+04 | |
| O2 | 32 | 2.24E+01 | | | | 12,596 | 11.26 | 6.33E+01 | 2.03E+03 | |
| CO2 | 44 | 2.24E+01 | | | | 12,596 | 6.07 | 3.41E+01 | 1.50E+03 | |
| H2O | 18 | 2.24E+01 | | | | 12,596 | 6.9 | 3.88E+01 | 6.98E+02 | |
| Argon | 40 | 2.24E+01 | | | | 12,596 | 0.410 | 2.31E+00 | 9.22E+01 | |
| sum | | | | | | 12,596 | 99.620 | 5.602E+02 | 16,248 | 11,727 |
| Kg/nm3/h wet | | | | | | | | | 1.29 | |
| CO | 28 | 2.24E+01 | 164 | 80 | 0.00754 | 12596 | 0.008 | 4.24E−02 | 1.19E+00 | |
| NO2 initial | 46 | 2.24E+01 | 40 | 20 | 0.0018 | 12596 | 0.002 | 1.04E−02 | 4.78E−01 | |
| NO initial | 30 | 2.24E+01 | 1970 | 959 | 0.0897 | 12596 | 0.090 | 5.05E−01 | 1.51E+01 | |
| SO2 initial | 64 | 2.24E+01 | 8259 | 2891 | 0.2704 | 12596 | 0.270 | 1.52E+00 | 9.74E+01 | 2.14E+02 |
| SO3 initial | 80 | 2.24E+01 | 83 | 29 | 0.0029 | 12596 | 0.003 | 1.62E−02 | 1.30E+00 | |
| VOC (as CH4) | 16 | 2.24E+01 | 0.83 | 328 | 0.0327 | 12596 | 0.033 | 1.84E−01 | 2.94E+00 | |
| sum | | | | | | | 0.405 | | 118.46 | |
| NO final | 30 | 2.24E+01 | 197 | 96 | 0.0090 | 12596 | 0.009 | 5.05E−02 | 1.51E+00 | |
| SO2 final | 64 | 2.24E+01 | 165 | 58 | 0.0054 | 12596 | 0.005 | 3.04E−02 | 1.95E+00 | |
| DELTA SO2 | | | | | | | | 1.49E+00 | 95.47 | |
| DELTA NO | | | | | | | | 4.54E−01 | 1.36E+01 | |
| PM initial | | | | | | | | | 0.72 | |
| PM final | | | | | | | | | 0.0144 | |
| DELTA PM | | | | | | | | | 0.7056 | |

TABLE 31
Auxiliary Engine Equipment Gas Flow - Option 1

| Gas | | | Fow | | Conversion | | | | Gas | |
|---|---|---|---|---|---|---|---|---|---|---|
| Flow @ | | Conversion | rate @ | Gas | factor | Flow rate | Flow rate @ | | Density | |
| Tactual | | factor (acfm) | Gas Temp | Temperature | Tactual | Tref = 0 C. | Gas Temp | Molecular | @ Tref | mass flow |
| wet (acfm) | Equipment Input | to (m3/h) | m3/h | (° C.) | to Tref | wet (nm3/h) | wet (m3/h) | Weight | (kg/m3) | (kg/h) |
| 1.80E+04 | input duct | 1.70 | 3.06E+04 | 390 | 2.43 | 12,596 | | | 1.275 | 1.61E+04 |
| 9.59E+03 | duct | 1.70 | 1.63E+04 | 80 | 1.29 | | | | | |
| 1.08E+04 | reaction chamber | 1.70 | 1.83E+04 | 123 | 1.45 | | 1.83E+04 | 28.5 | 8.78E−01 | 1.61E+04 |
| | without | | | | | | | | | |
| | humidification | | | | | | | | | |
| 9.59E+03 | reaction chamber | 1.70 | 1.63E+04 | 80 | 67.79 | | 8.54E+05 | 28.5 | 1.88E−02 | 1.61E+04 |
| | (after | | | | | | | | | |
| | humidification) | | | | | | | | | |
| 1.07E+04 | wet by-product | 1.70 | 1.82E+04 | 122 | 1.29 | | 1.63E+04 | | | |
| | collector without | | | | | | | | | |
| | humidification | | | | | | | | | |
| 9.04E+03 | wet by-product | 1.70 | 1.54E+04 | 60 | 1.22 | | 1.54E+04 | | | |
| | collector (after | | | | | | | | | |
| | humidification) | | | | | | | | | |
| 8.93E+03 | stack (133° F.) | 1.70 | 1.52E+04 | 56 | 1.21 | | 1.52E+04 | | | |

TABLE 32
Auxiliary Engine Gas Flow Pressure Effects - Option 1

| | | | | | | Pressure | Engine | | Flow | Flow rate |
|---|---|---|---|---|---|---|---|---|---|---|
| | | Conversion | Fow rate | | Conversion | Drop | Flow | Standard | refenced | Tref = 0 C. |
| Gas Flow | | factor | @ Gas | | factor | DELTA -- | Pressure -- | Pressure -- | to | & Standard |
| @ Tactual | | (acfm) to | Temp | Gas Temp | Tactual to | inches Hg | inches Hg | inches Hg | Standard | Pressure |
| wet (acfm) | Equipment Input | (m3/h) | m3/h | (° C.) | Tref | (wc) | (wc) | (wc) | Pressure | wet (nm3/h) |
| 7.93E+03 | reference @ 68° F. | 1.70 | 1.35E+04 | 20 | 1.07E+00 | 0.091 | 30.0125 | 29.9213 | 9.97E−01 | 12,604 |
| 8.93E+03 | reference @ 133° F. | 1.70 | 1.52E+04 | 56 | 1.21E+00 | | | | | |
| 9.04E+03 | reference @ 140° F. | 1.70 | 1.54E+04 | 60 | 1.22E+00 | | | | | |
| 9.59E+03 | reference @ 176° F. | 1.70 | 1.63E+04 | 80 | 1.29E+00 | | | | | |
| | | 132.80 | | | | | | | | |
| 1.08E+04 | reference @ 255° F. | 1.70 | 1.83E+04 | 123 | 1.45E+00 | | | | | |
| 9.59E+03 | reference @ 176° F. | 1.70 | 1.63E+04 | 80 | 1.29E+00 | | | | | |
| 1.07E+04 | reference @ 253° F. | 1.70 | 1.82E+04 | 122 | 1.45E+00 | | | | | |
| 1.80E+04 | reference @ 734° F. | 1.70 | 3.06E+04 | 390 | 2.43E+00 | | | | | |

TABLE 33
Auxiliary Engine Gas Flow Temperature Increase - Option 1

| | Reduction | Reduction | | | Specific | | | Reaction | Reaction | Quench |
|---|---|---|---|---|---|---|---|---|---|---|
| | NOx | SO2 | heat of reaction | Total heat | heat gas | Flue Gas Mass | | Temp. | Chamber | section 0 C. |
| Item | kmoles/h | kmoles/h | kcal/mole | kcal/hour | j/kg ° C. | flow kg/h | dose j/kg | Increase 0 C. | Share ° C. | ° C. |
| by product | | 1.49 | 131 | 1.95E+05 | 1.00E+03 | 1.84E+04 | 4.44E+04 | 4.44E+01 | | |
| formation | | | | | | | | | | |
| Nitric Acid | 4.54E−01 | | 49.8 | 2.26E+04 | 1.00E+03 | 1.84E+04 | 5.14E+03 | 5.14E+00 | 5.14E+00 | |
| Sulfuric Acid | | 1.49 | 207.5 | 3.09E+05 | 1.00E+03 | 1.84E+04 | 7.03E+04 | 7.03E+01 | 2.81E+01 | 4.22E+01 |
| e-beam | | | | | 1.00E+03 | 1.84E+04 | 1.00E+04 | 1.00E+01 | 1.00E+01 | 0 |
| deposition | | | | | | | | | | |
| Total | | | | | | | 8.54E+04 | 8.54E+01 | 4.33E+01 | 4.22E+01 |

TABLE 34
Auxiliary Engine Sea Water Flow Requirements - Option 1

| | | | No | Com- | Gas | | | | | | Replace- |
|---|---|---|---|---|---|---|---|---|---|---|---|
| | | | Com- | pressed | Flow + | | | Final | | Added | ment |
| | | Gas | pressed | Air − | Compressed | Initial | Required | Gas Flow | Added | Water | water |
| | Average | Flow @ | Air − Mass | Mass | Air − Mass | Mass | Water | Mass | Mass | Flow | form acid |
| Gas Temp | density | Temp | Gas Flow | Gas Flow | Flow | H2O flow | Flow | Flow Rate | Fraction | gallons | production |
| (C.) | (kg/m3) | (m3/h) | (kg)/h | (kg)/h | (kg)/h | (kg)/h | kg/h | (kg/h) | water/air | per minute | (gpm) |
| water | | | | | | | | | | | |
| injection | | | | | | | | | | | |
| into duct | | | | | | | | | | | |
| 390 | 5.31E−01 | 3.06E+04 | 1.62E+04 | | | 6.98E+02 | | | | | |
| 66 | | | | 1.14E+02 | | | | | | | |
| 388 | 5.31E−01 | | | | 1.64E+04 | | | | | | |
| 80 | 1.13E+00 | 1.63E+04 | | | | | 2.06E+03 | 1.84E+04 | 1.12E−01 | 9.05E+00 | 3.08E−01 |
| reaction | | | | | | | | | | | |
| chamber | | | | | | | | | | | |
| without | | | | | | | | | | | |
| sea water | | | | | | | | | | | |
| 1.23E+02 | 1.01E+00 | 1.83E+04 | | | | | | | | | |
| reaction | | | | | | | | | | | |
| chamber | | | | | | | | | | | |
| with | | | | | | | | | | | |
| sea water | | | | | | | | | | | |
| 80 | 1.15E+00 | 1.63E+04 | 1.84E+04 | 3.75E+01 | 1.85E+04 | 3.08E−01 | 3.26E+02 | 1.88E+04 | 1.74E−02 | 1.44E+00 | |
| quench | | | | | | | | | | | |
| section | | | | | | | | | | | |
| wet by- | | | | | | | | | | | |
| product | | | | | | | | | | | |
| collector | | | | | | | | | | | |
| without | | | | | | | | | | | |
| sea water | | | | | | | | | | | |
| 1.22E+02 | 1.03 | 1.82E+04 | | | | | | | | | |
| quench | | | | | | | | | | | |
| section | | | | | | | | | | | |
| wet by- | | | | | | | | | | | |
| product | | | | | | | | | | | |
| collector | | | | | | | | | | | |
| with | | | | | | | | | | | |
| sea water | | | | | | | | | | | |
| 60 | 1.26 | 1.54E+04 | 1.88E+04 | 3.75E+01 | 1.88E+04 | 0.00E+00 | 4.78E+02 | 1.93E+04 | 2.48E−02 | 2.10E+00 | |
| INCREASE | | | | | | | 2.860 | | 1.154 | | |
| MASS/ | | | | | | | | | | | |
| MASS | | | | | | | | | | | |
| FRACTION | | | | | | | | | | | |

| | | | Fraction | Total Water | | Solution | H2SO4 | | |
|---|---|---|---|---|---|---|---|---|---|
| | density | mass flow | before | content before | | available for | quench | H2SO4 quench | Final |
| Concentration | (kg/m3) | kg/h | quench | quench kg/h | concentration | quench kg/h | kg/h | concentration | concentration |
| Nitric Acid HNO3 | 1.60E+03 | 2.86E+01 | 1 | 3.08E+03 | 9.29E−03 | 9.72E−01 | | | 9.29E−03 |
| Sulfuric Acid | 1.84E+03 | 1.46E+02 | 0.4 | 3.08E+03 | 1.90E−02 | 3.31E+03 | 8.76E+01 | 2.65E−02 | 4.54E−02 |
| H2SO4 | | | | | | | | | |

TABLE 35
Auxiliary Engine Acid Mist Production - Option 1

| | | | | | # H2O | Reduction of | | |
|---|---|---|---|---|---|---|---|---|
| | | Specific | Boiling | # moles/ | moles/SO2 | SO2 kmoles | #H2O moles/ | Reduction of NO |
| Item | mol wt | gravity | point | SO2 Moles | Moles | per hour | NO Moles | kmoles per hour |
| H2O | 18 | | | | 2 | 1.49E+00 | 2 | 4.54E−01 |
| HNO3 | 63 | 1.6 | 83 | | | | | 4.54E−01 |
| H2SO4 | 98 | 1.84 | 338 | | | 1.49E+00 | | |
| total acid mist | | | | | | | | |
| HNO3 Formation | | | | 2 | | | | |
| NO + OH—HNO2 | | | | 1 | | | | |
| NO + O + N2—NO2 + N2 | | | | | | | | |
| NO2 + OH—HNO3 | | | | 1 | | | | |
| Sulfuric Acid formation | | | | 2 | | | | |
| SO2 + OH—HSO3 | | | | 1 | | | | |
| SO2 + O—SO3 | | | | | | | | |
| SO3 + H2O—H2SO4 | | | | 1 | | | | |

| | H2O | Item | Item | Item | Liquid |
|---|---|---|---|---|---|
| Item | kmoles/hour | kg/h | lb/h | kg/day | gallons/hr |
| H2O | 3.89E+00 | 7.00E+01 | 1.54E+02 | | 1 gal H20 = 8.3 lb |
| | | | | | 1.85E+01 |
| HNO3 | | 2.86E+01 | 6.30E+01 | | 1 gal HN03 = 8.3 * (1.6) lb |
| | | | | | 4.72E+00 |
| H2SO4 | | 1.46E+02 | 3.21E+02 | | 1 gal H2S04 = 8.3 * (1.84) lb |
| | | | | | 2.41E+01 |
| total acid mist [symbol] | | 1.75E+02 | 3.84E+02 | 4.19E+03 | |
| HNO3 Formation | | | | | |
| NO + OH—HNO2 | | | | | |
| NO + O + N2—NO2 + N2 | | | | | |
| NO2 + OH—HNO3 | | | | | |
| Sulfuric Acid formation | | | | | |
| SO2 + OH—HSO3 | | | | | |
| SO2 + O—SO3 | | | | | |
| SO3 + H2O—H2SO4 | | | | | |

[symbol]

indicates data missing or illegible when filed

TABLE 36
Duty Factor-Main Engine

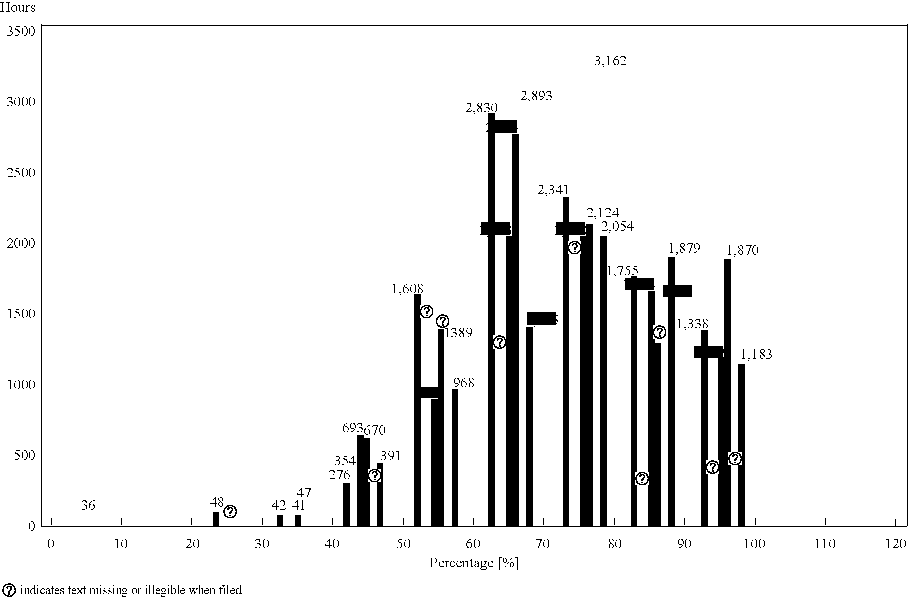

TABLE 37
e-beam Power/Number of e-Beam Modules/Duty Factor
and Axial Flow Velocity

| | | normal | | | e-beam | |
|---|---|---|---|---|---|---|
| | boiler power | volume flow | mass fow | | power | |
| Unit | MWe | rate nm3/h | rate kg/s | dose (Gray) | required (W) | |
| Auxiliary | 2.4 | 15,554 | 5.17 | 8.00E+03 | 4.13E+04 | |
| | 3.6 | 23,331 | 7.11 | 8.00E+03 | 5.69E+04 | |
| | 3 * 3.6 + 2.7 | 88,507 | 29.67 | 8.00E+03 | 2.37E+05 | |
| | | normal | | | | deposited |
| | main boiler | volume flow | mass flow | | | beam power |
| Unit | MWe | rate nm3/h | rate kg/s | dose (Gray) | | per unit (W) |
| Main Engine | 50 | 3.22E+05 | 1.07E+02 | | | |
| | .125 main eng | 4.02E+04 | 1.34E+01 | 8.00E+03 | 1.07E+05 | 5.35E+04 |
| | .25 main eng | 8.04E+04 | 2.68E+01 | 8.00E+03 | 2.14E+05 | 5.35E+04 |
| | .5 main eng | 1.61E+05 | 5.35E+01 | 8.00E+03 | 4.28E+05 | 5.35E+04 |
| Second Ductwork | .75 main eng | 8.04E+04 | 2.68E+01 | 8.00E+03 | 2.14E+05 | 5.35E+04 |
| | Main Engine | 1.61E+05 | 5.35E+01 | 8.00E+03 | 4.28E+05 | 5.35E+04 |

Duty Factor analysis indicates size wet by product collector for 0.86 CSR; CSR = .9 MCR;
size for = .86 * .9 50 MW. Operate wet by-product collector

| CSR = 90% MCR | 45 | 289,390 | 9.63E+01 | | | |
|---|---|---|---|---|---|---|
| | 21.5% CSR | 6.22E+04 | 2.22E+01 | 8.00E+03 | 1.77E+05 | 5.91E+04 |
| | 43% CSR | 1.24E+05 | 4.14E+01 | 8.00E+03 | 3.31E+05 | 5.52E+04 |
| Second Ductwork | 64.5% CSR | 6.22E+04 | 2.22E+01 | 8.00E+03 | 1.77E+05 | 5.91E+04 |
| | 86% CSR | 1.24E+05 | 4.14E+01 | 8.00E+03 | 3.31E+05 | 5.52E+04 |
| Total Gas Flow | 86% CSR | 248,875 | | | | |
| # of Belco Unit | 3.1 | | | | | |
| | | | #60 kW | | | |
| | | e-beam | deposited | | | |
| | | generator | beam | | | axial |
| | boiler power | output power | power | generator | e baem wall | flow velocity |
| Unit | MWe | (W) | modules | efficiency | plug power | (m/s) |
| Auxiliary | 2.4 | 6.00E+04 | 1 | 0.75 | 5.51E+04 | 16.0 |
| | 3.6 | 6.00E+04 | 1 | 0.75 | 7.59E+04 | 24.0 |
| | 3 * 3.6 + 2.7 | 6.00E+04 | 4 | 0.75 | 3.16E+05 | 27.3 |
| | main boiler | | Number of | | | |
| Unit | MWe | Unit size | Units | | | |
| Main Engine | 50 | | | | | |
| | .125 main eng | 6.00E+04 | 2 | 0.75 | 1.43E+05 | 6.2 |
| | .25 main eng | 6.00E+04 | 4 | 0.75 | 2.85E+05 | 12.4 |
| | .5 main eng | 6.00E+04 | 8 | 0.75 | 5.71E+05 | 24.8 |
| Second Ductwork | .75 main eng | 6.00E+04 | 4 | 0.75 | 2.85E+05 | 12.4 |
| | Main Engine | 6.00E+04 | 8 | 0.75 | 5.71E+05 | 24.8 |

Duty Factor analysis indicates size wet by product collector for 0.86 CSR; CSR = .9 MCR;
size for = .86 * .9 50 MW. Operate wet by-product collector

| | | | | | | |
|---|---|---|---|---|---|---|
| CSR = 90% MCR | 45 | | | | | |
| | 21.5% CSR | 6.00E+04 | 3 | 0.75 | 2.36E+05 | 12.8 |
| | 43% CSR | 6.00E+04 | 6 | 1.75 | 1.89E+05 | 25.6 |
| Second Ductwork | 64.5% CSR | 6.00E+04 | 3 | 0.75 | 2.36E+05 | 12.8 |
| | 86% CSR | 6.00E+04 | 6 | 1.75 | 189,414 | 25.6 |
| Total Gas Flow | 86% CSR | | | | | |
| # of Belco Unit | 3.1 | | | | | |

TABLE 38
e-SCRUB ™@SEA Power Consumption

| | | | | | | | e-beam | #60 kW | | e-beam |
|---|---|---|---|---|---|---|---|---|---|---|
| | | normal | | | | | generator | deposited | | wall plug |
| | boiler power | volume flow | mass flow | dose | e-beam power | | output power | beam | generator | power |
| Unit | MWe | rate nm3/h | rate kg/s | (Gray) | required (W) | | (W) | power | efficiency | (W) |
| auxiliary | 2.4 | 15,554 | 5.17 | 8,000 | 4.13E+04 | | 6.00E+04 | 1 | 0.75 | 5.51E+04 |
| | 3.6 | 23,331 | 7.11 | 8,000 | 5.69E+04 | | 6.00E+04 | 1 | 0.75 | 7.59E+04 |
| | | normal | | | | deposited | | | | |
| | main boiler | volume flow | mass flow | dose | | beam power | | Number of | | |
| unit | MWe | rate nm3/h | rate kg/s | (Gray) | | per unit (W) | Unit size | Units | | |
| main engine | 50 | 3.22E+05 | 1.07E+02 | | | | | | | |
| | .125 main | 4.02E+04 | 1.34E+01 | 8,000 | 1.07E+05 | 5.35E+04 | 6.00E+04 | 2 | 0.75 | 1.43E+05 |
| | engin | | | | | | | | | |
| | .25 main eng | 8.04E+04 | 2.68E+01 | 8,000 | 2.14E+05 | 5.35E+04 | 6.00E+04 | 4 | 0.75 | 2.85E+05 |
| | .5 main eng | 1.61E+05 | 5.35E+01 | 8,000 | 4.28E+05 | 5.35E+04 | 6.00E+04 | 8 | 0.75 | 5.71E+05 |
| second | .75 main eng | 8.04E+04 | 2.68E+01 | 8,000 | 2.14E+05 | 5.35E+04 | 6.00E+04 | 4 | 0.75 | 2.85E+05 |
| ductwork | Main Engine | 1.61E+05 | 5.35E+01 | 8,000 | 4.28E+05 | 5.35E+04 | 6.00E+04 | 8 | 0.75 | 5.71E+05 |

Duty Factor analysis indicates size wet by product collector for 0.86 CSR;
CSR = .9 MCR; size for = .86 * .9 50 MW. Operate wet by-product collector 12.6% of time of flow rate.

| | | | | | | | | | | |
|---|---|---|---|---|---|---|---|---|---|---|
| CSR = 90% MCR | 45 | 289,390 | 9.63E+01 | | | | | | | |
| | 21.5% CSR | 6.22E+04 | 2.22E+01 | 8,000 | 1.77E+05 | 5.91E+04 | 6.00E+04 | 3 | 0.75 | 2.36E+05 |
| | 43% CSR | 1.24E+05 | 4.14E+01 | 8,001 | 3.31E+05 | 5.52E+04 | 6.00E+04 | 6 | 0.75 | 4.42E+05 |
| Second | 64.5% CSR | 6.22E+04 | 2.22E+01 | 8,000 | 1.77E+05 | 5.91E+04 | 6.00E+04 | 3 | 0.75 | 2.36E+05 |
| Ductwork | 86% CSR | 1.24E+05 | 4.14E+01 | 8,000 | 3.31E+05 | 5.52E+04 | 6.00E+04 | 6 | 0.75 | 4.42E+05 |
| Total Gas Flow | 86% CSR | 248,875 | | | | | | | | |
| #of Belco Units | 3.1 | | | | | | | | | |

| | | | e-beam | total | Belco unit | Belco unit | e-SCRUB ™@ | | Fraction |
|---|---|---|---|---|---|---|---|---|---|
| | | e-beam | system | e-beam | power | power | Sea power | Fraction | Utilized (%) |
| | boiler power | auxiliary I | auxiliary | system | requirements | requirements | requirements | Utilized (%) | when not in |
| Unit | MWe | (W) | power (W) | power (W) | fan (W) | pumps (W) | (W) | when in port | port |
| auxiliary | 2.4 | 500 | 7,000 | 62,596 | 4,464 | 73,000 | 140,060 | 5.84 | 0% |
| | 3.6 | 500 | 7,000 | 83,352 | 6,696 | 73,000 | 163,048 | 4.53 | 0% |
| | main boiler | | | | | | | | |
| unit | MWe | | | | | | | | |
| main engine | 50 | | | | | | | | |
| | .125 main | 1,000 | 14,000 | 157,736 | | | | | |
| | engin | | | | | | | | |
| | .25 main eng | 2,000 | 28,000 | 315,473 | | | | | |
| | .5 main eng | 4,000 | 56,000 | 630,945 | | | | | |
| second | .75 main eng | 2,000 | 36,177 | 323,650 | | | | | |
| ductwork | Main Engine | 4,000 | 72,355 | 647,300 | | | | | |

Duty Factor analysis indicates size wet by product collector for 0.86 CSR;
CSR = .9 MCR; size for = .86 * .9 50 MW. Operate wet by-product collector 12.6% of time of flow rate.

| | | | | | | | | |
|---|---|---|---|---|---|---|---|---|
| CSR = 90% MCR | 45 | | | | | | | |
| | 21.5% CSR | 1,500 | 21,000 | 258,871 | | | | |
| | 43% CSR | 3,000 | 21,000 | 465,967 | | | | |
| Second | 64.5% CSR | 1,500 | 21,000 | 258,871 | | | | |
| Ductwork | 86% CSR | 3,000 | 21,000 | 465,967 | | 1,842,967 | 3.69% | 0% |
| Total Gas Flow | 86% CSR | | | | | | | |
| #of Belco Units | 3.1 | | | 279,000 | 1,098,000 | | | |

1. A method for reducing emissions of sulfur oxides and nitrogen oxides and particulate matter such as fly ash from flue gas of marine engines, comprising:
a) cleaning the flue gas to substantially remove fly ash;
b) injecting the flue gas into an electron beam chamber containing high energy electrons, whereby such high energy electrons interact with the flue gas to form sulfuric and nitric acids;
c) passing the flue gas through a wet by-product collector into which a basic aqueous solution is sprayed, whereby the sulfuric and nitric acids and particulate matter from the flue gas are collected in the aqueous solution to form a liquid discharge that is substantially environmentally friendly, and whereby the flue gas is quenched;
d) scrubbing the quenched flue gas through one or more filters connected to the wet by-product collector, wherein the quenched flue gas is accelerated and then decelerated and whereby water condenses and nitric and sulfuric acid droplets form, and further wherein the water and nitric and sulfuric acids drain to the wet by-product collector and mix with the sprayed basic aqueous solution; and
e) passing the scrubbed flue gas through the stack of said marine engine.
In a preferred embodiment, the Belco EDF is used as the wet by-product collector, which allows the direct venting of flue gasses to the atmosphere.

2. A method for reducing emissions of sulfur oxides and nitrogen oxides and particulate matter such as fly ash from flue gas of marine engines, comprising:
a) cleaning the flue gas to substantially remove fly ash;
b) injecting the flue gas into an electron beam chamber containing high energy electrons, whereby such high energy electrons interact with the flue gas to form sulfuric and nitric acids; and
c) passing the flue gas through a wet by-product collector into which a basic aqueous solution is sprayed, whereby the sulfuric and nitric acids and particulate matter from the flue gas are collected in the aqueous solution to form a liquid discharge that is substantially environmentally friendly; and
d) passing the scrubbed flue gas through the stack of said marine engine.
In a preferred embodiment, the Belco EDF is used as the wet by-product collector, which allows the direct venting of flue gasses to the atmosphere.

3. The method of claim 1 or 2, wherein the electron beam chamber comprises:
a vacuum housing comprising one or more cathode rods and an anode;
wherein the cathode rods generate electrons that are accelerated toward the anode;
wherein a wall of the vacuum housing holds the anode in a first window that acts a conduit for the flue gas;
wherein the first window comprises beryllium; and
wherein the vacuum housing comprises a second window between the first window and the flue gas.
In a preferred embodiment the second widow is configured as a sacrificial window arrangement. The sacrificial foil arrangement separates the flue gas and any corrosive by-products that are produced by the process from the anode foil. In a preferred embodiment, the sacrificial foil arrangement is a Kapton foil that is mounted on a roller assembly and a partial pressure of 1/10 atmosphere is maintained between the anode and sacrificial foil.

4. The method of claim 1 or 2, wherein the basic aqueous solution is sea water.

5. The method of claim 1 or 2, wherein the basic aqueous solution is freshwater or brackish water mixed with a basic pH-neutralizing solution or with buffering solutions.

6. The method of claim 4, wherein the aqueous solution is seawater from the ship's cooling system.

7. A system and method for scrubbing of flue gases to remove sulfur oxides and nitrogen oxides from a flue gas stream having high SO₂, NOx and particulate matter contents, said system comprising:
a) one or more e-Beam process chamber(s);
b) one or more wet by-product collector(s); and
c) conduit(s) for carrying the flue gas from a stack to the e-Beam process chamber(s);
d) conduit(s) for carrying the flue gas from the e-Beam process chamber(s) to the one or;
e) more wet by-product collector(s);
f) conduit(s) for carrying the flue gas from the one or more wet by-product collector(s) back to the stack; and
g) conduit(s) for carrying sea water from the sea to the one or more wet by-product collector(s); and
h) conduit(s) for carrying the sea water from the one or more wet by-product collector(s) back to the sea.
